(19) United States
(12) Patent Application Publication
(10) Pub. No.: US 2014/0337621 A1
(43) Pub. Date: Nov. 13, 2014

(54) WEARABLE COMMUNICATION DEVICE, SECURITY COMPLEX AND USER INTERFACE

(71) Applicant: Serguei Nakhimov, Woodbridge (CA)

(72) Inventor: Serguei Nakhimov, Woodbridge (CA)

(21) Appl. No.: 14/269,537

(22) Filed: May 5, 2014

Related U.S. Application Data
(60) Provisional application No. 61/820,209, filed on May 7, 2013.

(51) Int. Cl. G06F 1/16; G02B 27/02; G06F 3/041; H04L 9/32; G06F 3/023; H04L 29/06

(52) U.S. Cl. CPC G06F 1/163; G06F 3/023; H04L 63/10; G06F 3/041; H04L 9/32; G02B 27/027; G02B 27/028
USPC 713/168; 345/168; 726/4; 361/679.26; 361/679.03; 359/811

(57) ABSTRACT

A wearable electronic modular computer-communicator device is described which may interact and cooperate with other wearable, vehicle-mounted, object-mounted or stationary electronic devices that are also described.

### CROSS-REFERENCE TO THE PRIOR APPLICATION

This application is claiming the benefit of
the US Provisional Application No. 61/820,209
Filing date: 7 May 2013
EFS ID: 15708050
Confirmation number: 7470.

### BACKGROUND

1. Field of the Described Embodiments

The described embodiments relate to portable, vehicle-mounted, and stationary electronic devices. In particular methods for expanding the functionality and improving usability and security of electronic devices are disclosed.

2. Related Art

In the recent years, the class of portable computer-communicator devices called “smartphones” has experienced dramatic advancements and improvements, primarily in the fields of data processing/remote data communication performance and multimedia input/output capabilities. With powerful processors, fast data communication capabilities, vast memory storage and large high-resolution displays, these devices have a strong potential to perform nearly every task related to data processing, data input/output or remote voice/data communication that a person may encounter while on the go or away from a desk. However, their other characteristics important for consumers—general and specific usability, operational convenience, data security, physical reliability, upgradeability, battery life—have stayed at approximately same levels or even deteriorated.

The existence of the vast majority of such devices in a single form factor only (namely the flat planar one), without any shape or form factor conversion capabilities, is becoming a limiting factor not only for functional expansion, but for attempts of designers to bring operational convenience and reliability of such devices to a normal level easily achieved (for a subset of functions supported by a common smartphone) by many alternatively used devices, for example watches, cameras and computer keyboards.

The flat planar form factor with a large display on one side and fixed main camera on other side is generally suitable for a multitude of possible applications but fits well only a few of them and creates significant handling inconvenience and operational problems for others. For example, for photo or video shooting the user has to hold the unit at its edges to avoid blocking or accidentally touching the display. The sides of the unit have become narrow and as a result the number of physical buttons has decreased to a minimum—so for almost every function or command, even for the most common ones like camera shutter or zoom control, the user has to use virtual buttons or menus on the display and therefore has to look at it the latter very often. Such mode of handling, combined with narrow, often slippery sides of the unit, highly increase chances of the device being dropped and broken or lost. Bottom line is that the prevalent form factor with a large touch-sensitive display on one side of a flat planar body does not allow the user to have a convenient grip, required not only when shooting photos or videos but also in many other common situations: phone call, video chat, interactive video game etc. Moreover, many smartphones made in the last couple of years are too wide to be carried comfortably in a pocket or operated by one hand.

Text typing using a virtual keyboard is another example of a very inconvenient operation. It requires high visual concentration and coordination of fingers. In most situations, maximum two fingers can be used. There's no reliable tactile feedback from virtual keys (especially before they are actually pressed) so typing is slow and prone to errors. The few available models featuring mechanical keyboards bring additional problems such as increase in device size and weight, decrease in display size, and mechanical keys being still too small to be convenient. As a rule, the keys are located in the same plane as the display so convenient desktop operation is not possible. The last problem also applies to a recently introduced solution featuring a combination of a displayed virtual keyboard and a physical protrusions appearing permanently or on-demand at the display surface over virtual keys. Even traditional full-size mechanical keyboards used in a bundle with desktop PCs, laptops, tablets and smartphones have significant drawbacks: they are bulky items that cause strain to user's eyes (because for many users their sight has to be constantly switched between the display and the keys) and to user's hands (because the palms have to be kept raised above the desk surface and constantly moved).

Inefficiency and inconvenience of small displays, of virtual and small mechanical keyboards are the key factors preventing the existing smartphones to replace bigger devices such as laptops for the majority of common tasks, regardless of greatly improved computational performance/processor speed, screen resolution, memory size, communication and multimedia capabilities etc. of the former.

The usability of a common smartphone for specific situations may be improved by addition of accessories that vast majority of users purchase separately, for example back covers, cradles/stands, carrying pouches, wireless earpieces etc. Unfortunately, these accessories often bring their own inconveniences: they reduce portability of the device and oblige the user to carry, store and locate additional pieces, including chargers or other accessories for accessories.

If a smartphone is carried in a pocket or a bag, it may take few seconds or even more time for the user to locate, take and activate it. This can be critical in certain situations requiring immediate response such as call answer or photo/video shooting start. The lack of physical buttons also contributes to such delays because the user has to use long menu paths and/or virtual controls requiring visual attention and therefore a specific positioning of the device body to operate.

Other drawbacks associated with pocket or bag storage relate to fairly high possibility of the device being forgotten in a wrong bag or piece of clothing, lost or stolen, and also to a chance that neither audible signal nor vibration signal be recognized. On the other hand, users often forget to turn off sound alerts in an environment requiring silence and turn it back on, resulting in disturbance for others or missed calls.

The existing smartphone devices with the flat planar form factor are suitable primarily for general handheld operation and for pocket or bag storage. They are inconvenient or unsuitable for a specialized use like gaming, for sport, tourism and professional activities requiring fast, convenient and reliable operation under challenging mechanical and environmental conditions such as high humidity, plus they lack the ability to collect environmental data delivered by specialized sensors such as barometers. An existing smartphone would require addition of accessories, external wired or wireless sensors etc. This path significantly decreases the portability and operational convenience of the device.

The standalone devices performing some of these specialty functions—for example, advanced electronic watches or “super watches” equipped with integrated sensors or other hardware—lack advanced computational and user interface capabilities of a smartphone. Some of super watches may connect to a smartphone wirelessly, but this solution comes with the problems of shortened watch battery life and necessity to carry two separate devices. Also, a watch can incorporate only a limited number of sensors so achieving further functional flexibility is possible only by purchasing other complete devices (super watches or others) designed for different tasks.

The difficulty to combine in a single smartphone device features required for personal and professional (corporate) use—namely, functional versatility, software openness on one side with data security and confidentiality requirements on other side—has already led to carrying two smartphones as a common situation.

Even interaction with common accessories while performing standard tasks may present a problem. A smartphone can easily become misplaced, forgotten in a pocket or a bag, lost or stolen. Accepting the call requires first to locate the phone, then to take it properly in hand, then to operate a virtual (in most cases) control. Usage of wireless earpieces is limited by additional overhead these devices bring in the form of necessity to store the small device, to track/remember its location, to charge it separately and possibly carry additional accessories for this accessory.

In the smartphone market, consumers typically have to wait for a long time and then replace the whole device (often with its expensive accessories) even if they only want to achieve improvement from upgrading in a single circuit—for example, a cellular data protocol upgrade. Hardware upgrade in a smartphone, with the few exceptions like memory cards, is impossible. Together with fast moral depreciation, this fact limits the comfortable level of consumer investment.

Recently, attempts were made to solve some of the above stated problems by introducing new wrist-wearable devices. Some of these are complimentary devices that connect wirelessly to smartphones. These accessories solve a few problems (fast call accepting, reliable vibration or sound alerts, easy status check without taking the phone from a pocket or bag) but are unable to solve the remaining majority, while having drawbacks associated with carrying, storing, charging two separate devices.

Other recent solutions and prototypes are standalone devices capable of performing most common and important functions of a smartphone. They mostly fall in one of the two categories:
devices with a non-flexible, solid single or segmented body that are either too big to be worn comfortably on a wrist or too small to have a full-size screen like existing smartphones;
devices that can be worn comfortably on a wrist but unable to convert to a flat shape suitable for reliable and convenient handheld, pocket or desktop operation.

In the last decade, exponential growth of the number of people using electronic devices and networks in daily activities led to emerging and deepening major challenges related to data security. The volume, importance and criticality of information people generate, exchange and consume daily grow constantly while the ability of an average individual or organization to handle security threats decreases. As a result, cybercrime is on the rise becoming more sophisticated and dangerous and turning itself into a multimillion-dollar industry growing even faster than the opposing industry of data protection.

Most of the existing data security solutions are based on a password to be created, memorized and subsequently entered by a user. The known fundamental flaws of this method are:
it's very hard for a user to create and memorize dozens of different passwords that would be hard enough to pick;
passwords are routinely forgotten or lost by users, so a remote (online) password recovery procedure has to be used that presents even greater security risk because it relies on easily-stolen quasi-confidential information like birth date, favorite pet name etc.
each time the password is used, it can easily be intercepted by some malware or other tools, without the user even knowing this has happened;
online servers and databases that store passwords are routinely hacked and the passwords get stolen;
using of password concentrator applications, online hubs or cloud storage presents additional risk of one stolen password or one hacked server leading to loss of all user's passwords;
passwords and quasi-confidential personal data are vulnerable to phishing scams, social engineering and other attacks;
passwords and PINs can be easily captured by hidden or not video cameras, especially in public places.

Other methods of remote authorization (for example, verifying some quasi-confidential personal information via phone) are even less reliable than the password-based ones, and only encourage identity theft attempts undertaken by criminals.

To overcome the common password-related flaws, the One-Time Password (OTP) method using the specialized hardware memory storage modules (electronic fobs and tokens etc.) were introduced. This method provides much better security level but also has its flaws, applicable only to dual-channel security methods using a code sent to the user via text message etc.:
the code supplied by the device in user's possession or received as a text message via mobile network has still to be entered by the user into a PC, smartphone or similar device. If the device (or other participating computers) is compromised by a malware capable of intercepting web traffic and/or keyboard keystrokes, displayed images and/or mouse manipulations, the code can be easily stolen and used immediately to commit a cybercrime;
a personal secure memory storage device only protects data exchange between the user and the specific party that has issued it to the user. This can present a major inconvenience. For example, if the user wants to perform secure online banking with 3 banks he must, as a rule, obtain 3 different security devices.

Another advance of the common data security methods was made with introduction of a a secure memory module (or secure element) within a smartphone designed to store PINs, passwords, or other security data. The problem with this solution is no really important data can be trusted to a device that can easily be lost or stolen and protects the contents only by a PIN that the user has to enter many times a day, often in public places.

Nowadays an average person daily carries dozens of pocket items, typically including a watch, a cell phone, house keys, a car key, other keys, a driver's license, other ID cards, credit cards, debit cards, membership/loyalty/discount cards, corporate access card, public transport tickets or passes, security fobs/tokens etc.

These items range from low-tech (mechanical lock keys) to high-tech ones (car keys, security tokens) but all essentially share the same primary function of storing and communicating data used for personal identity verification, authorization and granting access of various kind.

This large collection of performers is inefficient even if some of them sometimes perform well. The total weight and volume of the collection is significant and each individual item requires independent acquiring, maintenance, prolongation etc., can be easily lost, forgotten in another piece of clothing or bag or stolen. Also, it's relatively easy for a criminal to make a copy of almost every item.

The car key loss or theft is especially risky because this device is not even protected by a PIN and the vehicle can be easily stolen afterwards with a high chance for the owner to lose the vehicle insurance coverage. Also, if a car key is given to a valet, a mechanic, a dealership employee, an inexperienced relative or friend etc., these persons receive full access to the car's functions without limits to driving distance, time, speed etc.

Credit and debit cards, as well as sensitive data contained in the cell phone, usually protected only by a short PIN which may be used many times a day, often in public places, and therefore can be easily intercepted with the help of a camera etc.

Even without breaking PINs etc. criminals can get valuable information by just looking at some of the pocket items (credit card numbers, upscale credit cards and club cards, luxury brand car keys etc.).

If the collection is lost or stolen, it can take many weeks and incur a significant cost to restore all the items.

Some of the items cannot be carried together (mechanical keys can scratch the cell phone, cards can corrupt each other's magnetic stripe data etc.), which decreases the overall portability of the collection.

### SUMMARY OF THE DESCRIBED EMBODIMENTS

In a first aspect there is provided, a flexible modular communication device comprising:
a flexible base comprising a plurality of embedded wires and a plurality of mechanical connector points arranged along the length of the base; a plurality of removable modules, each module comprising a housing with electrical and mechanical connectors connected to the base at one of the connector points so that electrical communication between the plurality of removable modules occurs through the embedded wires, the plurality of removable modules cumulatively comprising control circuitry, visual display circuitry, and radio communication circuitry; the connector points arranged to allow removal or attachment of at least one removable module without mechanical or electrical disruption of the other removable modules; and a flexible display assembly in electrical communication with at least one of the plurality of removable modules.

In a second aspect there is provided, a wearable data management device comprising:
a band comprising an exterior surface and an interior surface;
a housing coupled with the band and defining an internal cavity;
an access window formed on the interior surface of the band in communication with the housing cavity;
a data storage unit located in the housing cavity and comprising an internal clock circuitry, an internal source of electric power; and
one or more sensors detecting changes in physical status of the device and physical breach attempts.

In a third aspect there is provided, a touchpad keyboard device comprising:
a touch sensitive surface;
a plurality of relief points extending from the touch-sensitive surface and yielding to finger pressure;
the plurality of relief points spaced apart in proportion to spacing of keys on a keyboard;
instructions stored in a memory for presenting on a visual display finger touches on the touchpad keyboard, images of the touches superimposed over an image of the keyboard.

In a fourth aspect there is provided, a complex of universal devices capable of performing authorization, validation and access control tasks via mutual data exchange comprising:
at least one portable data management device that has wireless data communication capabilities and comprises a key data storage unit;
one or more devices wherein each device is either a stationary data storage device operated by an organization or a lock data storage unit installed in a vehicle, in a door lock or in another object.

In a fifth aspect there is provided, a display image magnification accessory comprising:
a flat lens;
a plurality of connection bands; and
a plurality of attachment points for mechanical connection of the connection bands to the flat lens and either to the flexible base or the modules of the flexible modular communication device, or to a body of an existing smartphone device, or to a body of another host device having a display.

### BRIEF DESCRIPTION OF THE DRAWINGS

The described embodiments and the advantages thereof may best be understood by reference to the following description taken in conjunction with the accompanying drawings. These drawings in no way limit any changes in form, shape, composition, material and detail that may be made to the described embodiments by one skilled in the art without departing from the spirit and scope of the described embodiments.

FIG. 1 shows the general view of the Wearable Data Management device worn on the wrist, together with the Communication device (Version “Sandwich”) attached to it, the latter having its Display Assembly in the Lowered position.

FIG. 2 shows the view from the Right side (i.e. when looking against the fingertips) of the Wearable Data Management device worn on the wrist, together with the Communication device (Version “Sandwich”) attached to it, the latter having its Display Assembly in the Lowered position.

FIG. 3 shows the general view of the Wearable Data Management device worn on the wrist, together with the Communication device (Version “Sandwich”) attached to it, the latter having its Display Assembly in the Raised position.

FIG. 4 shows the same view as the previous Figure with demonstration of the three types (directions) of user arm's motion used to control certain applications running on the Communication device.

FIG. 5 shows the Communication device in its Flat state as seen from the Front side (where the display is located).

FIG. 6 shows the Communication device (Version “Sandwich”) in its Flat state as seen from the Back side with the Touchpad Keyboard unit removed.

FIG. 7 shows the Communication device (Version “Sandwich”) in its Flat state as seen from the Bottom side with the Touchpad Keyboard unit attached.

FIG. 8 shows the cross section of a single Module of the Communication device (Version “Sandwich”) together with adjacent parts as seen from the Bottom side, with those parts (of the Module and beyond) included in the drawing that are essential for demonstration of the method of attachment of the Module to the Base assembly.

FIG. 9 shows the view of the Wearable Data Management device worn on the wrist, together with the Communication device attached to it, as seen from the Bottom side of the latter, with demonstration of the palm movement that can be used to control certain applications running on the Communication device, as well as the approximate free range of such movement.

FIG. 10 shows the Top-side part of the Communication device (Version “Sandwich”) in its Bent state (with the Display Assembly attached accordingly in its Lowered position) as seen from the Front side of the device (where the display is located).

FIG. 11 shows the view of the user's left arm's inner side with the Wearable Data Management device worn on the wrist, together with the Top-side part of the Communication device attached to it, and with the Removable Earpiece unit being removed by the user's right hand in the direction indicated.

FIG. 12 shows the view of the Wearable Data Management device together with the Communication device attached to it, worn on the user's left wrist being raised and brought into proximity of user's left ear in order to perform “fingerless” call answering, call placement or other function (i.e. without use of finger(s) to engage any buttons or controls—physical or virtual).

FIG. 13 shows the view of the user's left arm's inner side with the Wearable Data Management device worn on the wrist in the Lower position which allows quick attachment of the Communication device if necessary.

FIG. 14 shows the view from of the user's left arm's outer side with the Wearable Data Management device worn on the wrist in the Upper position which allows comfortable wear similarly to a common watch, and also allows quick attachment of the Communication device (Version “Croissant”, Configuration Variant C) if necessary.

FIG. 15 shows the Wearable Data Management device taken off a wrist.

FIG. 16 shows the first stage of attachment of the Communication device (Version “Sandwich”) to the Wearable Data Management device worn on a wrist: moving the Communication device body in linear bottom-directed motion until electro-mechanical connector(s) on its Bottom side come into secure contact with counterparts on the top side of the Wearable Data Management device's body.

FIG. 17 shows the second stage of attachment of the Communication device (Version “Sandwich”) to the Wearable Data Management device worn on a wrist: bending the Communication device body until its Back side comes into close contact with attachment (magnetic?) parts located on the Wearable Data Management device's bracelet part, while the top side of the Display Assembly detaches itself from the attachment parts located on the Front side of one of the Modules of the Communication device.

FIG. 18 shows the third stage of attachment of the Communication device (Version “Sandwich”) to the Wearable Data Management device worn on a wrist: bending the Display Assembly downward until its Back side comes into close contact with attachment (magnetic) parts located on the Front side of one of the Modules of the Communication device.

FIG. 19 shows the Communication device (Version “Sandwich”) in its Flat state as seen from the Back side with the Touchpad Keyboard unit attached.

FIG. 20 shows the Front-side view of the Communication device (Version “Sandwich” in its Flat state) being held by two hands in the position suitable for text typing, game playing etc. using up to four fingers (index and middle ones) pressed against the Relief Points of the Touchpad Keyboard unit attached to the Back side (not visible).

FIG. 21 shows the Back-side view of the Communication device (Version “Sandwich” in its Flat state) being held by two hands in the position suitable for text typing, game playing etc. using up to four fingers (index and middle ones) pressed against the keys of the Touchpad Keyboard unit attached to the Back side

FIG. 22 shows the Communication device (Version “Sandwich”) as seen from the Top side with the Touchpad Keyboard unit being unfolded (stage 1) and the whole Communication device thus being converted from its Flat state into Desktop Position.

FIGS. 23(a) and 23(b) show the fragment of the foldable attachment mechanism—one of the assemblies that attach the Touchpad Keyboard unit to the Back side of the Communication device, in two positions—Unfolded and Folded.

FIG. 24 shows the Communication device (Version “Sandwich”) as seen from the Top side with the Touchpad Keyboard unit being unfolded (three subsequent stages shown) and the whole Communication device thus being converted from its Flat state into Desktop state.

FIG. 25 shows the Communication device (Version “Sandwich”) as seen from the Top side with the Touchpad Keyboard unit being unfolded (near-final stage shown) and the whole Communication device thus being converted from its Handheld/pocket/cradle-mount State into the Desktop State.

FIG. 26 shows the Communication device in its Desktop State (with the Touchpad Keyboard unit laying flat on desktop surface).

FIG. 27 shows Front-side views of the two “Croissant” Versions of the Communication device, both shown in the Configuration Variant (c) or “Lean” and in the Flat State: B1 with movable flexible Display Assembly that can be raised and lowered and B2 with fixed flexible Display assembly that is integrated with the flexible Base.

FIG. 28 shows a Back-side view of the “Croissant” Version B1 of the Communication device in its Configuration Variant (c) or “Lean” and in the Flat State.

FIGS. 29(a), 29(b) and 29(c) show three cross-sectional views for the three Configuration Variants of the B1 “Croissant” Version of the Communication device attached to the Wearable Data Management device worn on the wrist in two different positions.

FIG. 30 shows the general view of the Wearable Data Management device worn on the wrist, together with the Communication device (Version “Sandwich”) attached to it, the latter having its Display Assembly in the Raised position and the Touchpad Keyboard unit placed over the arm in the fold-out position.

FIG. 31 shows the Communication device in its Desktop State (with the Touchpad Keyboard unit laying flat on desktop surface) and the magnification accessory attached.

FIGS. 32(a), 32(b), 32(c) and 32(d) show the magnification accessory coupled with an existing smartphone, in the four positions as it is transformed from the working position (a) into the non-working (folded) position (d).

### DETAILED DESCRIPTION OF EXAMPLE EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Also, references are made to detailed structure of these embodiments outlined in the Appendix to the Specification. Although these embodiments are described in sufficient detail to enable one skilled in the art to practice the described embodiments, it is understood that these examples are not limiting; such that other embodiments may be used, and changes may be made without departing from the spirit and scope of the described embodiments

### 1. Overview

Described herein, together with related algorithms and methods, are seven electronic devices named Communication device, Removable Earpiece unit, Touchpad Keyboard unit, Wearable Data Management device, Key Data Storage unit, Lock Data Storage unit, Stationary Data Storage device and one electromechanical device named Installed Lock device. These devices are normally used in combination with each other, within one or more complexes or bundles. Two of the devices—Communication device and Wearable Data Management device—can be also used as independent (standalone) devices. Five of the devices—Communication device, Removable Earpiece unit, Touchpad Keyboard unit and Wearable Data Management device—may contain certain moving (mechanical) parts. The Removable Earpiece unit and the Touchpad Keyboard unit may be implemented in two separate versions each: as independently sold accessories for existing devices such as laptop PCs, mobile phones, etc. or as reversibly attachable units—components of the Communication device. The following devices: Communication device, Wearable Data Management device, Key Data Storage unit, Lock Data Storage unit, Stationary Data Storage device, Installed Lock device may be connected to each other via mechanical and/or electric (wired) and/or radio (wireless) connections. Thus, two or more devices from this group may operate within a temporary or permanent complex or bundle. Interaction of such connected devices with each other within the complex and/or with devices outside the complex makes possible various application scenarios in various Usage Modes that are listed below. In addition, the list of possible connections between the devices is provided in the Table 2 below.

Depending upon a specific Usage Mode or application scenario, some of these devices may or may not participate in the overall complex. However, inclusion of two or more of the devices: Communication device, Wearable Data Management device, Key Data Storage unit, Lock Data Storage unit, Stationary Data Storage device, Installed Lock device into the complex is justified by a cumulative effect that cooperation between the devices contributes to usefulness and marketability of the whole complex and/or the individual devices. In part, this effect is related to the threshold that needs to be overcome for various groups of consumers to accept the new solution—which is possible only when the consumers receive a set of multiple benefits of added convenience, functional versatility, security and reliability, that only the whole complex can provide.

The devices Communication device, Wearable Data Management device, Key Data Storage unit are referred together as the Wearable Complex as they are designed to be primarily owned/used by a person and worn on a wrist or carried in a pocket, bag etc. (although the Communication device has the Desktop State which allows it to be used as a desktop computer-communicator device also—see 2.1 below).

The devices Key Data Storage unit, Lock Data Storage unit, Installed Lock device and Stationary Data Storage device are referred together as the Security Complex because their primary functions relate to online and offline security, personal identity verification, physical & logical (data) access authorization, data exchange session validation, data encryption/decryption, electronic and electromechanical locks operation etc.

The Removable Earpiece unit and the Touchpad Keyboard unit, in their versions as independent devices, will be designed to connect as accessories to other devices existing on the market: laptops, tablets, desktop PCs, mobile phones etc. The first of the two devices is a wireless earpiece (with a microphone) that is combined with a wireless optical mini-mouse and the second device is a keyboard with the surface sensitive to single-finger and multi-finger touches and thus, combined with appropriate algorithm(s), software and/or method(s), enabling typing in a so-called blind mode (i.e. without the necessity for a user to look at the fingers). Application of this keyboard device may require installation of certain software (instructions for presenting on the visual display finger touches on the keyboard touchpad over an image of a keyboard) on the host device. See 2.1 below for details.

The Touchpad Keyboard unit may also enable a special type of user interface that can be used as a touchscreen alternative whenever the latter becomes inconvenient and/or inefficient. The touch-sensitive surface will allow to highlight one or more of the selectable elements currently shown on a host device's display (i.e. virtual buttons, virtual controls, text fields, images, menu items, widgets, frames, display areas etc.) and one or more of the relief points serving as the keys of the Touchpad Keyboard, if pressed, will select, activate, engage etc. one or more of the pre-selected (highlighted) elements.

The display image magnification accessory may be also implemented as an accessory compatible with the Communication device and/or existing smartphone model(s). This lightweight and compact accessory will enhance displayed images and allow user to receive significantly more information from a display of a pocket-sized device than usual, making the latter functionally comparable to a laptop. Use of the Touchpad Keyboard unit together with the display image magnification accessory will provide a cumulative effect enhancing speed and convenience of data entry as well as output.

2. The Six Principal Devices and their Key Features, Primary Functions, Key Benefits and Connectivity

NOTE: in this paragraph, each device is described in a sub-paragraph numbered from 2.1 through 2.6, and the Usage Modes are listed with independent numbering: A, B, C, . . . , Z. Thus, each Usage Mode is introduced in the text as early as possible, right after description of all related devices.

### 2.1. Communication Device

The Communication device is a portable multi-functional computer/communicator designed to replace the existing class of devices called smartphones.

This device is convertible and can take various States while it changes its shape to accommodate to different utilization modes:

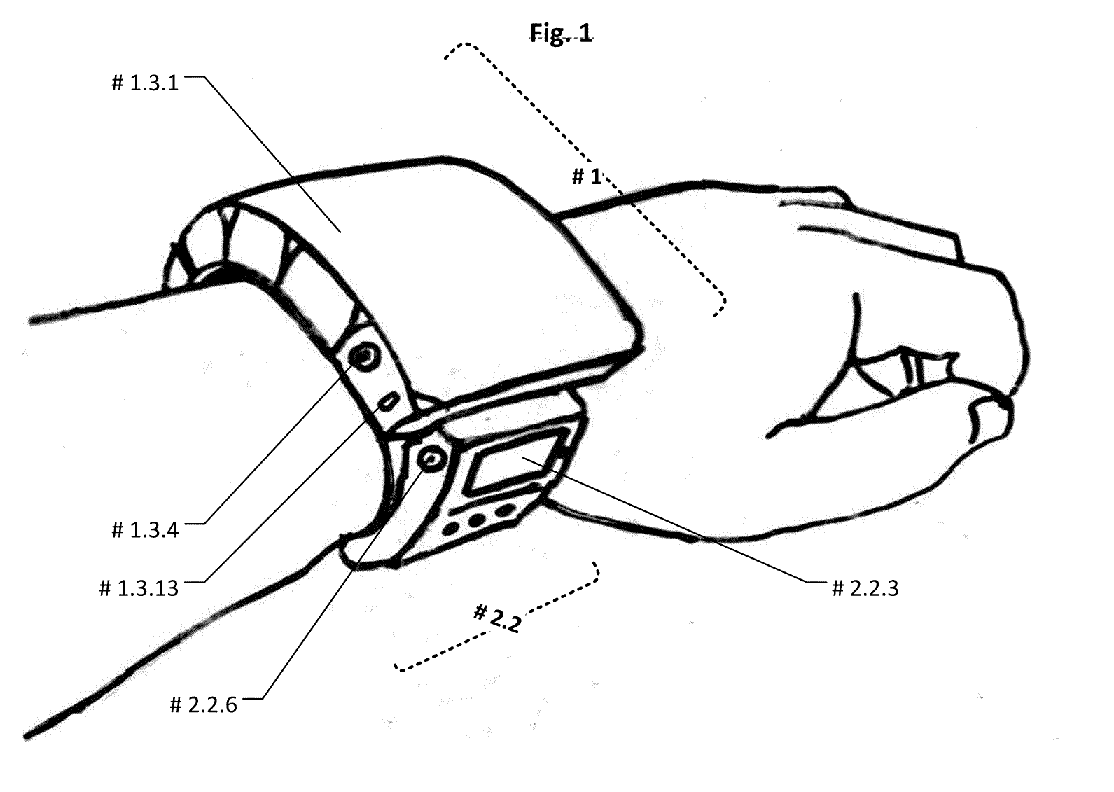

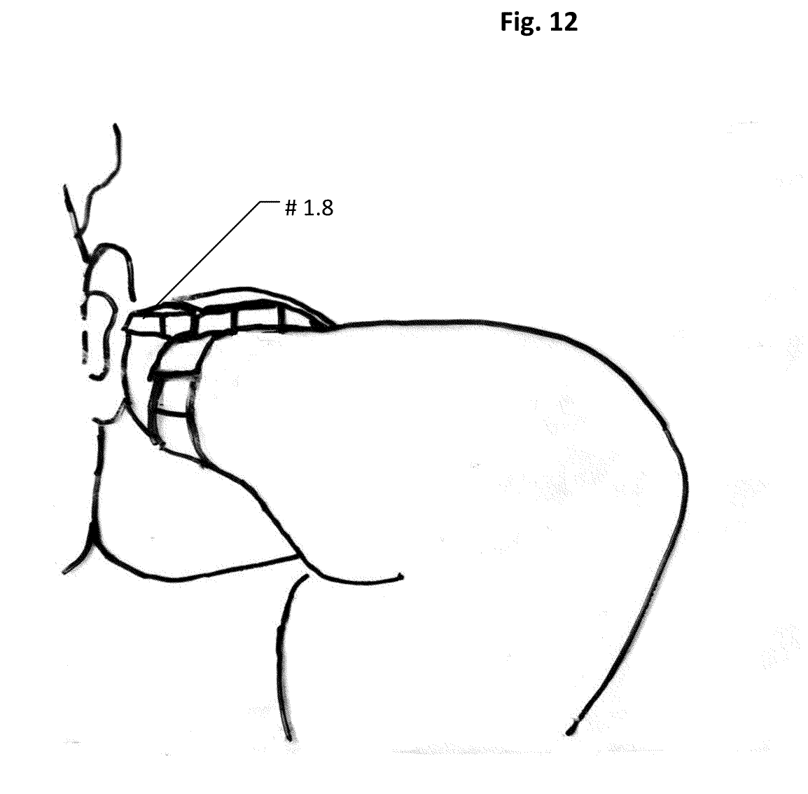

State a1: wrist wearable Communication device taken its Bent shape, with the flexible Display assembly in the Lowered position—meaning the Display assembly is attached to the body of the Communication device at both its Top and Bottom areas (see FIGS. 1, 2, 9, 18, 29(a, b, c)). This State is mostly suitable for an “on-the-go” situation when the user performs functions requiring limited user input and no full-screen visual output: checking time, alerts, status messages, reading text messages and short emails, operating audio player, placing and accepting voice calls (including via the “Fingerless call” method—see FIG. 12), creating voice memos/recording audio, executing simple retail shopping transactions via e-wallet applications (including paying a public transport fare), unlocking doors, vehicles, lockers, online access pages, etc. Also, this State is suitable for performing urgent photo shooting or audio recording or video recording in an emergency situation (with or without immediate uploading or real-time streaming to a secure remote server) or other situation requiring prompt reaction to capture valuable information.

State a2: same as a1, but with the Touchpad Keyboard unit in the fold-out position. This State is mostly suitable for performing, in an “on-the-go” environment, functions requiring significant user input but not full-screen visual output: composing short messages, browsing lists of alerts and/or messages, controlling various applications not relying on full-screen visual feedback, etc.

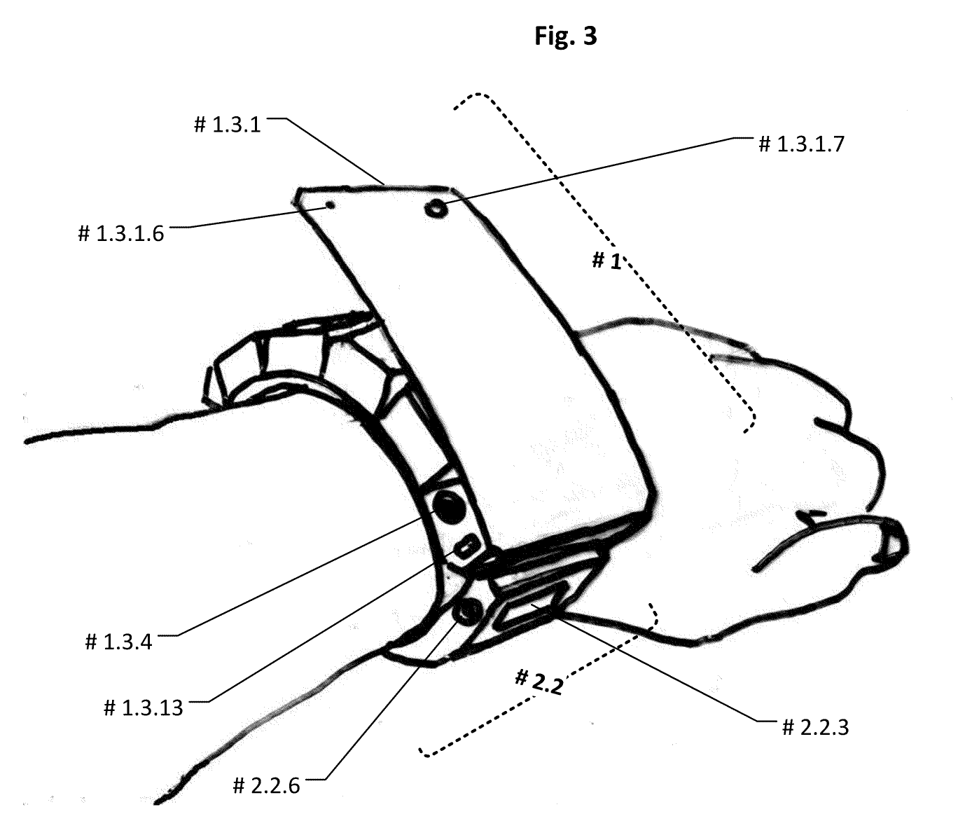

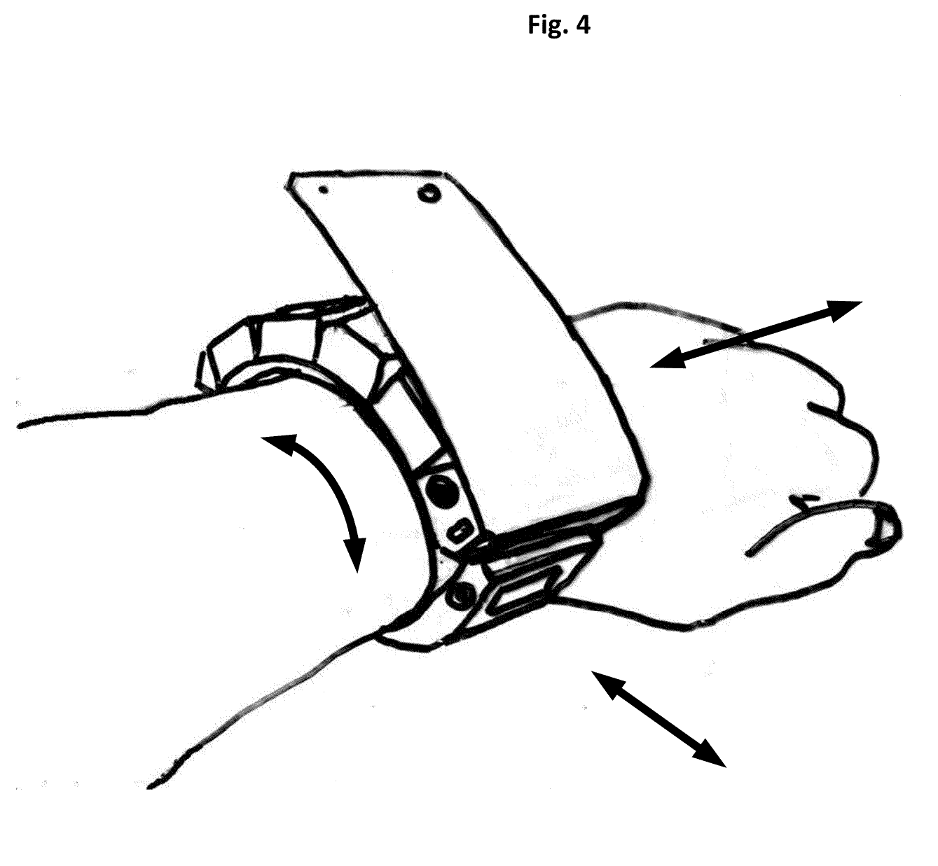

State b1: wrist wearable Communication device taken its Bent shape, with the flexible Display assembly in the Raised position—meaning the Display assembly is attached to the body of the Communication device at the Bottom area and detached (raised, popped up) at the opposite Top area (see FIGS. 3, 4). This State is mostly suitable for an “on-the-go” situation when the user performs functions requiring full-screen visual output but limited user input: browsing/looking at pictures, watching videos, basic photo or video shooting, reading texts, performing video calls/video chats, browsing maps/operating navigation applications, browsing web pages requiring limited input, executing advanced retail shopping transactions via e-wallet applications with catalogs browsing, etc.

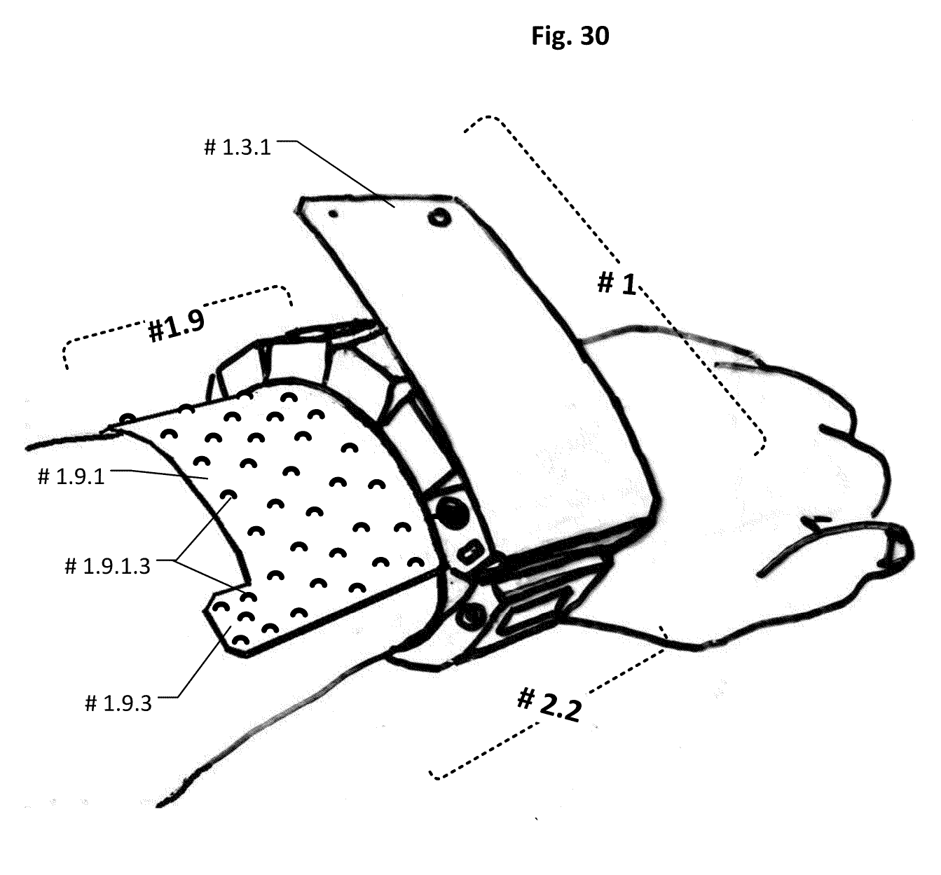

State b2: same as b1, but with the Touchpad Keyboard unit in the fold-out position (see FIG. 30). This State is mostly suitable for an “on-the-go” situation when the user performs functions requiring significant user input and full-screen visual output: composing long text messages/emails, creating text memos or sketch drawings, advanced photo or video shooting (with manual adjustment of parameters in real time), working with web pages requiring significant user input (like search engines, e-commerce, online banking web sites), etc.

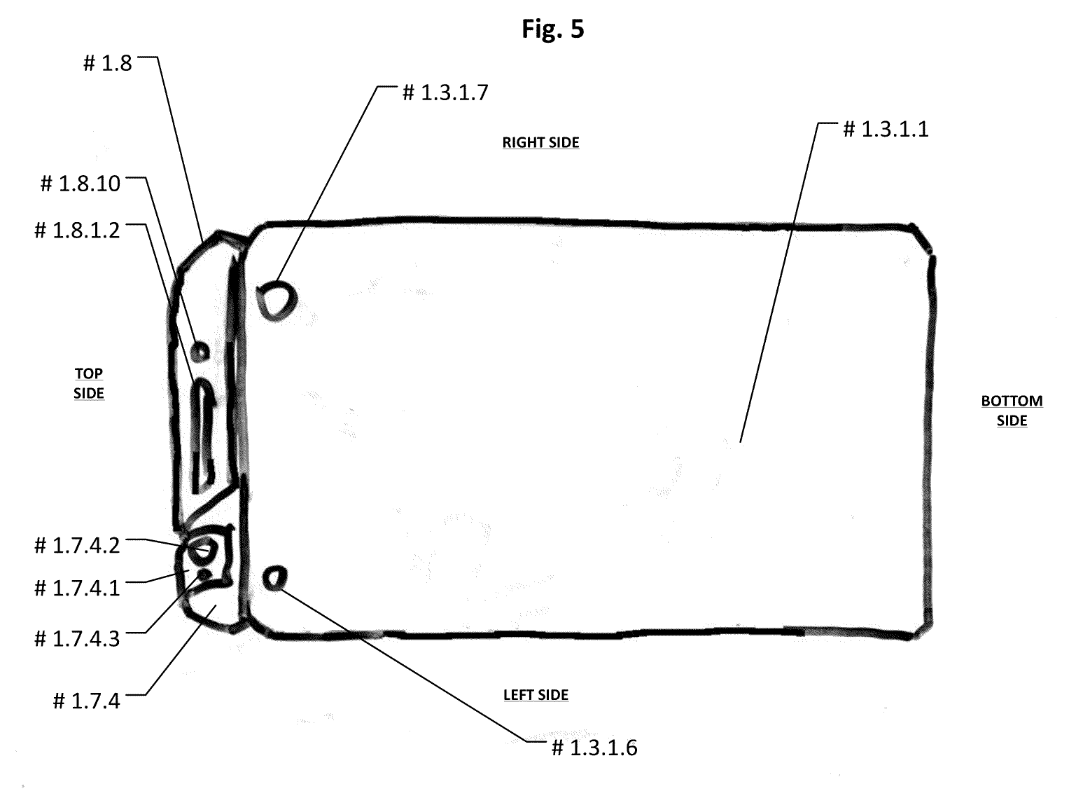

State c: handheld/pocket/cradle-, windscreen- or dashboard-mount Communication device taken its Flat shape (see FIGS. 5, 20, 21, 27, 28). This State is mostly suitable for performing, in a more stable environment like a passenger seat in a transport, a wide variety of functions requiring two hands operation and/or horizontal (landscape) full screen visual output: playing games, watching movies, reading books, typing texts with up to four fingers, browsing web pages containing multimedia, shooting in a portrait or landscape orientation, etc.

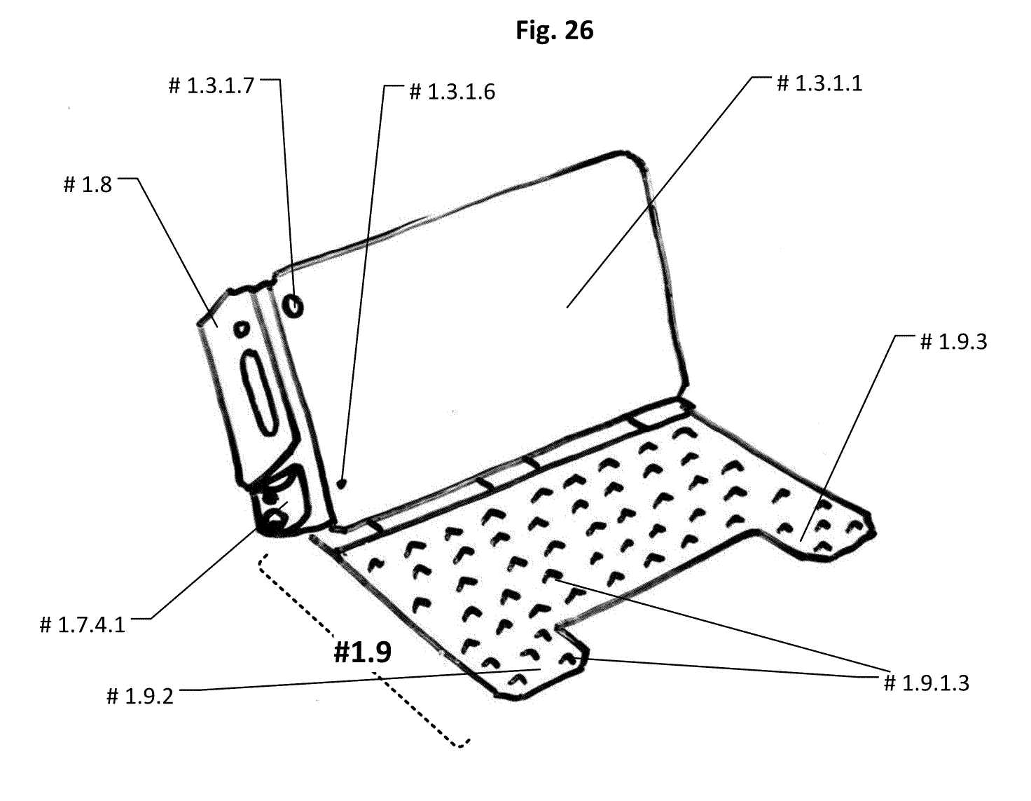

State d: desktop Communication device (see FIG. 26). This State is mostly suitable for performing, in a stable environment like an office, a wide variety of functions including fast text typing with multiple fingers, controlling applications/working with documents via mouse (if detached from the Communication device, the Removable Earpiece unit may be used as the mouse) and/or an external display, placing or receiving voice and video calls, browsing Web pages etc. This State is also convenient for performing confidential data input/output operations (Communication device either operates standalone (i.e. connected to a network only) or supports the Secure Terminal mode while connected to a PC or similar external device—see Usage Modes A and G below respectively).

Depending on its Version and/or Configuration Variant, the Communication device may take either a subset of the States listed above or all of them. See Table 1 below for the full list of possible combinations between the Communication device's Version, Configuration Variant and State.

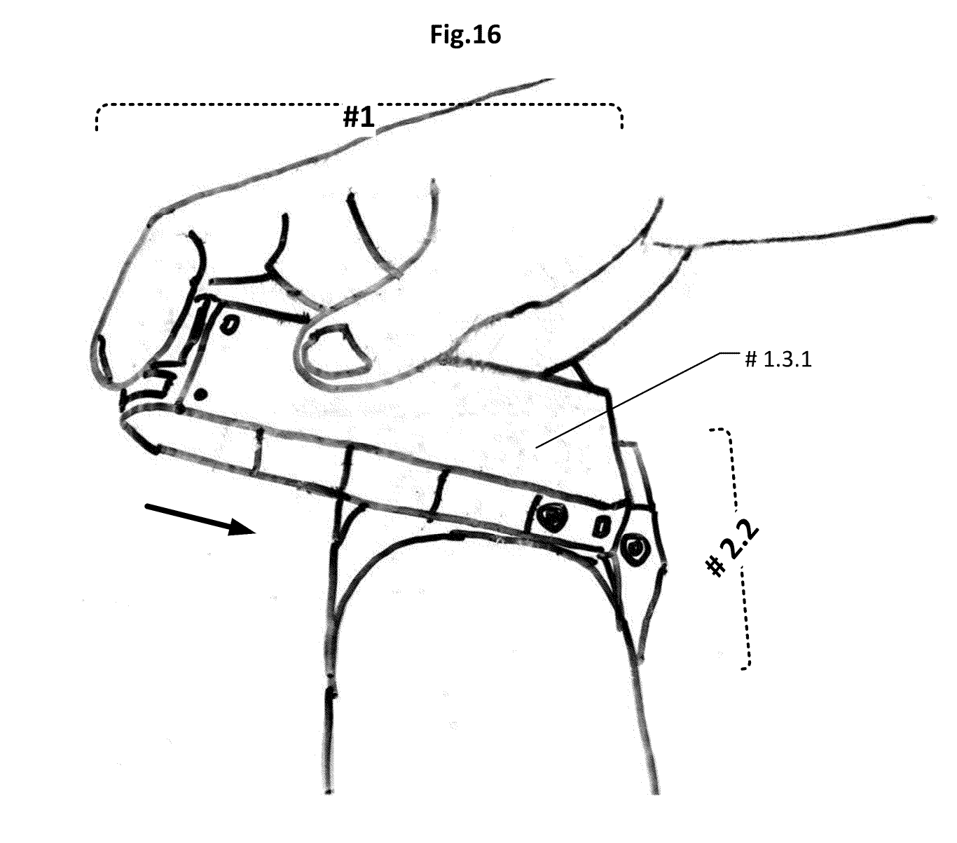

The Communication device may be reversibly attached to the Wearable Data Management device (see 2.2 below) worn on a wrist in order to take States a1, a2, b1 or b2. The attachment procedure is shown by steps on FIGS. 16 through 18.

To support these States, the flexible parts of the Communication device allow it to be worn on a wrist in a Bent shape, with approximately the same level of comfort as that of a large watch.

After being detached from the Wearable Data Management device and after subsequent manual or semi-manual (spring-assisted) manipulation, the Communication device changes its shape into Flat and thus is transformed into a handheld/pocket device (State c) which is very similar in its physical, mechanical and handling characteristics to an existing smartphone featuring the standard flat planar form factor.

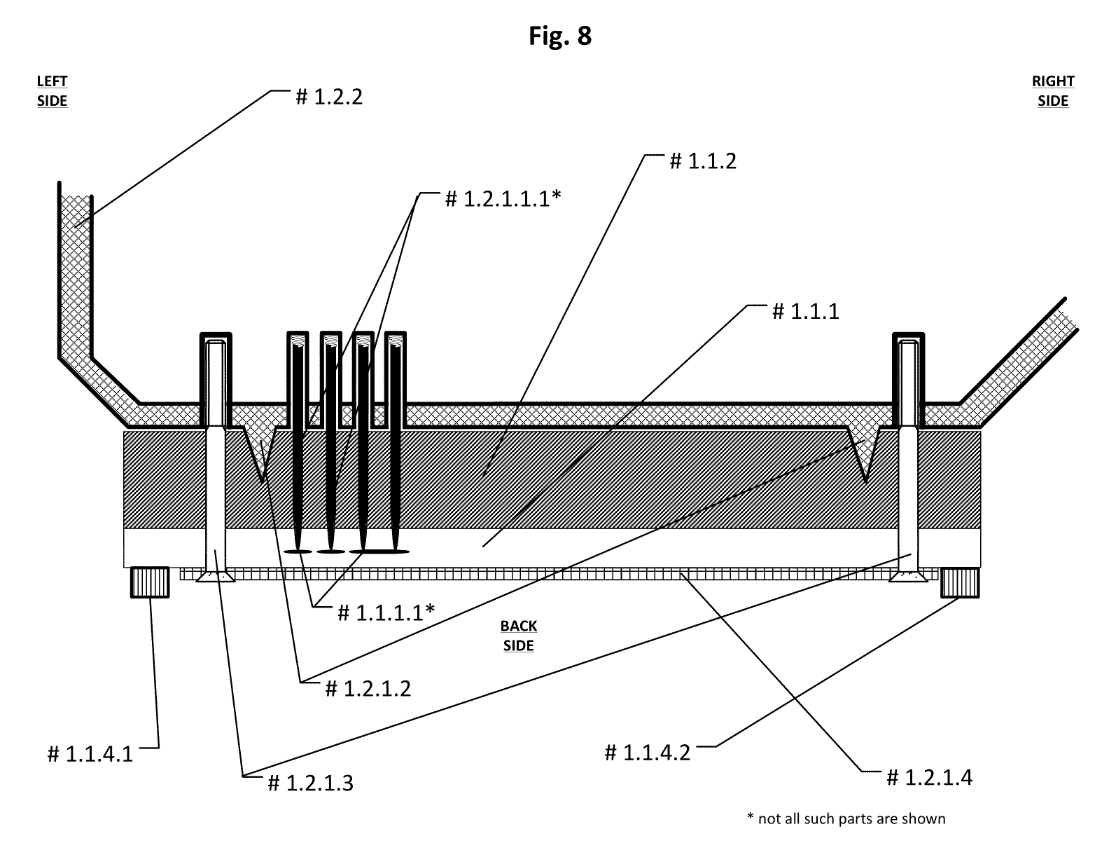

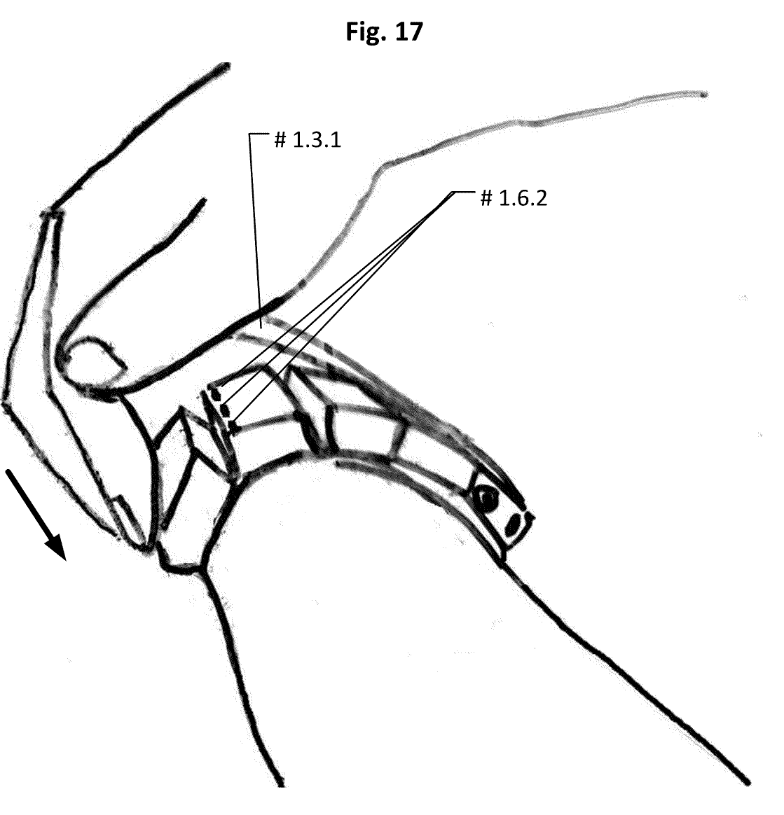

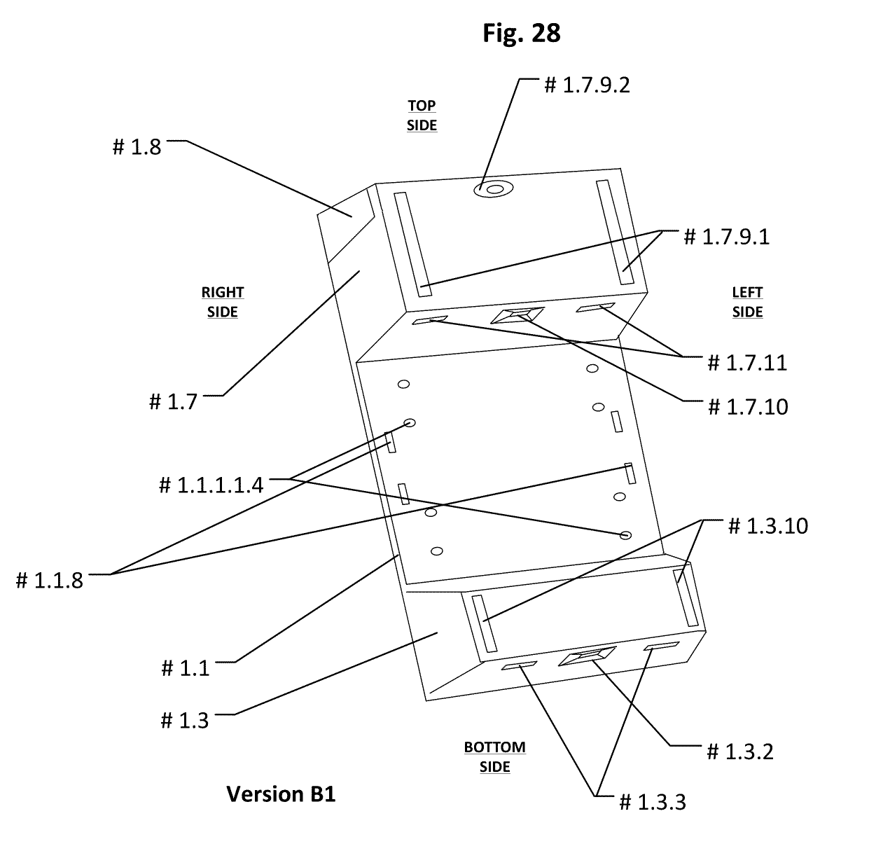

The Communication device features modular design with most of its electronic components located inside or at an external surface of housings of several container-type components called Modules. Each Module is attached in a semi-permanent manner to the common flexible Base (see FIGS. 17 and 28. A cross section of the attachment mechanism is shown on FIG. 8).

The Communication device may have 2 or more Modules. Some of the Modules may be purchased separately and installed by the user to enhance functionality and/or performance of the device. Such Modules are called Extension Modules.

The Communication device may also have one or more Removable Modules. Their reversible attachment mechanism is designed to allow quick, frequent and secure attachment and removal. The mechanism may require usage of intermediate connectors or sockets that will be attached to the Communication device's flexible Base in the same semi-permanent manner as the Modules described above.

The Communication device may also be used in combination with a keyboard named Touchpad Keyboard unit with flat, flexible, foldable design and featuring a combination of properties of a touchpad (i.e. a surface that senses positions of one, two or more fingertips that touch it) and a conventional keyboard with physical keys (implemented as pressure-sensitive relief points). The Touchpad Keyboard unit is reversibly attached to its parent device (the Communication device).

The Communication device may also be used in combination with the reversibly removable (wireless) earpiece device named Removable Earpiece unit. When attached, the Removable Earpiece unit works as a common earpiece (earphone) component similar to those built into most existing smartphones. The Removable Earpiece unit comprises a microphone which may or may not perform the functions of a conventional smartphone's second microphone at this time. When detached, the Removable Earpiece unit works as a wireless earpiece device (comprising a microphone). It may also perform the functions of a wireless optical mouse (primarily used when the Communication device is in the Desktop State (see State c above)). The Removable Earpiece unit comprises its own rechargeable battery but typically needs to be attached to the Communication device for being recharged together with it.

The software run by the Communication device (including operating system) may differ from the standard software run by existing smartphones, because the former may be required to support operations of certain components (the Touchpad Keyboard unit, the Removable Modules, etc.) or interaction with external devices within the Wearable Complex or the Security Complex (see the definitions in paragraph 1. above) or beyond. The details of this interaction are described in the Usage/interaction modes outlined below.

The described below path may be undertaken by a user wishing to customize a Communication device. To fit various requirements, the Communication device may be implemented in several Versions. Typically, a user would choose to purchase a single Version of the device that suits his or her personal needs best. After the purchase, the user may wish to configure the device's hardware to achieve even better fit to his/her requirements. To do so, the user may need to purchase additional components (Modules, a Touchpad Keyboard unit, etc.). Then these component(s) will be installed onto the Communication device via semi-permanent connections. Installation may require use of simple tools like a screwdriver. Installing new or replacing existing components in such a way means changing the device's hardware composition called Configuration Variant. Furthermore, while the device stays within the Configuration Variant chosen, the user may replace certain components attached in a reversible manner (for example, one or more Removable Modules, battery, memory card etc.). Such operation would be performed during normal use and would not require, as a rule, use of any instruments. Finally, the exact same hardware composition of the device may have its State changed by manipulation with the shape of the device and/or repositioning its certain parts (for example, folding or unfolding the Touchpad Keyboard unit). All possible Versions, Configuration Variants and States, together with their possible combinations, are described below.

There, are two main Versions for the Communication device: A. “Sandwich” and B. “Croissant”. The primary difference between them is the relative position of the main components of the device.

### Version A: “Sandwich”

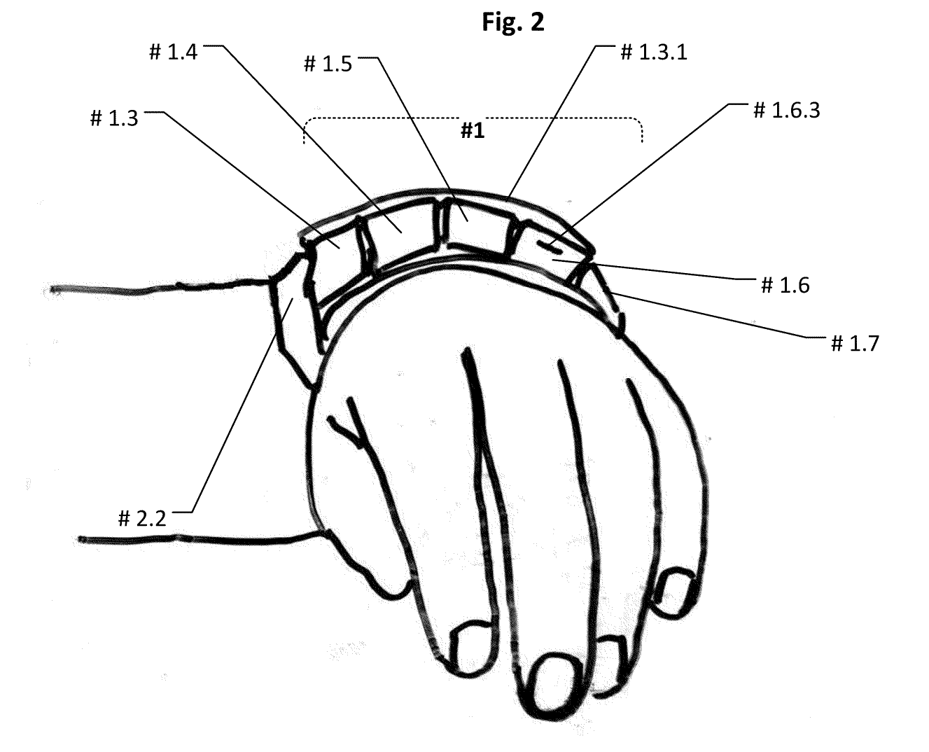

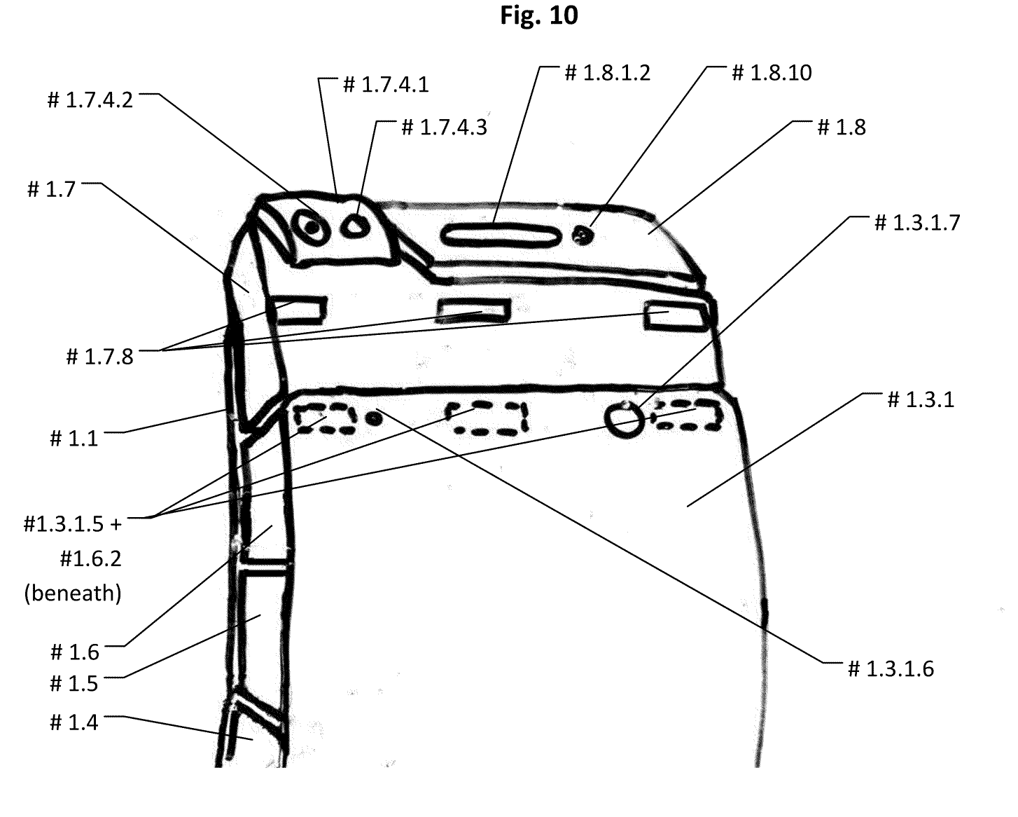

In Version A, a plurality of Modules is arranged between two flexible assemblies: the Display assembly at the Front side and the Base assembly at the Back side of the device. Each Module is attached to the Base assembly. The Back side of the Screen Assembly is attached in a permanent or semi-permanent manner to the Front side of the Bottom Module and the opposite (Top) side of the Screen Assembly may be either detached (raised) as shown on FIG. 2 or attached in a temporary (reversible) manner to either one of the two sets of Attachment Points located on the Front sides of one or more Modules (including the Top Module—see FIG. 10). Such attachment pattern allows the Screen Assembly to be fixed in its Lowered position when the device takes either Flat shape (for States c, d) or Bent shape (for States a1, a2, b1, b2). The first set of the Attachment Points is designed for the Flat shape of the device, and the second set for the Bent shape. The device relies on a tension created by the flexible Display assembly attached to the first set of Attachment Points to keep its Flat shape.

### Versions B1 and B2: “Croissant”

In Versions B1 and B2, two or more Modules are attached to the Back side of the flexible Base assembly in a semi-permanent manner. The flexible Display assembly is placed on the Front side of the Base assembly and attached in one of the two ways respectively for the two Versions B1 and B2:

In Version B1, one (Bottom) end of the Display assembly is attached permanently to the Bottom end of the Base assembly and another (Top) end attached in a temporary (reversible) manner to either one of the two sets of Attachment Points located on the Front side of the Base assembly. This device Version relies on a tension created by the flexible Display assembly attached to the first set of Attachment Points to keep its Flat shape.

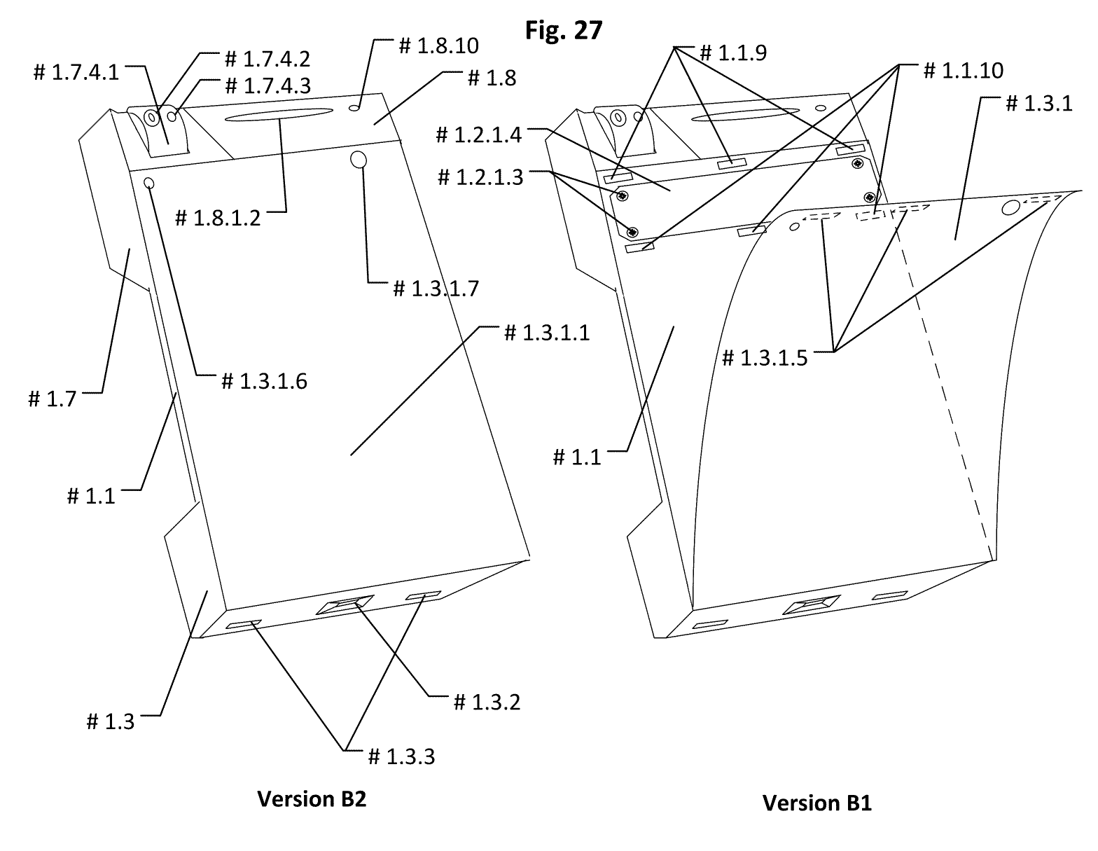

In Version B2, the Display assembly is integrated permanently with the Base assembly. See FIG. 27 (B2). This device Version relies on the self-flattening effect provided by the flattening mechanism with spring-like components comprised within the flexible Base assembly and/or within the integrated flexible Display assembly. One example of such flattening mechanism would be a set of spring-action bands made of a thin steel (or mechanically similar material), having a curved (arched) cross section similar to that of a steel measuring tape, and positioned parallel to each other in such a way that each band is stretched from Top side to Bottom side of the Base assembly. The set will contain at least one band positioned with its concave side upwards (facing the Front side of the device) and at least one band positioned with its concave side downwards (facing the Back side of the device).

TABLE 1
Possible combinations of Version, Configuration Variant and State for Communication device

| | | | | | | Wearable | |
|---|---|---|---|---|---|---|---|
| | | | | | | Data | |
| | | | | Touchpad | Display | Management | |
| | Configuration | | | Keyboard unit | assembly | device | Shown on |
| Version | Variant | State | Usage Type | position | position | position | Fig.(s.) |
| A: | with or without | a1 | Wrist-worn | Folded or | Lowered | Lower | 1, 2, 9, 12, 18 |
| “Sandwich” | Touchpad | | | removed | | | |
| | Keyboard unit | | | | | | |
| | attached | | | | | | |
| -″- | -″- | b1 | -″- | -″- | Raised | -″- | 3, 4 |
| -″- | with Touchpad | a2 | -″- | Fold-out (semi- | Lowered | -″- | |
| | Keyboard unit | | | folded) | | | |
| | attached | | | | | | |
| -″- | -″- | b2 | -″- | -″- | Raised | -″- | 30 |
| -″- | with or without | c | Handheld/ | Folded or | Lowered | N/A | 5, 6, 19, 20 |
| | Touchpad | | Pocket/ | removed | | | |
| | Keyboard unit | | Cradle- | | | | |
| | attached | | mount | | | | |
| -″- | with Touchpad | d | Desktop | Unfolded | -″- | -″- | 26 |
| | Keyboard unit | | | | | | |
| | attached | | | | | | |
| B1: | (a) with additional | a | Wrist-worn | N/A (removed) | Lowered | Lower | 29(a) |
| “Croissant” | Module(s) | | | | | | |
| with movable | | | | | | | |
| display | | | | | | | |
| -″- | -″- | b | -″- | -″- | Raised | -″- | |
| -″- | -″- | c | Handheld/ | -″- | Lowered | N/A | |
| | | | Pocket/ | | | | |
| | | | Cradle- | | | | |
| | | | mount | | | | |
| -″- | (b) with Touchpad | a1 | Wrist-worn | Folded | Lowered | Lower | 29(b) |
| | Keyboard unit | | | | | | |
| -″- | -″- | b1 | -″- | -″- | Raised | -″- | |
| -″- | -″- | a2 | -″- | Fold-out (semi- | Lowered | -″- | |
| | | | | folded) | | | |
| -″- | -″- | b2 | -″- | -″- | Raised | -″- | |
| -″- | -″- | c | Handheld/ | Folded | Lowered | N/A | |
| | | | Pocket/ | | | | |
| | | | Cradle- | | | | |
| | | | mount | | | | |
| -″- | -″- | d | Desktop | Unfolded | -″- | -″- | |
| -″- | (c) “Lean” | a | Wrist-worn | N/A (removed) | Lowered | Upper | 29(c) |
| -″- | -″- | b | -″- | -″- | Raised | -″- | |
| -″- | -″- | c | Handheld/ | Folded | Lowered | N/A | 27(B1), 28 |
| | | | Pocket/ | | | | |
| | | | Cradle- | | | | |
| | | | mount | | | | |
| B2: | (a) with additional | a | Wrist-worn | N/A (removed) | Lowered | Lower | |
| “Croissant” | Module(s) | | | | (fixed) | | |
| with fixed | | | | | | | |
| display | | | | | | | |
| -″- | -″- | c | Handheld/ | -″- | -″- | N/A | |
| | | | Pocket/ | | | | |
| | | | Cradle- | | | | |
| | | | mount | | | | |
| -″- | (b) with Touchpad | 1 | -″- | Folded | -″- | -″- | |
| | Keyboard unit | | | | | | |
| -″- | -″- | 2 | -″- | Fold-out (semi- | -″- | -″- | |
| | | | | folded) | | | |
| -″- | -″- | c | Handheld/ | Folded | -″- | N/A | |
| | | | Pocket/ | | | | |
| | | | Cradle- | | | | |
| | | | mount | | | | |
| -″- | -″- | d | Desktop | Unfolded | -″- | -″- | |
| -″- | (c) “Lean” | a | Wrist-worn | N/A (removed) | -″- | Upper | |
| -″- | -″- | c | Handheld/ | -″- | -″- | N/A | 27(B2) |
| | | | Pocket/ | | | | |
| | | | Cradle- | | | | |
| | | | mount | | | | |

Legend for Table 1
-″- stands for “see above”
NOTES:
The Shape taken by the Communication device is associated with Usage Type. For the Wrist-worn Usage Type, the Shape is Bent. For other Usage Types (Handheld/Pocket/Cradle-mount, Desktop) the Shape is Flat.
The prevalent display orientation is also associated with Usage Type. For the Wrist-worn Usage Type, it's vertical (portrait). For the Desktop Usage Type, it's horizontal (landscape). For Handheld/Pocket/Cradle-mount Usage Type it can be either one.
The “cradle” mentioned in the Handheld/Pocket/Cradle-mount Usage Type is an accessory that may itself be placed on a desktop or mounted on a vehicle etc.

### Usage/Interaction Modes

This list runs through the whole Detailed Description section. Below, after a new device is described, the Usage/Interaction modes that have become possible with addition of this device are listed.

### Usage/Interaction Mode A: Communication Device (Standalone)

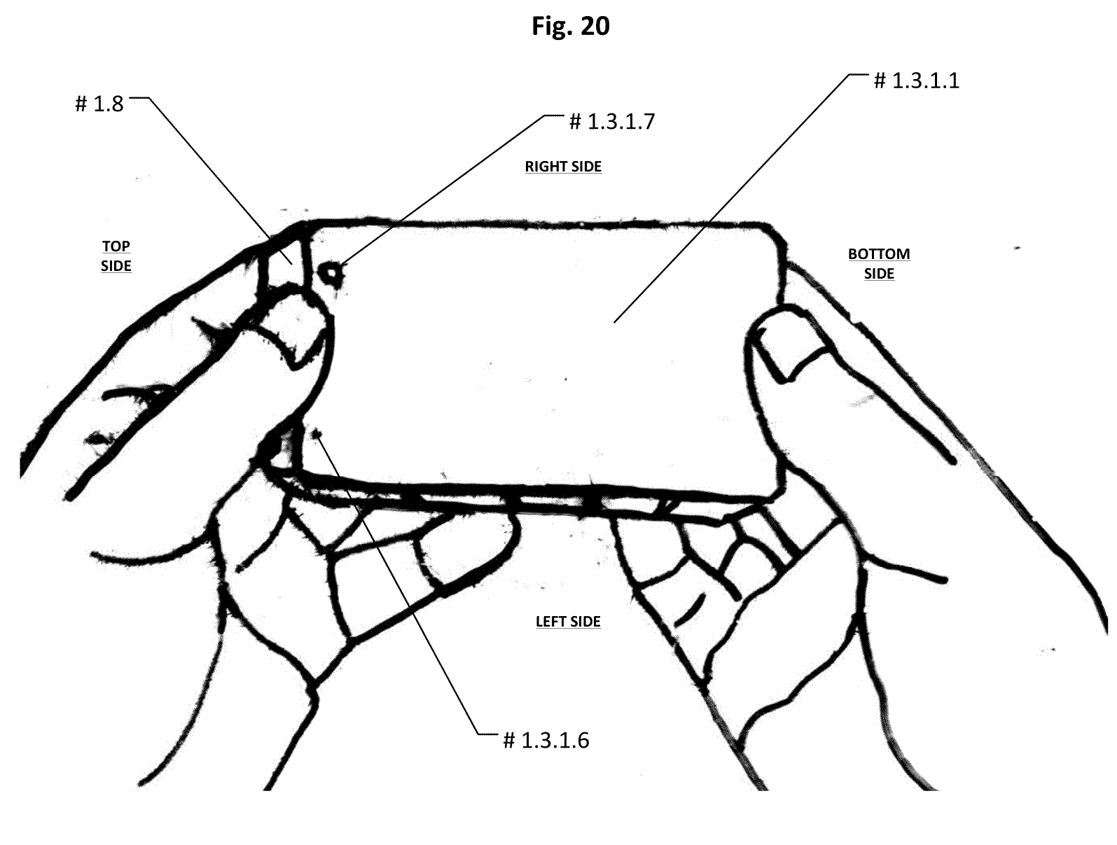

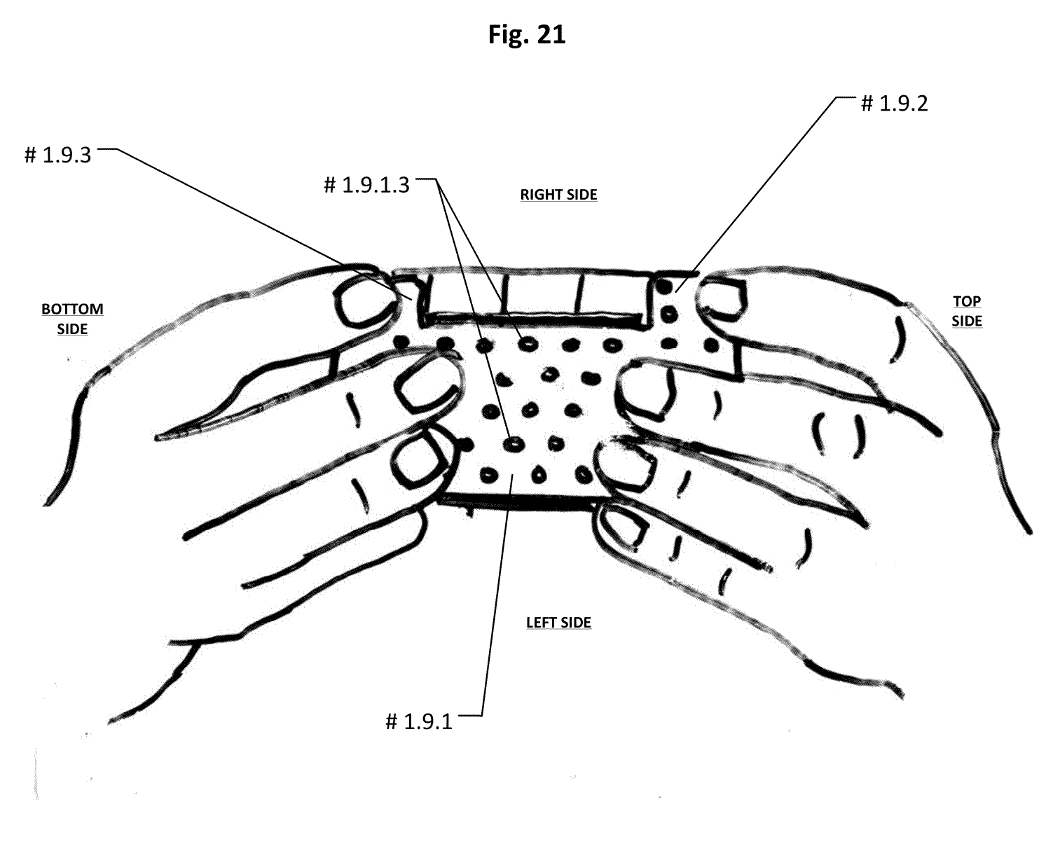

In its Handheld/Pocket/Cradle-mount State Communication device can perform all the common functions of existing smartphones and interact with the common accessories (chargers, wired headphones/headsets, cables etc.). The Removable Earpiece unit operates as a detachable wireless earpiece. If the Touchpad Keyboard unit is attached, it allows text typing, gaming etc. by finger movements applied at the back side of the Communication device (see FIGS. 20 and 21). In its Desktop State with the Touchpad Keyboard unit attached, the Communication device can serve as a desktop mini-computer (see FIG. 26). If detached, the Removable Earpiece unit may be used as either a wireless earpiece or a wireless mouse. The Communication device may be connected to common accessories such as chargers or to peripheral devices such as printers and monitors. When using a connected external monitor or projector, the Touchpad Keyboard unit allows for more convenient and fast desktop typing operation than most existing mechanical or virtual smartphone keyboards since user fingers' movements within a small desktop area are translated to the movements of finger or fingertip images within a much larger display area, with the user not being required to look at the first area and therefore avoiding eyestrain from constantly switching eyesight between the two focus areas (i.e. a display and a conventional keyboard). This “blind” method of typing is similar to a conventional mouse operation which also is very fast, efficient and accurate because of almost 100% of the user visual attention being dedicated to the display and user's hand being able to operate with limited horizontal movements and almost zero vertical movements.

### 2.2 Wearable Data Management Device

A Wearable Data Management device is a bracelet-like device with radio and electronic components/connectors that allow it to perform certain functions, including, but not limited to, wirelessly communicating with Lock Data Storage units (see 2.4 below) hosted by various electronic/electromechanical locks or other host objects, vehicles or devices. Such communication is performed directly between the two devices having established a wireless link, or via a radio circuit of a host object/vehicle/device. Also, the Wearable Data Management device may communicate with other radio-enabled authorization/validation devices (POS terminals, bank ATMs, access card readers etc.).

A Wearable Data Management device has an internal compartment which accepts a removable Key Data Storage unit (see 2.3 below). This compartment has an Access window which opens on the inner side of the Wearable Data Management device bracelet making it impossible to remove the Key Data Storage unit without taking the Wearable Data Management device off the wrist and tripping the Integrity Sensor. This Sensor the Wearable Data Management device's bracelet is equipped with issues an electronic signal whenever the bracelet is taken off the wrist, unfastened, torn or has its physical integrity breached in some other way. The signal is sent to the Key Data Storage unit (see 2.3 below) hosted by the Wearable Data Management device causing the former to lock itself i.e. to stop read or write operations with any confidential data until the user provides sufficient credentials via the host device (enters PIN and/or provides a valid fingerprint etc.).

A Wearable Data Management device may be equipped with a fingerprint sensor (on its outer side) to enable quick and secure user authorization.

Other sensor(s) may be placed on the inner side of the bracelet to come into direct contact with user's skin. Such sensor(s) may measure/monitor biological parameters such as body temperature, pulse, blood pressure etc. Also, a sensor-scanner may be installed performing infrared, ultrasonic or other type scanning of the wrist skin and/or underlying tissues. The information collected by this sensor(s)/scanner may be used to:
verify that the Wearable Data Management device is worn on a wrist of a live and conscious person;
verify that the person who wears the Wearable Data Management device is an authorized user;
monitor user's bio parameters/health status and issue alerts if necessary.

Wearable Data Management device is equipped with its own rechargeable battery (which is either a permanent, semi-permanent or removable part). The Wearable Data Management device can be charged either alone or together with a Communication device attached/connected.

### Legend for Usage/Interaction Modes

- - electromechanical (wired) connection
∥ wireless (radio) connection
|- wireless (radio) OR wired connection
̂ Master device
* Master or Peer device
[s] one or many such devices participating
< > external device (beyond the eight described devices)

### Example:

Lock Data Storage unit- -Wearable Data Management devicê- -Key Data Storage unit, |-Communication device

This statement means:
a Lock Data Storage unit has a wired connection to a Wearable Data Management device;
the Wearable Data Management device has a wired connection to a Key Data Storage unit;
the Wearable Data Management device has a wired or wireless connection to a Communication device;
this bundle is used for a Contract Generation and the Wearable Data Management device acts as a Master device.

### Usage/Interaction Mode B:

Wearable Data Management device (standalone)

The device can be used as an electronic watch (with vibration and sound alarm capabilities).

### Usage/Interaction Mode C1:

Wearable Data Management device- -Communication device

A Wearable Data Management device hosts a Communication device mechanically attached and electrically connected to it. The Communication device can perform common smartphone functions, some of which will benefit from the Wearable Data Management device's placement on the user's wrist. For example, user can answer a call (or place a call via voice dialing) in a “fingerless” manner—by merely raising the arm and putting the Communication device to close proximity of the ear (see FIG. 12). In addition, the device can perform extended functions (beyond the common smartphone functionality) supported by electronic components contained in one or more Extension Modules (see paragraph 1. above)—for example, measuring environment parameters using barometer, thermometer, gas analyzer or other sensors. Some of the extended functions also require the device to be placed on a wrist.

Also, the two devices may work as a complex to support certain functions or applications while exchanging data between each other. For example, the display on the Wearable Data Management device may work as a secondary display (which the user can look at, in many cases, faster and with less effort than at the primary display of the Communication device). Such secondary display may be used for specific information like current time in the main or the second time zone, brief list of alerts/messages received etc. Thus the secondary display of the low power consumption type (LCD etc.) may constantly display the most important information and the primary display may be turned on only on demand to save power. The Communication device may be programmed to turn off its audible alert signals and start using the vibration alarm of the Wearable Data Management device as soon as the two devices are connected. The applications running on the Communication device may utilize data supplied by bio sensors and/or other sensors comprised in the Wearable Data Management device. The Communication device may use the wireless circuits of the Wearable Data Management device to establish radio connection with external devices.

Besides the described above data exchange, a power exchange may be also possible: if either one of the devices has its battery depleted, the other device's battery may power both devices for some time. If the Wearable Data Management device is connected to an external accessory or device, it can pass data to/from and power to the Communication device. In particular, connecting the Wearable Data Management device to a charger accessory will enable charging of Wearable Data Management device, Communication device and Removable Earpiece unit batteries simultaneously.

### Usage/Interaction Mode C2:

Wearable Data Management device∥Communication device

A Wearable Data Management device wirelessly connects to a Communication device and receives alert messages and other information that the user can read without taking the Communication device out of a pocket, bag etc. For example, incoming calls received by the Communication device may trigger vibration and/or sound ringer on the Wearable Data Management device worn by the user thus ensuring with high probability that the call will not be missed.

In turn, the Wearable Data Management device can transmit data to the Communication device to control certain applications remotely, initiate an audible signal at the Communication device to locate the latter etc.

### 2.3 Key Data Storage Unit

Key Data Storage unit is an electronic device with the primary functions of storing confidential data, primarily in the form of multiple Time-arranged Code Arrays, and providing authorized read access for its host device to limited (time-specific) portions of data (Code Vectors) contained in such Arrays. This current time-specific data access is enforced by the Key Data Storage unit's internal processor (or control circuit) and the internal clock. The Key Data Storage unit also can write into its memory storage a new Code Array data generated by an authorized Master device—for example, a Wearable Data Management device, and can delete one or more Code Arrays. The Key Data Storage unit features protection from physical breach/tampering with/unauthorized data reading on an inherent physical design level, thus making it virtually impossible for any person or entity, including the user/owner and the designer/manufacturer, to perform unauthorized reading of contained confidential data (including reading Code Vector(s) assigned to future periods, regardless from authorized or unauthorized Code Array(s)). The Key Data Storage unit can be inserted into the dedicated compartment (Internal cavity) on a Wearable Data Management device to create a complete wearable electronic key solution (with or without connected Communication device). The internal memory storage of the Key Data Storage unit may have memory capacity sufficient to store 50-100 or more Code Arrays (each containing one Code Vector per each few minutes' period within a few years' timeframe—i.e. approximately 500,000 Code Vectors). The Key Data Storage unit requires external power source to operate. However, in order to perform data protection functions during Idle Periods when no power is supplied by a host device or the Key Data Storage unit is not connected to any host device, the Key Data Storage unit may have its own internal battery and/or capacitor (as a permanent, non-removable part or parts) capable of storing enough energy to perform, within the duration of each Idle Period, both data protection functions outlined below:
running periodical integrity check to verify mechanical, electrical etc. integrity of the protective Shell which prevents unauthorized access to the Key Data Storage unit's internal memory storage and other electronic circuits;
if the “Purge” Event is triggered, performing (at least once) complete irreversible deletion of all the confidential data contained in the memory storage.

The Key Data Storage unit's internal processor/controller is programmed to trigger the “Purge” Event if the sensor circuit(s) connected to it detect(s) any of the following conditions:
a periodical or on-demand integrity check reveals a mechanical, electrical, etc. breach of the Protective Shell or other type of tampering with the Key Data Storage unit;
the energy stored in the internal battery and/or capacitor falls below the minimum level required to fulfill both the data protection functions outlined above.

Note: some less confidential data may be excluded from the deletion procedure following a “Purge” Event if the latter was triggered by the second condition given above, and therefore such less confidential data can be retained by Key Data Storage unit for much longer time than a normal Idle Period.

### Usage/Interaction Mode D:

Key Data Storage unit- -Wearable Data Management device*

Key Data Storage unit is inserted into a special compartment (Internal cavity) in the host Wearable Data Management device to provide secure electric & mechanical connection. The compartment opens on the inner side of the Wearable Data Management device's bracelet to prevent the Key Data Storage unit from being removed while the Wearable Data Management device is worn and thus to enable the auto-locking function (see paragraph 2.2 above). Since the Wearable Data Management device has its own processor and radio communication circuit(s), such combination may serve as a universal electronic key for simple situations—i.e. for those not requiring a large touchscreen and/or advanced computational power and/or other features that a Communication device would provide.

### Usage/Interaction Mode E1:

Key Data Storage unit- -Wearable Data Management device*- -Communication device

A Key Data Storage unit is inserted into the special compartment (the Internal cavity) within the Wearable Data Management device which hosts the attached Communication device, and the combination of the three devices (called Wearable Complex) is worn on a wrist.

This is one of the most common Usage Modes, enabling broad functionality including a universal electronic key for more complex situations than those mentioned above in the Usage/Interaction Mode D—i.e. for situations requiring large touchscreen and/or advanced computational power and/or other features that the Communication device provides.

Since the connection is wired, it provides faster data exchange and higher security level (i.e. lower chance of data being intercepted) than the wireless variant (described in Usage/Interaction Mode E2 below).

This combination of devices is capable of supporting all the functions mentioned in the Usage/Interaction Mode C1 (see above) which describes the same combination except the Key Data Storage unit is absent. In addition, it may perform functions associated with confidential data stored in the Key Data Storage unit, for example:
communication with locks and access control devices;
data encryption/decryption and associated data communication.

### Usage/Interaction Mode E2:

Key Data Storage Unit- -Wearable Data Management device∥Communication device

A Key Data Storage unit is inserted into the special compartment (the Internal cavity) within the Wearable Data Management device worn on a wrist, and the Communication device is used as a handheld, pocket, desktop, or cradle/windscreen/dashboard-mount device which connects wirelessly to the Wearable Data Management device to exchange data, for example to transmit and receive data related to some transaction requiring authorization, validation, encryption/decryption etc.—with the use of one or more Code Vector(s) retrieved from the Key Data Storage unit's memory. Also, other types of data exchange are possible—for example, Communication device can send to Wearable Data Management device alert signals to activate vibration and/or sound ringer in the Wearable Data Management device.

This is one of the most common Usage Modes, enabling broad functionality including a universal electronic key for complex situations—i.e. for those requiring large touchscreen and/or advanced computational power and/or other features that the Communication device provides.

Since the connection is wireless, it typically provides slower data exchange and lower security level (i.e. higher chance of data being intercepted) than the wired variant (see E1 above).

### Usage/Interaction Mode E3:

Key Data Storage unit[s]- -Wearable Data Management devicê- -Communication device

This combination is used for generation of a Contract between two or more Key Data Storage units and thus, between the owners of these devices. The Wearable Data Storage acts as a Master device generating the pseudo-random data for a new Code Array and orchestrating the procedure of writing the Code Array into memory of Slave devices—the Key Data Storage units that are subsequently connected by the user to the Master device. The Communication device may be used to provide user interface for controlling and monitoring the process. All wireless communication circuits of the device's may be turned off until the procedure is completed to assure maximum data security.

### Usage/Interaction Mode F:

<PC>|-Wearable Data Management device- -Key Data Storage unit

A Key Data Storage unit is inserted into the special compartment (the Internal cavity) within a Wearable Data Management device worn on a wrist, and the Wearable Data Management device is connected via a USB or similar port or wirelessly to an external PC or similar device. This is one of the most common Usage Modes for performing online authorization, validation, data encryption/decryption etc.

However, this Usage Mode does not entirely protect from malware capable of intercepting information that the user enters via a physical or virtual keyboard on the PC or reads from the PC display. The PC remains potential security vulnerability since it's controlled by a common open-type operating system which is easily targeted by malware etc. attacks.

### Usage/Interaction Mode G:

<PC>|-Wearable Data Management device- -Key Data Storage unit, - -Communication device

A Key Data Storage unit is inserted into the special compartment (the Internal cavity) within a Wearable Data Management device worn on a wrist, and the Wearable Data Management device is connected to both Communication device and—via a USB port or other port or wirelessly—to an external PC or similar device. This is preferable Usage Mode for performing online authorization, validation, data encryption/decryption etc.

This Usage Mode provides very high data security/protection level if the user engages the Secure Terminal mode. With this mode, the main processor (CPU) of the Communication device (which normally runs a common open-type operating system such as Android) is put into a suspended state and control over the Communication device's display, its Touchpad Keyboard unit (if available) and its other peripherals is passed to the processor of the Wearable Data Management device running a simplified, closed-type operating system (or other specialized program) whose instructions are stored in the Wearable Data Management device's ROM or RAM component(s) and are hardware-protected from modification by malware or any user-installed software. After that, the Wearable Data Management device processor interacts with the external PC in such a manner that no confidential data in unencrypted or decrypted form exists anywhere within the PC at any time, but only within the protected components controlled by the Wearable Data Management device processor: internal memory of the Wearable Data Management device, the Key Data Storage unit and the Communication device, the display of the Communication device and the Touchpad Keyboard unit. Alternatively, the Communication device's processor may be not put in a suspended state but start running a different operating system instead (preferably a closed-type one).

For example, if a Web page received from a Web server contains confidential data in certain fields only, it will be displayed in the PC's browser window with confidential data fields showing asterisks or other placeholder characters, while the Communication device display will show decrypted data contained in one or more of these fields (how much data will be shown may depend upon the position of the cursor on the PC's display, text lengths, appropriate settings made by the user etc.). In this example, the Wearable Data Management device processor, after receiving encrypted data from the browser program running on the PC, performs data decryption using one or more of the Code Vector(s) it retrieves from the Key Data Storage unit's protected memory and displays decrypted data on the Communication device screen.

When the user wants to enter confidential data (for example, into a field on a Web form), the Touchpad Keyboard unit (or a virtual keyboard displayed on the Communication device screen) will be used instead of the PC's keyboard or any virtual keyboard displayed on the PC's screen. Again, the PC display shows asterisks instead of unencrypted text which is visible only on the Communication device screen. In this example, the Wearable Data Management device processor performs data encryption using one or more of the Code Vector(s) it retrieves from the Key Data Storage unit's protected memory and then sends the data in encrypted form to the browser program running on the PC for sending further to the Web server.

The prerequisite for both such decryption and encryption operations is a pre-established Contract involving the Key Data Storage unit and some code storage device which the Web server interacts with (for example, a Stationary Data Storage device described below). In some cases, a part of the server's memory may be used instead of a physical code storage device. See paragraph 2.6 below for details.

This method protects from many types of malware attacks, including malware capable of intercepting information that the user enters via a physical or virtual keyboard on the PC or reads on the PC display. The PC's potential security vulnerability is neutralized by the fact that 100% of confidential data in its unencrypted (decrypted) form is isolated from the PC's memory and peripherals.

### 2.4. Lock Data Storage Unit

A Lock Data Storage unit is an electronic module similar in function and properties to a Key Data Storage unit described above except:

1) It typically stores only a single Code Array;
2) It may operate without allowing a host device to retrieve Code Vector(s) but instead just provides a binary response (Match/No match);
3) it may comprise a radio circuit for unidirectional or bidirectional communication with external devices, the circuit capable of converting radio signal into electric digital signal carrying Code Vector(s) and/or other data;
4) It may have no advanced security mechanism for confidential data protection with a breach-sensitive shell and thus no internal battery or capacitor.

A Lock Data Storage unit may be installed in various electronic or electromechanical locking devices to play a role similar to that of a cylinder in a mechanical lock.

These locking devices are designed to control physical and logical access to various movable and immovable objects, including (but not limited to): room doors, elevators, lockers, safes, vehicles, motorcycles, yachts and powerboats, aircraft, handguns, shotguns and other weapons, power tools and equipment (stationary or movable), laptops, desktop PCs and other electronic equipment.

### Usage/Interaction Mode H1:

Lock Data Storage unit- -Wearable Data Management devicê- -Key Data Storage Unit, |-Communication Device

### Usage/Interaction Mode H2:

Lock Data Storage Unit- -Wearable Data Management Devicê- -Key Data Storage Unit

In these two Usage/Interaction Modes, a Lock Data Storage unit is electrically connected to a Wearable Data Management device while a new Private Contract (see paragraph 8 for the term explanation) is generated (i.e. two identical or mathematically related Code Arrays are written into the Lock Data Storage unit's and Key Data Storage unit's memory chips). In the process, an optional Communication device connected to the Wearable Data Management device either via wired or wireless connection may be used to perform user interface functions.

### Related Method: Private Contract Generation

Prerequisites: a Lock Data Storage unit connected to a Wearable Data Management device via cable;
A Communication device is optional—if present, it is hosted by the Wearable Data Management device (wired connection takes place).

### Procedure:

Step 1. The Wearable Data Management device shuts down all radio communication for itself and, if applicable, for the connected Communication device

Step 2. Using the interface provided by the Communication device or the Wearable Data Management device, the user specifies:
Contract type;
the number and types of Slave devices (one or more Lock Data Storage unit(s)/Key Data Storage unit(s));
desired Validity Time Frame for the Contract (i.e. earliest Start Date/Time and latest End Date/Time for Validity Time Frame of any of the Code Vectors).

Step 3. The Wearable Data Management device creates new Contract ID and generates new Code Array filled with (pseudo) random data;

Step 4. The Wearable Data Management device writes the new Code Array (under the title of the new Contract ID) into the secure memory storage unit of the connected Lock Data Storage unit;

Step 5. The Wearable Data Management device writes the same new Code Array (or the one mathematically derived from the former), under the title of the new Contract ID, into the secure memory storage unit of the Key Data Storage unit it hosts.

If any device (Communication device, Wearable Data Management device, Stationary Data Storage device or other device) attempts to connect to or disconnect from the Wearable Data Management device while the latter is in process of contract generation, the generation procedure is stopped and canceled and the generated data is erased in every memory storage applicable, if possible.

Step 6. If applicable, the Wearable Data Management device signals the user to disconnect the first and connect the second Lock Data Storage unit. The user completes this action within certain timeframe, or the whole generation procedure will be canceled. The step is repeated for the third Lock Data Storage unit and so on.

Step 7. The Wearable Data Management device irreversibly erases the new Code Array and all the related confidential data from its temporary memory (RAM).

Step 8. The Wearable Data Management device signals the user about the completion of the generation procedure.

Example of the Failure recovery procedure: If one or more of the Lock Data Storage units and/or the Key Data Storage unit gets lost, damaged or stolen or becomes malfunctioning, the whole Contract has to be regenerated with the participation of all the related Slave devices. (The Contract is of Closed type not allowing to add new parties after the Generation has been completed). To avoid such situation, one or more of backup/replacement Key Data Storage units and/or Lock Data Storage units may be prepared at the time of the original Contract generation and put in a safe storage place (preferably with a connection to power source if life of internal batteries of these devices is expected to be shorter than the Contract's Term).

Usage/Interaction Mode I1:

<host object>- -Lock Data Storage unit∥Wearable Data Management device- -Key Data Storage unit, |-Communication device

Usage/Interaction Mode I2:

<host object>- -Lock Data Storage unit∥Wearable Data Management device- -Key Data Storage unit

A Lock Data Storage unit hosted by some object (for example, a door lock, a vehicle etc.) communicates via radio with a Wearable Data Management device located either within 1 cm or within few meters. The communication may be either bi-directional or uni-directional (when data is transmitted from the Wearable Data Management device to the Lock Data Storage unit), depending on a type of the host object and the specific usage scenario. Then the Code Vector contained in the Lock Data Storage unit's memory chip is compared by the Lock Data Storage unit's processor/controller chip with the Code Vector stored in the Key Data Storage unit's memory chip (received via radio communication). If the verification is positive the Lock Data Storage unit sends an electric signal that opens or unlocks the host object. The Communication device may or may not be used by the user to control and/or monitor the process. The host object also provides electric power for the Lock Data Storage unit operation. In the process, either the radio circuit comprised within the Lock Data Storage unit or a radio circuit the host object comprises may be used for wireless communication with the Wearable Data Management device.

### Valet Key Method

The special method may be used to control access to a vehicle, motorcycle, boat etc. with high levels of flexibility and security at the same time. The on-board computer of the vehicle hosting a Lock Data Storage unit may be re-programmed in such a way that the vehicle can still be accessed and started with one or more of the existing radio or mechanical or hybrid keys, but with a limited set of permitted operations and functions (for example, permitting driving only within a limited distance range and/or speed and/or time frame etc.). Thus the existing keys become “Valet Keys” to be used by valets, car dealership and repair shop employees, younger family members etc, while one or more of the participating Key Data Storage unit(s) hosted by Wearable Data Management device(s) become(s) “Master Key(s)” providing full access to the vehicle's functions, including re-programming of the permitted functions of “Valet Keys” and/or other (non-Master) Key Data Storage unit(s).

### 2.5 Installed Lock Device

Installed Lock device is an electronic/electro-mechanical adapter-type device that is designed to convert various door, safe etc. mechanical locks into electronic locks that can be opened via wireless contact with a device containing a matching Key Data Storage unit. Each Installed Lock device hosts a single Lock Data Storage unit that is inserted into a special compartment that opens on the secured (internal) side of the Installed Lock device. The Lock Data Storage unit may thus serve as a code storage unit and also as a radio communication circuit. The Installed Lock device features built-in mechanical (hand-driven) power generator to enable reliable operation with independence from batteries and external power sources.

### Usage/Interaction Mode J1:

Installed Lock device- -Lock Data Storage unit∥Wearable Data Management device- -Key Data Storage unit |-Communication device

Usage/Interaction Mode J2: Installed Lock device- -Lock Data Storage unit∥Wearable Data Management device- -Key Data Storage unit

### Usage Scenario—A Private Contract Execution:

Step 1. The user approaches the door or other object containing an Installed Lock device+a Lock Data Storage unit and places a Wearable Data Management device being worn on a wrist in a close proximity (usually 1-2 cm) from the lock's front panel containing antenna.

Step 2. If the internal battery comprised by the Installed Lock device contains sufficient power, the Lock Data Storage unit communicates via radio with Wearable Data Management device located within required range (typically few centimeters). Then the Code Vector contained in Lock Data Storage unit's memory chip is compared by the Lock Data Storage unit's processor chip with the Code Vector stored in the Key Data Storage unit's memory chip (received via radio communication). If the verification is positive the Lock Data Storage unit sends electric signal that unlocks the Installed Lock device (meaning that activated electromagnetic clutch mechanism within the Installed Lock device translates rotational motion from external door handle to linear motion of pistons or other lock parts). The Communication device may or may not be used by the user to control and/or monitor the process. The Installed Lock device also provides electric power for the Lock Data Storage unit operation;

Step 3. If the internal battery comprised by the Installed Lock device does not contain sufficient power, the user rotates or presses the door handle (mechanically connected to the Installed Lock device's power generator) to generate power, then the step (b) above takes place.

2.6. Stationary Data Storage device

A Stationary Data Storage device is a secure data storage unit for hundreds or thousands or more Code Arrays and other confidential data, equipped with electronic components performing data processing, data input/output, data protection and possibly other functions. A Stationary Data Storage device is typically owned and/or controlled by a private or government organization. It's usually used as a fully stationary device but can be installed on a vehicle, ship, plane etc.

The Stationary Data Storage device has connection slot(s) for Key Data Storage unit(s) (and possibly also for Lock Data Storage unit(s)) so it can generate a Code Array and write its two or more copies into own memory and the memory of one or more connected devices (Key Data Storage units and/or Lock Data Storage units).

The Stationary Data Storage device may comprise data protection components similar to those of a Key Data Storage unit, but on a larger scale—i.e. designed to protect data contained in many memory chips, not a single one. To support this functionality, the Stationary Data Storage device comprises an internal rechargeable power source (battery), a processor, a clock circuit etc.

For communication with external devices via networks, the device may comprise network connectivity components.

### Usage/Interaction Mode K:

Stationary Data Storage devicê- -Key Data Storage unit[s]

The Stationary Data Storage device works as a Master device writing a Code Array into its own memory and into memory of one or more Slave devices (Key Data Storage unit(s))—for a Public Contract generation (typically between an organization and an individual or a group of individuals). This is a Primary (Face-to-face) Contract that does not use data exchange via networks (like a Secondary Contract does) and therefore provides maximum possible data security.

### Usage/Interaction Mode L:

Stationary Data Storage device*- -Stationary Data Storage device

Stationary Data Storage device works as a Master device for Public Contract generation between two organizations (for example, a Trust Center and a bank).

### Usage/Interaction Mode M:

Stationary Data Storage device- -<network>|-Communication device- -Key Data Storage unit, |-Wearable Data Management device

This is a very common scenario of a person
obtaining online authorization, validation, account access etc.;
performing secure data exchange session for online banking, shopping, etc.; or
being granted access to corporate premises, facilities, networks, servers, databases etc.

To generate a Secondary Contract, it's preferable to have at least two Primary Contracts generated as prerequisites. Two Primary Contracts generated between Parties A-B and B-C (under Usage Modes K and L) allow subsequent generation of a Secondary contract between Parties A—C (under Usage Mode M)—with practically the same level of data security as that provided by the Primary Contracts. In this method, the party B plays a role of a “Trust Center” or “Validation Center” or “Authorization Hub” providing the service of remote Party validation and secure delivery data (including Code Vector(s) encrypted using another Code Vector).

The following is an example scenario of this Method of Secondary (Remote) Contract Generation (where the Party A is represented by “John Doe”, the Party B by “Trust Center” and the Party C—by “ABC Bank”).

### Prerequisites:

1. John Doe possesses a Key Data Storage unit and a Wearable Data Management device and optionally a Communication device;
2. ABC Bank possesses a Stationary Data Storage device;
3. Trust Center possesses a Stationary Data Storage device;
4. John Doe has visited the Trust Center and the public Contract C3 was established between the Trust Center and John Doe (i.e. between the John Doe's Key Data Storage unit and the Trust Center's Stationary Data Storage device);
5. ABC Bank has established a public Contract C2 with the Trust Center (i.e. the Contract was generated between the ABC Bank's Stationary Data Storage device and the Trust Center's Stationary Data Storage device);

### Procedure:

Step 1. John Doe communicates with ABC Bank and exchanges information required for (preliminary) opening of the account, including the Device ID of the Key Data Storage unit owned by John Doe. This information may be exchanged via unsecured channel.

Step 2. ABC Bank uses the Stationary Data Storage device it owns to generate new Contract C1 (with John Does Key Data Storage unit).

Step 2.1 ABC Bank's Stationary Data Storage device generates Code Array CA1 (with VTF=new Account's initial validity period—typically 1 year)

Step 2.2 ABC Bank's Stationary Data Storage device encrypts the newly-generated Code Array CA1 with a specifically generated for this purpose Code Vector CV1.

Step 2.3 ABC Bank's Stationary Data Storage device sends the encrypted Code Array CA1 to John Doe via email, ftp or other method which may involve an unsecured channel (Internet).

Step 2.4 ABC Bank's Stationary Data Storage device retrieves the current Code Vector CV2 from the Code Array CA2 belonging to the pre-existing Contract C2 between ABC Bank and the Trust Center.

Step 2.5 ABC Bank's Stationary Data Storage device uses the Code Vector CV2 to encrypt the message which includes the Code Vector CV1.

Step 2.6 ABC Bank's Stationary Data Storage device (via connected network server(s)) sends this encrypted message to the Trust Center.

Step 3.1 Trust Center's Stationary Data Storage device receives this encrypted message and decrypts it using the Code Vector CV2 it retrieves from the Code Array CA2 belonging to the pre-existing Contract C2 between ABC Bank and the Trust Center. After that, the Code Vector CV1 in its raw (unencrypted) form will be available to the Trust Center's Stationary Data Storage device for further processing in the step 3.3 below.

Step 3.2 Trust Center's Stationary Data Storage device retrieves the current Code Vector CV3 from the Code Array CA3 belonging to the pre-existing Contract C3 between John Doe and the Trust Center.

Step 3.3 Trust Center's Stationary Data Storage device composes a new message which includes the Code Vector CV1. This message is then encrypted using the Code Vector CV3.

Step 3.4 Trust Center's Stationary Data Storage device sends the encrypted message composed in 3.3 to John Doe via email, ftp or other method which may involve an unsecured channel (Internet).

Step 4.1 John Doe connects his Wearable Data Management device with hosted Key Data Storage unit (and with optional Communication deviCe connected) to the Internet or other network.

Step 4.2 John Doe's Wearable Data Management device receives/downloads the message from ABC Bank containing the encrypted Code Array CA1 and stores it in its RAM.

Step 4.3 John Doe's Wearable Data Management device receives/downloads the message from ABC Bank containing the encrypted Code Vector CV1 and stores it in its RAM.

Step 4.4 John Doe's Wearable Data Management device disconnects itself from all external devices (except the optional Communication device) and turns off any radio communication module in itself (and in the connected Communication device, if applicable).

Step 4.5 John Doe's Wearable Data Management device retrieves the current Code Vector CV3 from the Code Array CA3 belonging to the pre-existing Contract C3 between John Doe and the Trust Center.

Step 4.6 John Doe's Wearable Data Management device decrypts the message containing the encrypted CV1 Code Vector using the CV3 Code Vector as the decryption key.

Step 4.7 John Doe's Wearable Data Management device decrypts the Code Array CA1 using the (decrypted in previous step) Code Vector CV1 as the decryption key.

Step 4.8 John Doe's Wearable Data Management device writes the decrypted Code Array CA1 into the secure storage memory of the hosted Key Data Storage unit and assigns the new Contract ID (C1) to the Code Array CA1.

Step 4.9 John Doe's Wearable Data Management device irreversibly erases all the data associated with the Code Array CA1 and/or the Code Vectors CV1 and/or CV3 from its RAM. Upon successful completion of this step, it restores its own and the connected Communication device device's communication with external devices, if applicable.

### 3. Connectivity Matrix

The table below contains the Connectivity Matrix explaining possible modes of interaction between possible pairs of devices. Every device mentioned in a row can be either a Master or a Peer device in each applicable pair. Every device mentioned in a column can be either a Master or a Peer device in each applicable pair.

| | Attached device (Slave or Peer) | | | | | | |
|---|---|---|---|---|---|---|---|
| | | | | Wearable | | Lock | Stationary |
| Host device | | Removable | Touchpad | Data | Key Data | Data | Data |
| (Master or | Communication | Earpiece | Keyboard | Management | Storage | Storage | Storage |
| Peer) | device | unit | unit | device | unit | unit | device |
| Communication | | ME; R | ME | | | | |
| device | | | | | | | |
| Wearable Data | ME; R | | | | ME | R; E* | |
| Management | | | | | | | |
| device | | | | | | | |
| Installed Lock | | | | | | ME | |
| device | | | | | | | |
| Stationary | | | | N | ME* | ME* | E*; N |
| Data Storage | | | | | | | |
| device | | | | | | | |

Legend for Table 2
E = Electric connection (via wire/cable)
ME = Electromechanical connection (mechanical attachment with electrical contacts)
R = Wireless (radio) connection
N = connection through a communication channel or network (LAN, Internet etc.)
*connection for Contract generation

4. Cumulative Effect on Benefits from Cooperation Between the Devices

This paragraph explains how the presence and cooperation of all the devices provides maximum (cumulative) effect upon users' benefit and marketability of both the Wearable Complex and the Security Complex.

### 4.1 Key Data Storage Unit+Wearable Data Management Device

A Wearable Data Management device is an ideal host device for a Key Data Storage unit since it provides better protection from theft, loss, copy than other pocket devices used as hosts:
the Key Data Storage unit cannot be removed off user's wrist without triggering auto-locking which blocks access to the confidential data until valid credentials (master PIN, password, etc.) are supplied;
therefore, PIN entry can be done much less frequently than for a pocket device and never in a public place
hence much less chance of PIN or password interception;
incorporation of a confidential data storage module (similar in functionality to that of the Key Data Storage unit) within a Communication device or any existing smartphone device would be disadvantageous due to high theft/loss probability, frequent software changes (as opposed to firmware-like instruction set that controls handling of confidential data in the Wearable Data Management device), potential instability of its common open-type OS, etc.
   4.2 Wearable Data Management device (+Key Data Storage unit)+Communication device

A Wearable Data Management device makes the hosted Communication device a wrist-worn device and thus allows increased convenience, efficiency in many applications, enhanced functionality etc.

Alternatively, a Communication device can be used in Handheld or Desktop State but with less convenience and functional versatility (no gesture control of applications etc.).

If the Communication device is either attached or wirelessly connected to the Wearable Data Management device:

a) The former provides large screen for convenient operation for the Wearable Data Management device—and the Key Data Storage unit-related applications;
Alternatively, a Wearable Data Management device+Key Data Storage unit bundle can perform most authorization, validation, key authentication etc. tasks but with much less efficiency because of a small screen (not touch-sensitive), less powerful processor not running open-type OS etc.;
b) The Communication device enables the Secure Terminal mode (see the Usage/Interaction Mode G above);
c) The Wearable Data Management device allows storage of Code Arrays and other confidential data in a device physically and logically separated from the Communication device running a common open-type OS which is inevitably prone to virus, malware, etc. attacks;
4.3 Communication Device with Removable Earpiece Unit+Wearable Data Management Device

A Removable Earpiece unit is especially effective when the host Communication device is worn on a wrist (i.e. attached to a Wearable Data Management device) since the user can answer a call or place it promptly and comfortably—without the need to search for a wireless earpiece hidden in a pocket, bag or other location, nor to charge/to store the earpiece separately from the phone.

4.4 Communication Device with Touchpad Keyboard Unit

A standalone version of the Touchpad Keyboard unit can work with other devices (laptops or desktop PCs, tablets etc.) but it is especially effective in its version bundled with a Communication device since the latter can be used in both Handheld and Desktop State and in both modes benefit from a convenient keyboard for fast typing, gaming etc.

4.5 Communication Device with Removable Earpiece Unit and Touchpad Keyboard Unit

A Removable Earpiece unit serves as a wireless mouse and together with a Touchpad Keyboard unit provides capabilities for a Communication device to be used as a mobile desktop device connected to a larger (than its own) external display. Due to the blind-typing principle of operation of the Touchpad Keyboard unit, the small size of the keyboard is not very critical for user's convenient desktop-mode text entry as long as the external display is large enough.

### 4.6 Communication Device+Security Complex (Key Data Storage Unit, Lock Data Storage Unit, Installed Lock Device, Stationary Data Storage Device).

Security Complex makes many existing functions performed by a Communication device (online logon, online banking etc.) much less vulnerable to hackers' attacks;
Security Complex allows a Communication device to be a user interface device for many new functions (door unlocking, car entry/start, payment/shopping/e-wallet applications etc.);
Security Complex increases the suitability of a Communication device for specific professional applications with high data security requirements, including those of corporate/executive, government, law enforcement, medical, military, intelligence etc. users;
The Communication device provides computational power, mobile broadband data exchange and advanced user interface capabilities to operations of the Security Complex.

### 5. Examples of Other Possible Versions of the Devices

5.1 A bracelet-like accessory may be created for the Communication device to allow it to be worn on a wrist without a Wearable Data Management device. Such accessory would comprise an attachment mechanism for the Communication device similar to that of a Wearable Data Management device but no electronic components;
5.2 A Key Data Storage unit may be implemented as a Removable Module attached to a Communication device. This combination does not use a Wearable Data Management device so associated benefits of data security etc. (see paragraphs 4.1 and 4.2 above).

5.3 A simplified Version of the Communication device may be created comprising an integrated (non-removable) earpiece similar to those of the existing mobile phones/smartphones instead of the Removable Earpiece.

5.4 A Wearable Data Management device (with a hosted Key Data Storage unit) may be configured to connect wirelessly to an existing smartphone instead of a Communication device. This variant has the following drawbacks:
wireless communication is less secure than wired;
two hands operation will be required or operation with a small display only (the Auxiliary display of the Wearable Data Management device;
no Secure Terminal mode (see Usage/Interaction Mode G above).

5.5 A standalone Version of the Touchpad Keyboard unit may be created to connect wirelessly or via wired connection to existing laptop PCs, tablet computers and/or other similar devices. As a variant, a device similar to the Touchpad Keyboard unit may be implemented as a removable or permanent component of existing or new devices (for example, a tablet computer may be designed with a larger Version of the Touchpad Keyboard unit attached permanently to its back side).

5.6 A standalone Version of the Removable Earpiece unit may be created to connect wirelessly to existing laptop PCs, tablet computers and/or other similar devices and to perform functions of a wireless earpiece and/or wireless mouse. As a rule, such Version will require a separate charger accessory.

6. Detailed description of the Drawings

NOTE: all the Versions of both the Communication device and the Wearable Data Management device shown on the drawings mentioned below are those designed for left arm wear. The same Versions may also be used while worn on a right arm but probably with less comfort.

Comment to FIG. 1: In order to be worn on a wrist, the Communication device (#1) takes the Bent state (shape) and reversibly attaches to the Wearable Data Management device (#2) that is directly worn on the wrist like an ordinary watch bracelet, as shown on FIG. 1. The flexible Display Assembly (#1.3.1) of the Communication device (#1) is shown in its Lowered state: it has taken its curved shape and aligned itself against other parts of the device, thus minimizing possible interaction with clothing or other external objects. The bundle formed by the two devices can thus be worn on a wrist with approximately the same level of comfort as that of a large watch. The main (flexible) display may show essential information such as current time, weather, incoming or missed calls, unread messages or other alerts. The device processor may use data supplied by sensors belonging to either one of the bundled devices to determine the proper mode of visual and audible information output. Firstly, it may turn off the main (flexible) display to save power until the user performs a specific gesture with the arm to look at the display of the Communication device. Such gesture (or Look-at-the-display position) may be detected by gyro sensors and/or other sensors sensing the medium section of the flexible display being put into a near-horizontal position continuously for a period of approximately 1 second. At all other times, the optional display (#2.2.3) of the Control Unit (#2.2) of the Wearable Data Management device (#2) may be used instead to display the essential information since this display will most likely be implemented using low power-consuming LCD technology. Compared to a conventional watch, this secondary display has an advantage of being located closer to the user's line of sight in most situations (as shown on FIG. 1) and therefore a glance at it would likely require less movement of the arm or wrist. Secondly, the displayed image may be adjusted for the curved shape of the Display assembly being in its Lowered position, to minimize distortion. Thirdly, audible alerts may be turned off and replaced by vibration alerts automatically whenever the bundle is on a wrist, thus eliminating the need to manually set the device to “silent mode” at a meeting, in a theater, etc.

The FIG. 1 also shows the two audio jacks—one (#1.3.4) located on the Communication device (#1) and another (#2.2.6) located on the Control Unit (#2.2) of the Wearable Data Management device. The positioning of the jacks may vary. Either one can be used to connect a wired headset accessory (not shown) while the bundle of two devices is worn on a wrist. Using the first one provides an advantage of the headset accessory retaining wired connection with the Communication device (#1) while the latter is detached from the Wearable Data Management device and removed from the wrist for pocket, handheld etc. use. Using the second jack gives an advantage of the Communication device (#1) being removed from the wrist without any constraints from a connected wire while the Wearable Data Management device may automatically establish a wireless connection with the de-coupled Communication device (#1) to transmit audio signals to and from the wired headset accessory. In both cases, the headset wire may be reversibly attached to a sleeve or other clothing part by means of one or more of the Attachment Devices (not shown) using micro-hooks similar in shape to those of a plant's burr.

Comment to FIG. 2: FIG. 2 gives an alternative view to the same two devices in the same state as on FIG. 1. This view allows to see the five Modules (##1.3, 1.4, 1.5, 1.6, 1.7) that the modular Communication device (#1), Version “Sandwich” comprises in its example shown. The flexible display assembly (#1.3.1) in its Lowered state covers all the Modules except the Module closest to the Top side of the Communication device (#1) called the Top Module (#1.7), as shown on the FIG. 2. This allows placing some components like sensors or solar power panel to the Front side of this Module's housing. The Right side of the housing of one of the Modules may contain the Palm proximity/movement Sensor (#1.6.3) which detects certain palm movements for controlling certain applications. Also the Control Unit (#2.2) of the Wearable Data Management device is shown connected to the Bottom Module (#1.3) of the Communication device (#1). In this position, the cylinder-shaped Body containing the main Camera (both not shown) can be turned in one of the many wrist-outward directions to perform photo or video shooting, or alternatively it can be turned in a wrist-facing direction to hide the lens from view in an environment or situation where shooting is not allowed.

Comment to FIG. 3: FIG. 3 provides same view to the same two devices as on FIG. 1, but with the flexible Display Assembly (#1.3.1) in the Raised position. This position allows better view of the displayed images and data to the user, with larger field-of-view and smaller distortion than in the Lowered position. It's especially useful for email checking, photo/video capture, video calls, map navigation etc. performed on-the-run. Command and data input may be performed either via the touch-sensitive surface of the display (preferably at its bottom part, near the connection of the Display Assembly (#1.3.1) to the Bottom Module (#1.3), where the Display Assembly does not significantly bend or wave), or via the physical keys or buttons located on the two devices, or via specific arm/wrist movements shown on FIG. 4. Some sensors may be located at the Top side of the flexible Display Assembly (#1.3.1). The optional Front-facing camera (#1.3.1.6) may facilitate video chat in this position. The optional Light sensor (#1.3.1.7) may measure ambient light at the display's Front surface for automatic brightness adjustment. In this position, the cylinder-shaped Body containing the main Camera (both not shown) can also be turned in one of the many wrist-outward directions to perform photo or video shooting (with the raised Display providing especially good viewfinder capabilities), or alternatively it can be turned in a wrist-facing direction to hide the lens from view in an environment or situation where shooting is not allowed.

Comment to FIG. 4: The arm movements shown on FIG. 4 with arrows allow the user to control certain applications running on the Communication device worn on the wrist without the use of either hand's fingers. By performing either rotational or linear abrupt motions (jerks), as shown with arrows on the FIG. 4, the user may submit commands to control audio playback start/stop/next track/previous track, map navigation panning in four directions/zooming in and out, web page scrolling etc. To avoid unwanted commands, this control method may be activated only if the Look-at-the-display position has been detected and/or the flexible Display assembly is in the Raised positions.

Comment to FIG. 5: In its Flat state, the Communication device is very similar in its mechanical properties, shape and handling to existing smartphones. Its body rigidity is assured by secure reversible attachment of the Top side of the Display assembly (#1.3.1) to the first Attachment point (not shown, hidden beneath the Display assembly). The flexible Display assembly (#1.3.1) covers all the Modules except the Camera assembly (#1.7.4) which may be an integral part or a semi-permanent attachment to the Top Module (#1.7), and the Removable Earpiece unit (#1.8). Thus, sensors, controls and other appropriate components of these two units remain user-accessible. Some sensors may be located at the Top side of the flexible Display Assembly (#1.3.1) facing the viewer on the FIG. 5. The optional Light sensor (#1.3.1.7) may measure ambient light at the display's Front surface for automatic brightness adjustment. The optional Front-facing camera (#1.3.1.6) may facilitate taking self-portrait photo or conducting a video chat in this position. However, the cylinder-shaped Body (#1.7.4.1) containing the main Camera (#1.7.4.2) can be turned Front side-facing for the same purpose; or it can be turned in the opposite direction (Back-side facing) for the device to be used as a handheld or tripod-mounted etc. photo/video camera. The Removable Earpiece unit (#1.8) serves as an integrated earpiece of a conventional smartphone, but it can be detached and placed in the ear for hands-free conversation, and subsequently re-attached, for example to be charged together with the Communication device. For these two utilization modes, two separate parts of the Removable Earpiece unit (#1.8) may be used: the Earphone grid (#1.8.1.2) for a handheld operation and the Earhorn (#1.8.1.1, not shown) for in-ear/hands-free operation. The microphone(s) used to capture voice may also differ in both cases. The Proximity sensor (#1.8.10) may be used in the Flat state to perform similar functions as in common smartphones, but in the Bent state when the Communication device is worn on a wrist, this sensor, together with accelerometer and/or gyro sensor(s), may be used to start automatic call answering or call placement, as shown on the FIG. 12.

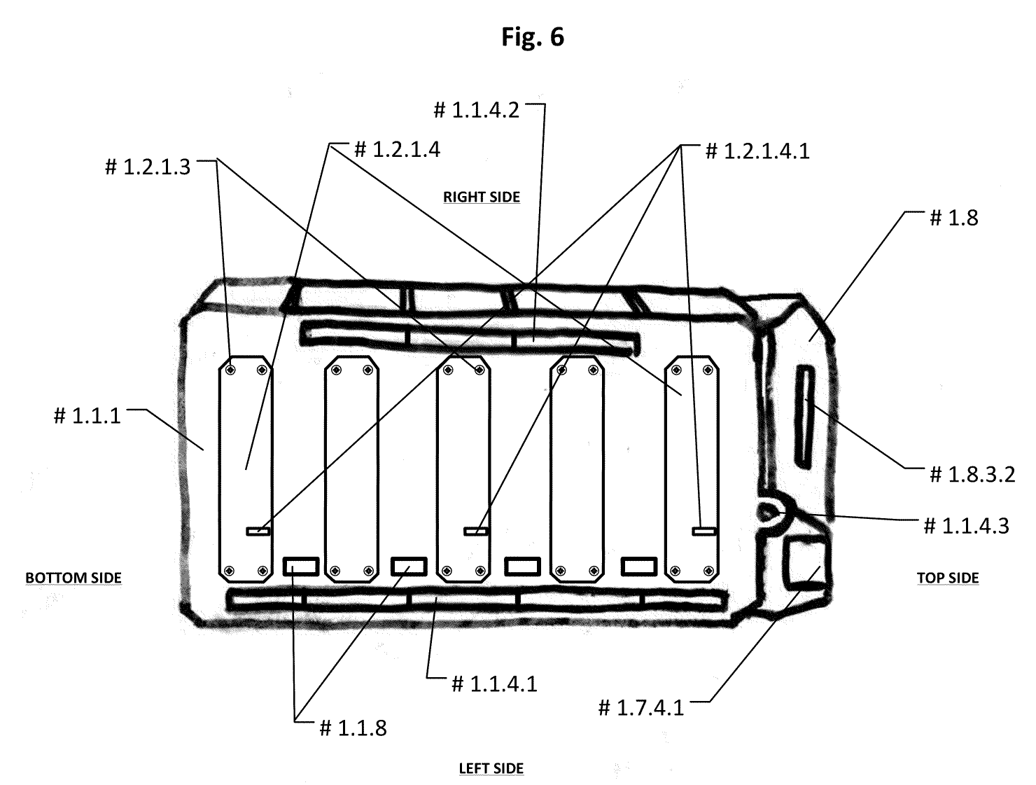

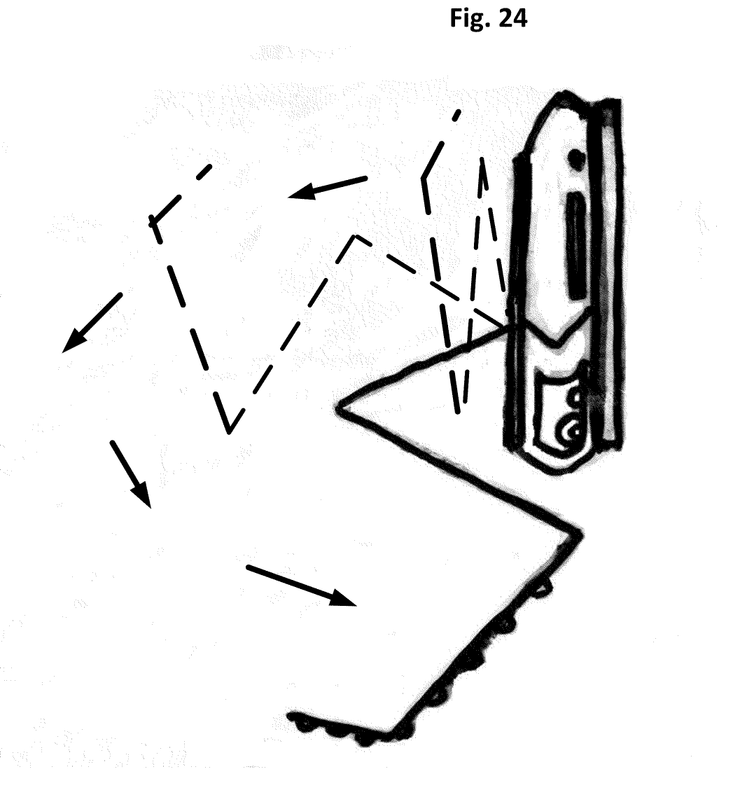

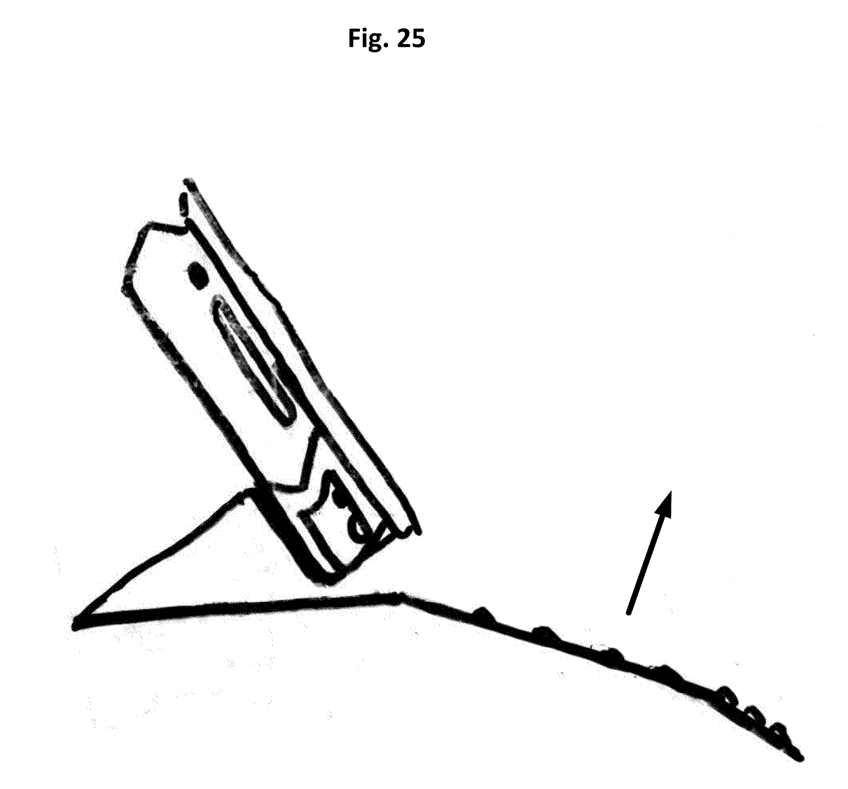

Comment to FIG. 6: The Back side of the Communication device (#1) shown on FIG. 6 is used primarily for reversible attachment of the Touchpad Keyboard unit (not shown) to the Communication device or the Communication device itself to the Wearable Data Management device (not shown). For the first purpose, there are several Attachment points (#1.2.1.4.1), each located at the back side of a Backplate (#1.2.1.4) plus several Fixing points (#1.1.8) located at the back side of the Main Layer (#1.1.1) of the flexible Base (#1.1) in the spaces between the Backplates (#1.2.1.4). Attachment points (#1.2.1.4.1) are used for reversible attachment of the Touchpad Keyboard unit's Connection bands (not shown) that may provide both mechanical and electrical connection (i.e. the bands themselves may conduct electric power and signals). See also FIG. 25 for an example of the Connecting band attachment. The Fixing points (#1.1.8) reversibly attach using magnetic or other effect to their counterparts also called Fixing points (not shown) located on the back side of the folded Touchpad Keyboard unit (not shown) thus allowing the unit to be held in folded position and not being unfolded accidentally (see also FIG. 24). In the described device variant, three Attachment points (#1.2.1.4.1) shown on the FIG. 6 will connect to three Connection bands (not shown); and four Fixing points (#1.1.8) will reversibly attach to their four counterparts (not shown). The above mentioned Backplates (#1.2.1.4) exist one per each Module (five in the described variant of the Communication device) and are primarily used to hold the flexible Base (#1.1) tightly pressed against the housings of the Modules (##1.3-1.7) at all times to provide water impermeable connection of each Module to the Base. Each Backplate (#1.2.1.4) is attached to respective Module's housing via the set of Screws (#1.2.1.3). The details of this semi-permanent attachment can be seen in the cross-section depicted on FIG. 8.

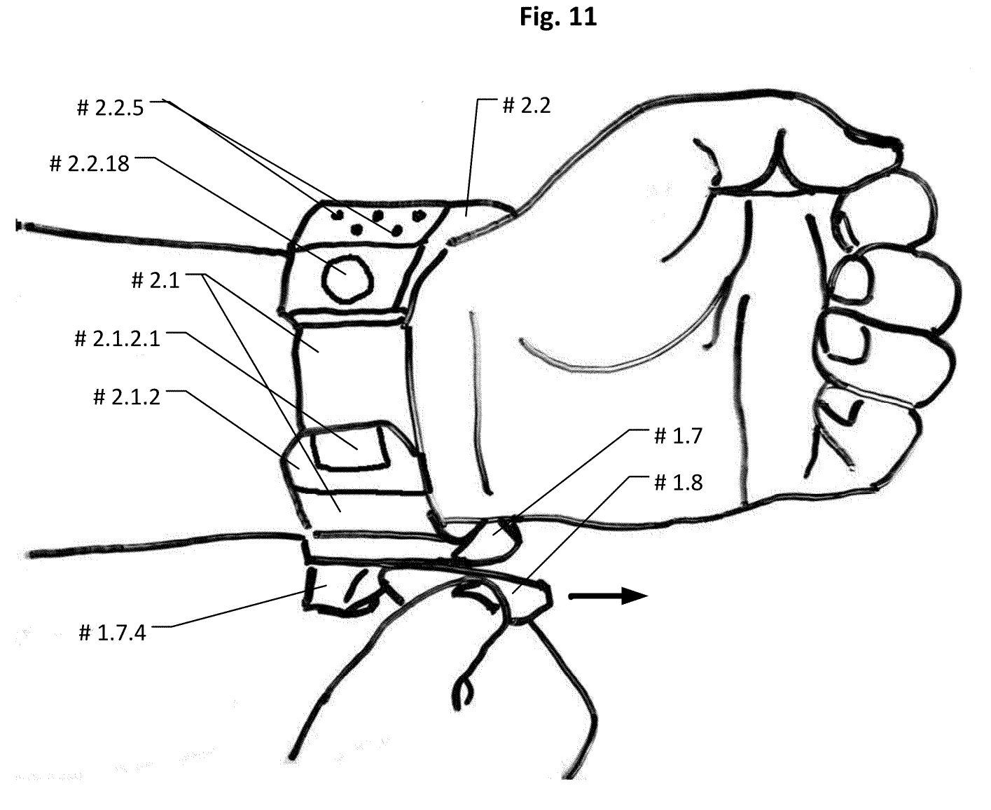

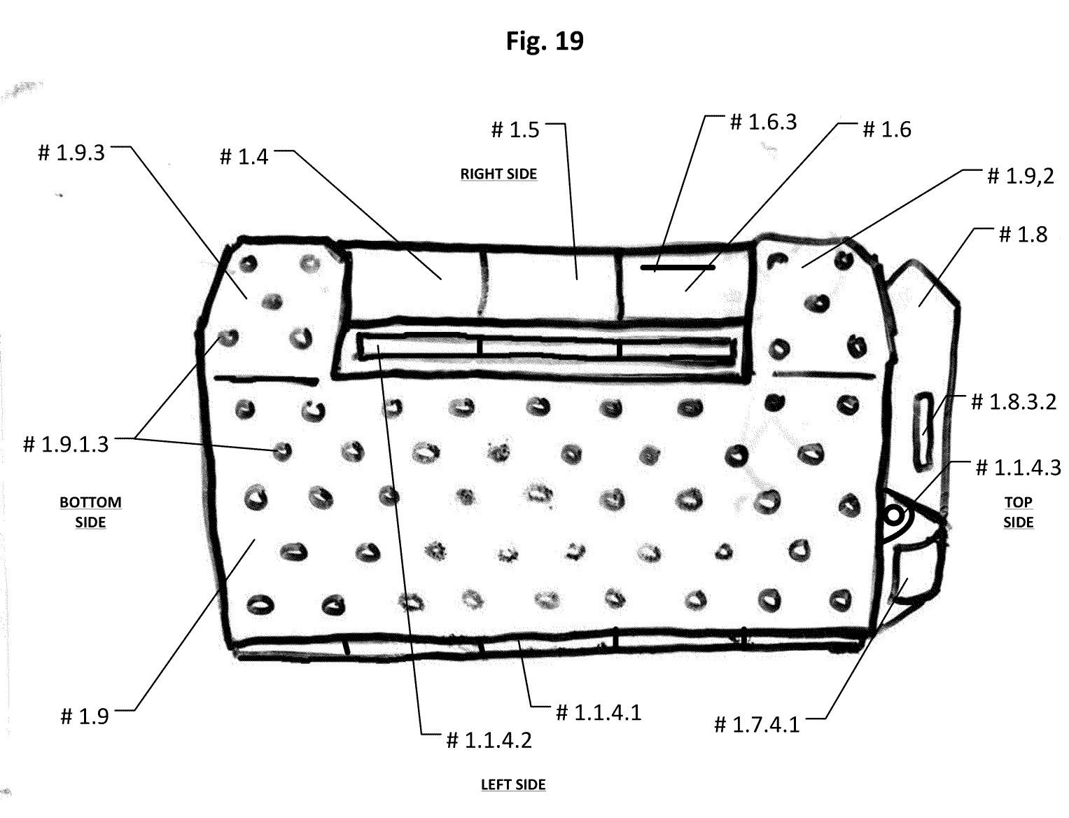

For reversible attachment of the Communication device (#1) itself to the Wearable Data Management device (not shown), the two Attachment Strips are used—the Left-side (#1.1.4.1) and the Right-side (#1.1.4.2) one. They are located at the two respective edges of the flexible Base (#1.1) as shown on FIG. 6. Both Strips use magnetic or other attachment principle and feature segmented structure (i.e. one segment per each Module, but the Right-side Strip may be 2 segments shorter than the Left-side one to allow the two Flaps of the removable Touchpad Keyboard unit (not shown) to be placed over the Right-side edge of the flexible Base (#1.1), as shown on FIG. 19). In addition, attachment of the Communication device (#1) to the Wearable Data Management device is facilitated by the Top-side button-type fastener (#1.1.4.3) located at the Top-side edge of the flexible Base (#1.1). The Back side of the Removable Earpiece unit (#1.8) comprises the Slider mechanism with latch button (#1.8.3.2) used for quick and easy removal of the unit, for example when the Communication device is worn on a wrist—as shown on FIG. 11—but also when the device takes other states/positions such as Handheld, Desktop etc.”

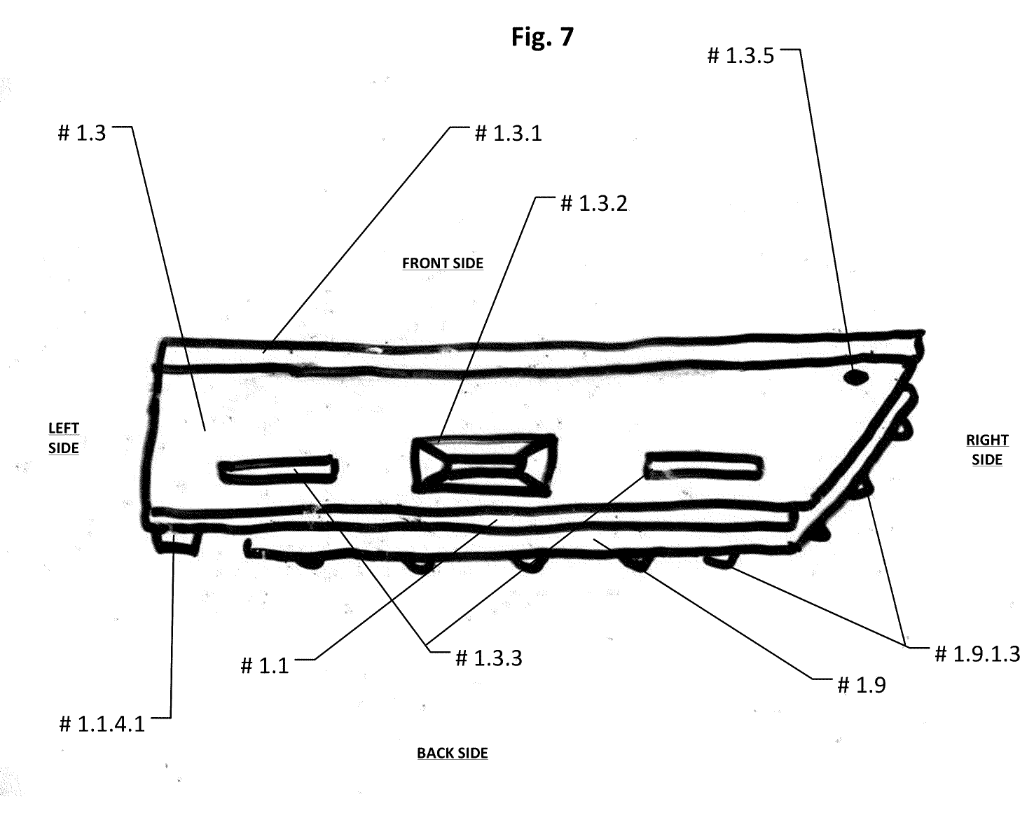

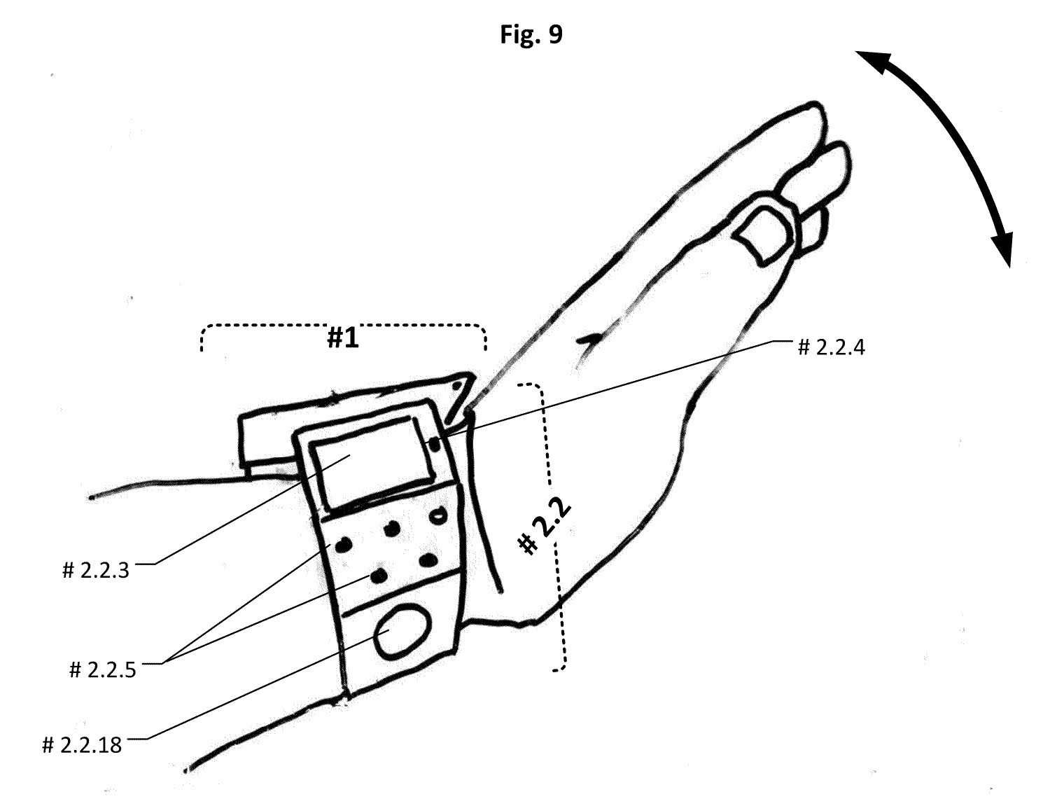

Comment to FIG. 7: When the Communication device (#1) is seen from its Bottom side, the housing of the Bottom Module (#1.3) is visible together with Bottom edges of the flexible Base (#1.1) and the flexible Display assembly (#1.3.1). If the removable Touchpad Keyboard unit (#1.9) is attached to the device as on the FIG. 7, its Bottom edge and some of its Relief points (#1.9.1.3) will be seen also. The Bottom Module (#1.3) housing, as well as housing of other Modules, may have prismatic shape with a trapezoid cross-section as shown on the FIG. 7. Such shape allows combining a wider Display assembly (#1.3.1) and therefore wider Display itself at the Front side of the device with narrower flexible Base (#1.1) minimizing interaction with the wrist at the Back side of the device. Also, such shape allows free unobstructed movement of user's palm as shown on FIG. 9. The Bottom side of the Bottom Module (#1.3) housing shown on FIG. 7 comprises components used for reversible connection of the device to the Control Unit of the Wearable Data Management device (not shown). These are the Bottom multifunctional female connector (#1.3.2) providing electrical connection together with some mechanical fixing, and the set of Protrusions and/or Depressions (#1.3.3) providing mechanical restraining when the two devices are coupled. The Bottom multifunctional female connector (#1.3.2) is shown with surrounding niche or depression in the Module housing that may be implemented to facilitate self-positioning of the female connector (#1.3.2) against its male counterpart (not shown) when connection is made as shown on FIG. 16.

Comment to FIG. 8: FIG. 8 shows a cross-section view of a single (sample, generic) Module attached to the flexible Base (#1.1) via the partially-shown Module Housing (#1.2.2). Two most important layers of the flexible Base (#1.1) are shown: the Main layer (#1.1.1) responsible for mechanical integrity of the whole device and the Water impermeable layer (#1.1.2) that isolates the connection area from liquids, moisture, dust etc. Pins (#1.2.1.1.1) and Gasket (#1.2.1.2) protrude from the Back side of the Module housing. Each Pin may be equipped with a separate spring to make contact between the Pin and an Embedded wire more reliable (see below). The Gasket may be implemented as an integral protruding part of the Module Housing and not a separate component. The Gasket has a shape of a closed contour encircling the entire Pin group to protect its connection area from liquids, moisture, dust etc. coming from any direction. When the Module is being attached to the flexible Base (#1.3.1), first it's placed in a specific location at the Front side of the flexible Base in such a way that the screw holes on the Back side of the Module housing are placed against corresponding Connection points (#1.1.1.1.4), then a Backplate (#1.2.1.4) is placed at the opposite (Back) side of the flexible Base and aligned so its holes match the Connection points too, and finally the Screws (#1.2.1.3) are put through the Backplate holes, through the Connection points (which may be implemented as holes) on the flexible Base and into the mounting (threaded) holes in the Module housing—as shown on FIG. 8. As the Screws are being subsequently tightened to finish the attachment procedure, the Pins (#1.2.1.1.1) and the Gasket (#1.2.1.2) pierce through the Water impermeable layer (#1.1.2) until the spring-loaded Pins come into secure contact with Embedded wires (#1.1.1.1) located either within the Main layer (#1.1.1) or at the border between the Main layer and the Water impermeable layer (#1.1.2). Note: on FIG. 8, not all the Pins and not all the Embedded wires are shown. Some Embedded wires designed to conduct higher current then others may be wider than the latter ones and connect to more than one Pin per Embedded wire, as in the example shown on FIG. 8.

When the Screws (#1.2.1.3) are tightened, the Backplate (#1.2.1.4) shown at the bottom of the drawing on FIG. 8 distributes pressure exerted by the Screws throughout the whole area surrounding the Gasket (#1.2.1.2) and thus allows the connection to retain its water impermeable properties even if the flexible Base (#1.1) is bent.

Comment to FIG. 9: With the bundle of the two devices (Communication device (#1) and Wearable Data Management device (#2)) worn on a wrist, user can perform normal palm movements of the same hand freely, thanks to the trapezoid shape of the cross section of a prismatic housing of each Module (as shown on FIG. 9). Certain palm motions as those shown on FIG. 9 with arrows may be detected by the Palm proximity/motion sensor(s) (#1.6.3) shown on FIG. 2.

Comment to FIG. 10: When the device's body is being bent, the flexible Display assembly (#1.3.1) detaches from the first set of Attachment points (#1.7.8) located at the Front side of the housing of the Top Module (#1.7) and takes the Raised position shown on FIG. 3. When device body bending is complete, the flexible Display assembly (#1.3.1) can be also bent (i.e. it takes its Lowered position) and subsequently attached to the second set of Attachment points (#1.6.2) that may be located at the front side of the housing of the second Module from the Top called the Radio Module (#1.6) or of other Module. This final state with the flexible Display assembly in its Lowered position is shown on FIG. 10. The process of bending the device body and the Display assembly is shown in three stages on FIGS. 16-18.

Comment to FIG. 11: When the bundle of the two devices (Communication device (#1) and Wearable Data Management device (#2)) is worn on a wrist, the flexible body of the Communication device is bent in a manner that allows the Top side of the device with attached Removable earpiece unit (#1.8) to appear at the side of the wrist closest to the small finger. This is a convenient location for the Removable earpiece unit (#1.8) to be taken and detached by fingers of the other hand, as shown on FIG. 11 with an arrow. To detach the Removable earpiece unit (#1.8), the user may press the Latch button (#1.8.3.2) of the Slider mechanism located at the Bottom side of the Removable earpiece unit and then slide the unit in the direction of the arrow. Vice versa, after completing the conversation the user may re-attach the unit via sliding motion in the direction opposite to the arrow shown and via subsequent self-locking of the Latch. This method provides secure storage of the Removable earpiece unit, allows convenient charging together with the host device and minimizes the risk of the unit being lost or stolen.

Comment to FIG. 12: “Fingerless” call answer/call placement operation may be performed with the help of the gyro and/or accelerometer and/or ear proximity sensors which detect the moment the user raises an arm wearing the bundle of the two devices and brings the attached Removable earpiece unit to close proximity of an ear, as shown on FIG. 12. Thus, such detected gesture may be considered a signal to place a voice-controlled call, to answer an active call, or to perform another pre-programmed action.

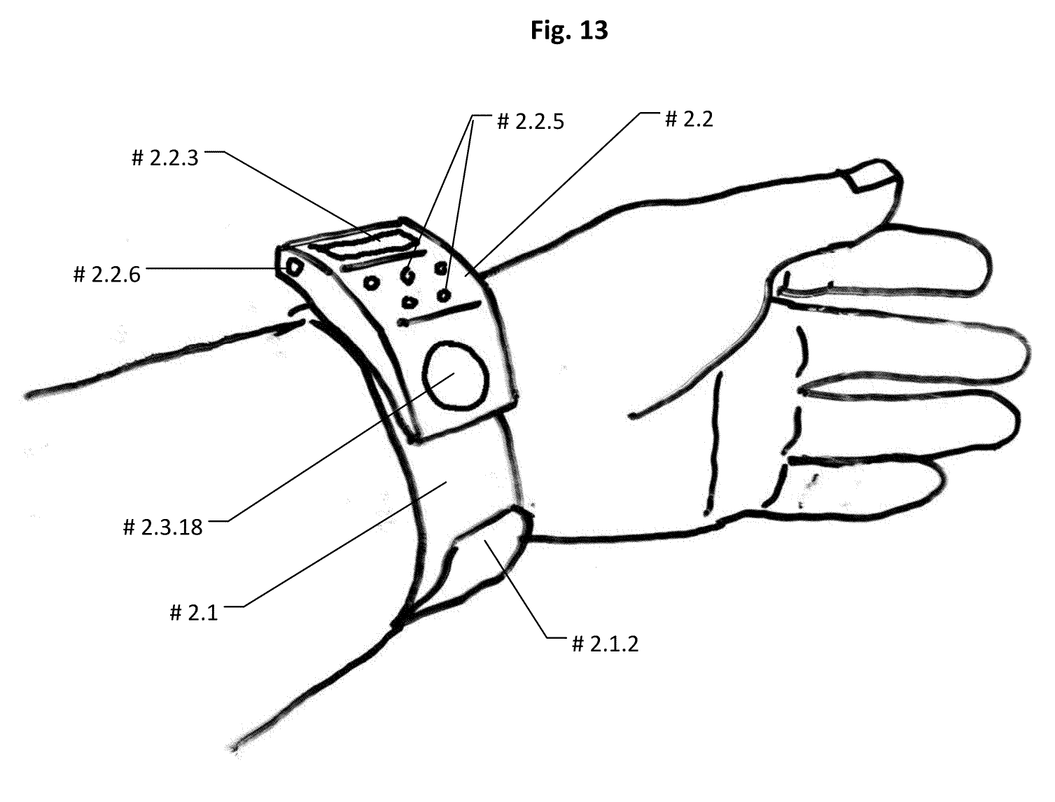

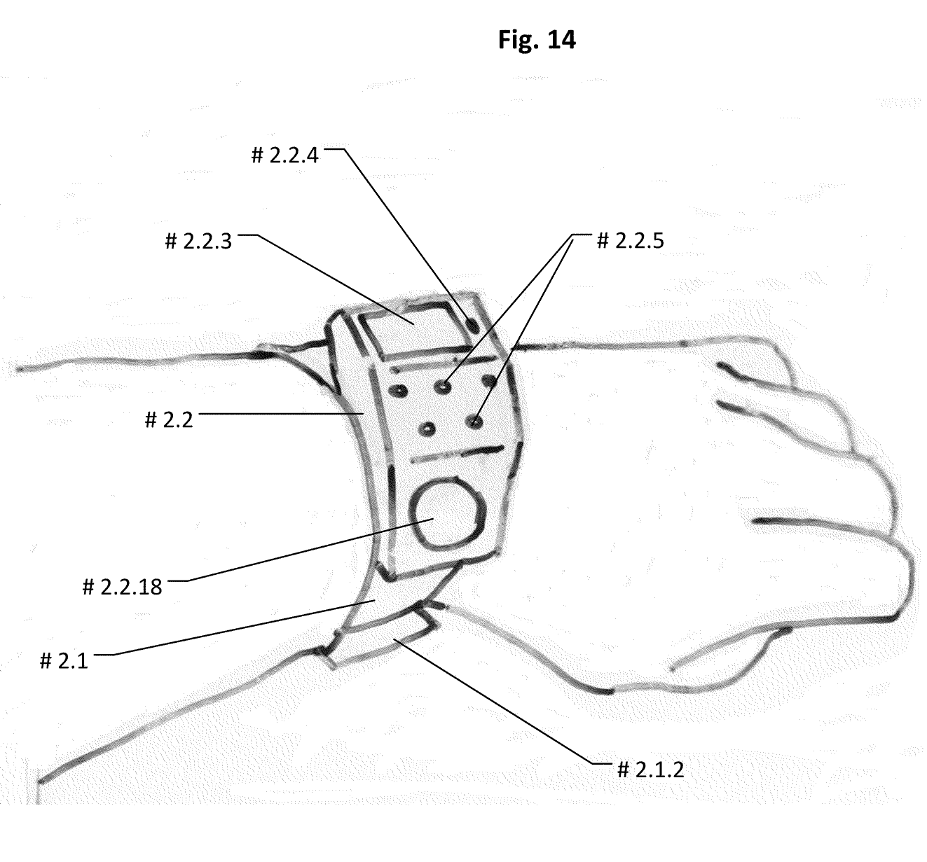

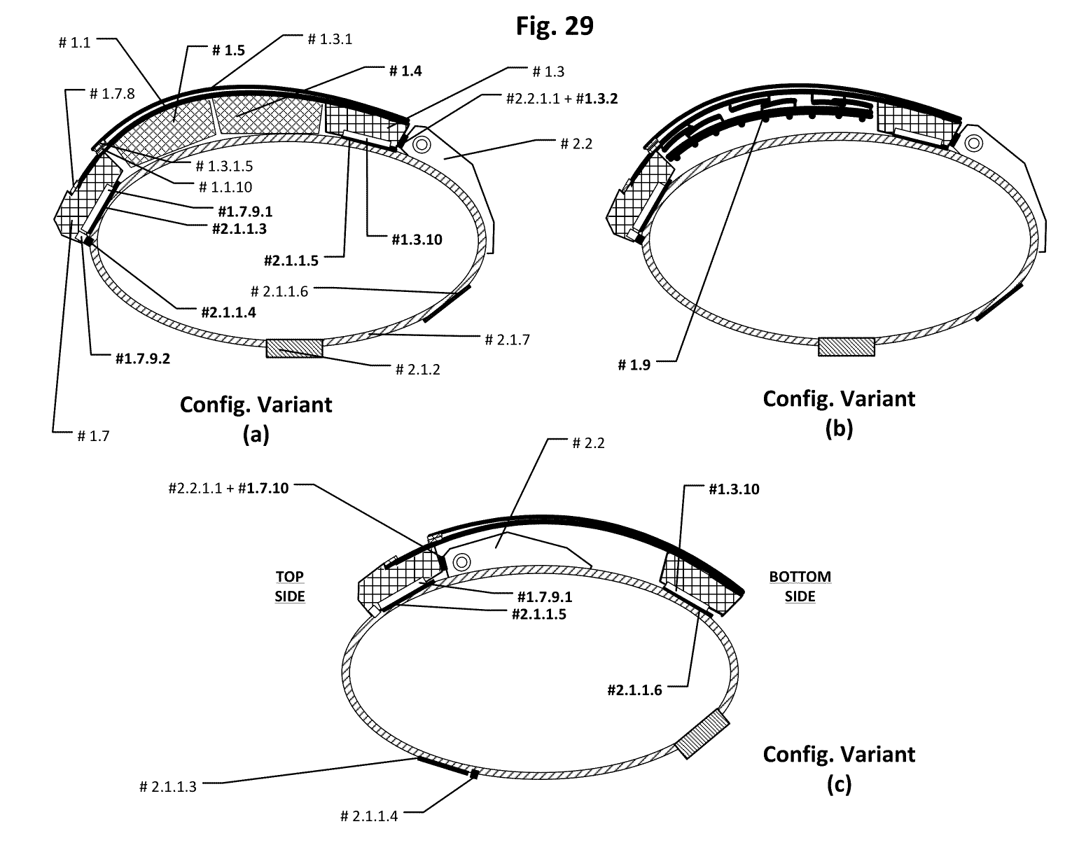

Comment to FIG. 13: The Wearable Data Management device (#2) may be worn and used alone to perform limited number of functions (or a wider set of functions if it establishes a wireless connection with a Communication device located nearby (not shown). The Wearable Data Management device (#2) may be worn in two positions on a wrist: “Bottom” (shown on the FIG. 13) and “Top” (shown on the FIG. 14). The first position is suitable for quick attachment and detachment of the Communication device (Version “Croissant”, Configuration Variants A, B or Version “Sandwich”—see FIG. 29(A,B) and FIG. 1 respectively for details).

Comment to FIG. 14: In the “Bottom” position, the Wearable Data Management device (#2) is worn in the same manner as an ordinary watch. In this position, quick attachment/detachment of the Communication device (Version “Croissant”, Configuration Variant “C”) is possible—see FIG. 29 (C) for details.

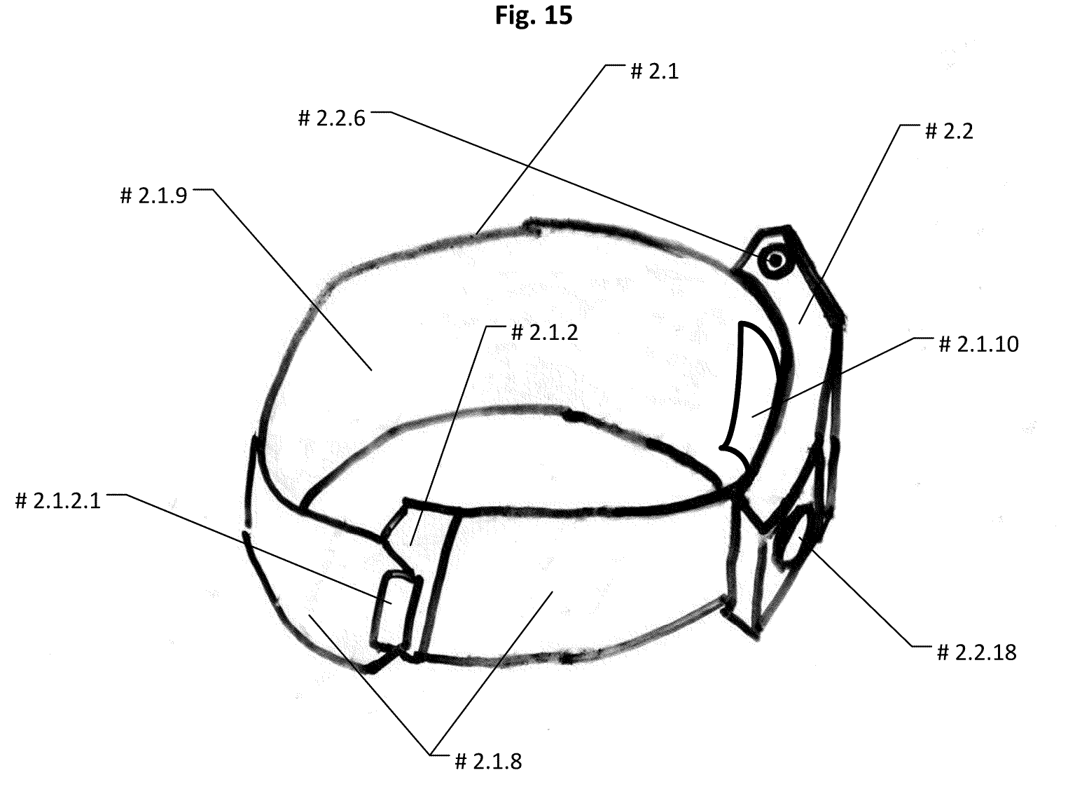

Comment to FIG. 15: The control Unit (#2.2) housing is rigid and has its inner side curved but some additional soft padding may be comprised in the Band (#2.1) for better accomodation to anatomic shape of the wrist. The Access window (#2.1.10) opens on the inner surface of the Band to prevent access to the contained Key Data Storage unit while the Wearable Data Management device (#2) is worn on a wrist.

Comment to FIG. 16: At the first stage of connection of the Communication device (#1) to the Wearable Data Management device (#2), the Bottom multifunctional female connector and the set of Protrusions and/or Depressions provide mechanical restraining of the Communication device so it cannot move outward from the Band of the Wearable Data Management device (i.e. from the wrist surface).

Comment to FIG. 17: At the second stage of connection of the Communication device (#1) to the Wearable Data Management device (#2), the former is bent by applying pressure at its Top side (as shown on the FIG. 17 with the arrow) while its Back side is becoming attached to the Band via Attachment Stripes (not shown). In the process, the flexible Display assembly (#1.3.1) detaches from the first set of Attachment points (#1.7.8) located at the Front side of the housing of the Top Module (#1.7) and takes the Raised position, as shown on FIG. 17 and also on FIG. 3.

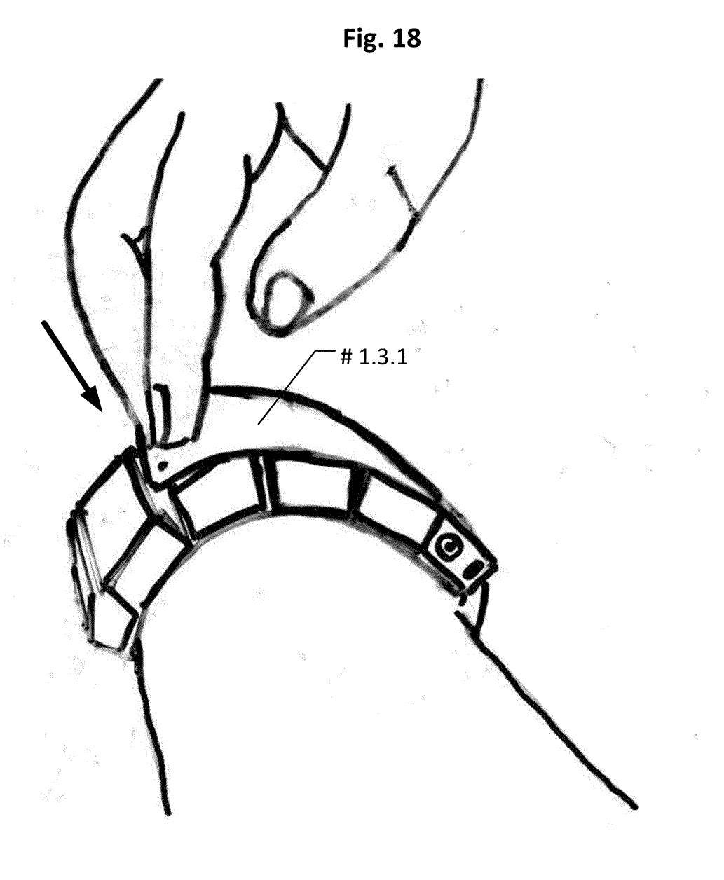

Comment to FIG. 18: At the third stage of connection of the Communication device (#1) to the Wearable Data Management device (#2), the flexible Display assembly (#1.3.1) is bent by applying pressure at its Top side (as shown on the FIG. 18 with the arrow) and attached to the second set of Attachment points (#1.6.2) located at the front side of the housing of the second Module from the Top called the Radio Module (#1.6). Thus, the flexible Display assembly (#1.3.1) takes its Lowered position shown also on FIG. 1 and FIG. 2.

Comment to FIG. 19: When the Communication device (#1) is in its Flat shape and the Touchpad Keyboard unit (#1.9) is attached, the latter covers the whole Back side of the former, except the two Attachment strips—the Left (#1.1.4.1) and the Right (#1.1.4.2), the Top-side Button fastener (#1.1.4.3), the Back side of the Camera assembly (#1.7.4) and the Wireless Earpiece unit (#1.8). The two Flaps comprised by the Touchpad Keyboard unit (#1.9)—the Left-hand (#1.9.2) and the right-hand (#1.9.3) are bent over the Right-side edge of the flexible Base and cover the Right sides of the two Modules, as well as a portion of the Right Attachment strip (#1.1.4.2), as shown on FIG. 19. The attachment method of choice for the Attachment strips (for example, the magnetic one) may provide some attachment effect even if a relatively thin object (like the Flap) is inserted between the counterparts forming the attachment pair. Alternatively, the Right Attachment strip (#1.1.4.2) may be made shorter than the Left one, as shown on FIG. 6, in order to pass through the Flaps more easily when the Communication device (#1) together with the Touchpad Keyboard unit (#1.9) is attached to the Wearable Data Management device (not shown) or to a cradle-type accessory. The two Flaps in this position may serve as convenient keypads controlled by two index fingers (as shown on FIG. 21) while the Communication device (#1) is being used as a handheld device—a feature useful for gaming, typing etc. Also, the Flaps bent over the edges of the two Module housings and affixed there to the surfaces of the housings may serve as protective caps for the two grids of the stereo speakers (not shown).

Comment to FIG. 20: When the Communication device (#1) is used as a handheld device, it takes its Flat shape and the attached Touchpad Keyboard unit (#1.9) allows for fast and convenient text entry or application controlling using a combination of physical keys and virtual controls, with the benefits provided by both. The device is being held by two hands in a “landscape” orientation like a common smartphone (see FIG. 20), but most of the text input/application controlling activity happens on the Back side using the so-called back-touch operation mode. The two thumbs are holding the device in place without the risk of accidentally touching the virtual controls appearing on the display (the operating system or the running application may make the whole display or its selected areas touch-insensitive) and other fingers of both hands (typically two index and two middle ones and occasionally also two ring ones) are skimming the Back touch-sensitive surface of the Touchpad Keyboard unit (not shown) and pressing one or more of the Relief points (not shown). See FIG. 21 for details. The skimming motions of the fingers are directed by the user with the help of visual feedback from the display which is real-time simulated images of as many fingers (or fingertips) as there are real fingertips actually touching the touch-sensitive surface at the Back, such images being superimposed over the image of virtual keyboard or of some other set of controls. These images are not shown on FIG. 20. With this method, a position of each fingertip at a certain point of the touch-sensitive surface is translated in real time by the software running on the Communication device's processor to a corresponding position of simulated finger or fingertip image shown on the display, and the key of the displayed virtual keyboard corresponding to the relief point which is being touched by a fingertip is visually highllighted to indicate that it will be activated if the user presses the relief point (or, if an alternative algorithm is chosen, just keeps the finger touching the Relief point for a certain time).

Comment to FIG. 21: When the Communication device (#1) with the attached Touchpad Keyboard unit (#1.9) is used in the back-touch operation mode as shown on FIG. 21, up to six fingers may operate at the same time doing typing or application controlling, including multi-key entry for both tasks. Two index fingers are mostly operating the Relief point keys located on the surface of the two Flaps (#1.9.2 and #1.9.3). The flap surface may be not touch-sensitive. And the other fingers are skimming the touch-sensitive surface (#1.9.1) of the Touchpad Keyboard unit (#1.9) and pressing one or more of the Relief points (#1.9.1.3) when necessary.

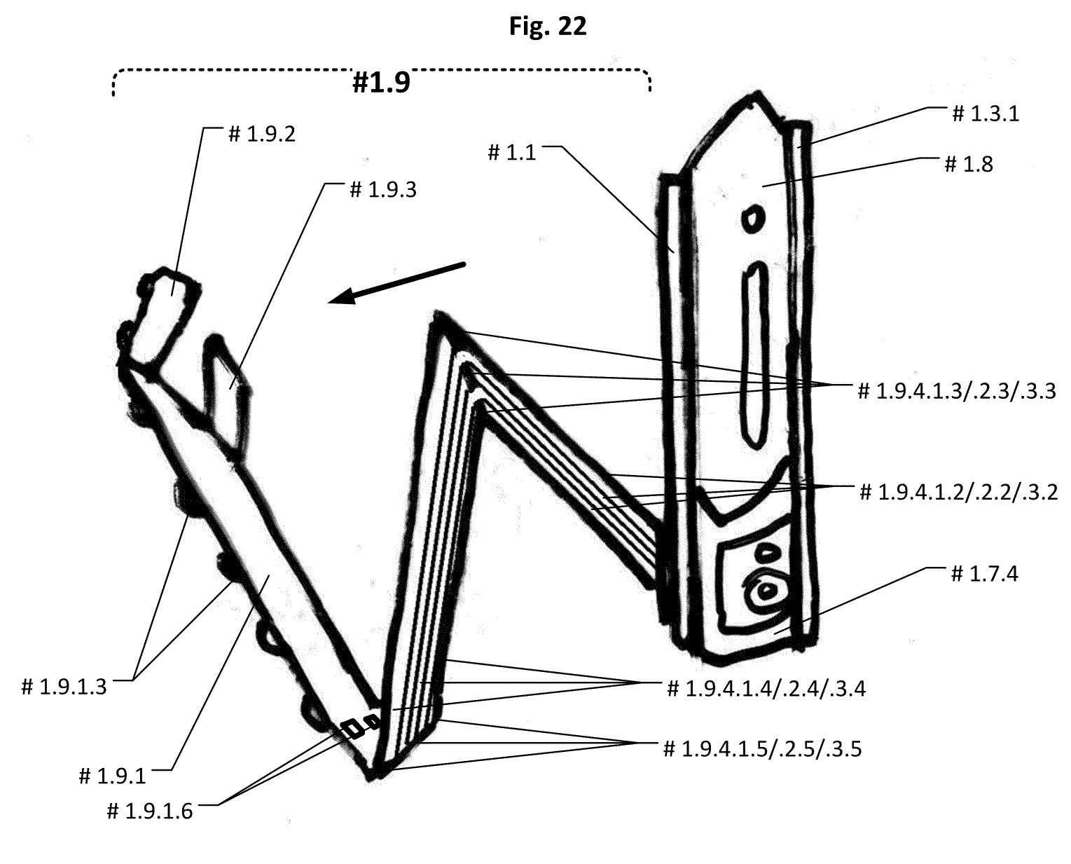

Comment to FIG. 22: In the example shown, the Touchpad Keyboard unit (#1.9) is attached to the Communication device (#1) via three Connection bands (#1.9.4.1, #1.9.4.2 and #1.9.4.3). Each Connection band consists of the two Band sections—a Long section (##1.9.4.1-3.4) and a Short section (##1.9.4.1-3.2), connected by a Hinge called Hinge Beta (##1.9.4.1-3.3).

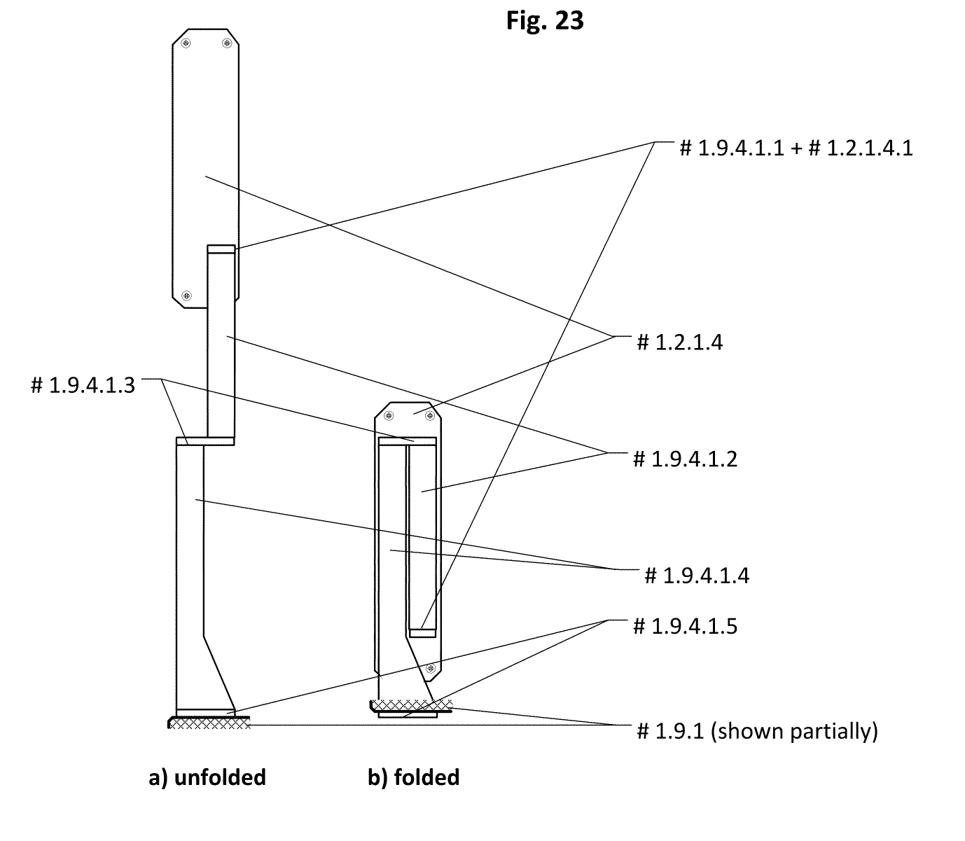

As the Touchpad Keyboard unit (#1.9) starts being transformed from the Folded position (suitable for the Handheld/pocket/cradle-mount State of the parent device) into the Desktop position shown on FIG. 26, the Connection bands start being unfolded in the three points (hinges) each, as shown on FIG. 22. The first set of hinges, called Hinges Alpha (##1.9.4.1-3.1) attaches the Long Section (##1.9.4.1-3.4) of each Connection Band (##1.9.4.1-3) to appropriate Backplate (#1.2.1.4, shown on FIG. 6 and FIG. 23), more precisely to its Attachment mechanism (#1.2.1.4.1, also shown on FIG. 6 and FIG. 23), in a temporary or semi-permanent manner. The second set of hinges, called Hinges Beta (##1.9.4.1-3.3) attaches the Long Section (##1.9.4.1-3.4) of each Connection band to its Short section (##1.9.4.1-3.2) in a permanent manner. The third set of hinges, called Hinges Gamma (##1.9.4.1-3.5) attaches the Long Section (##1.9.4.1-3.4) of each Connection band to the Touchboard (#1.9.1) in a permanent manner.

Before the shown transformation (unfolding) process started, the Touchpad Keyboard unit (#1.9) was being hold in place by the set of Fasteners (#1.9.1.6) that were located in the spaces between folded Connection bands (##1.9.4.1-3) and possibly also by Flap keypads (#1.9.2 and #1.9.3) attached via magnetic or other method to their counterparts located on the Flexible base and Module housings of the Communication device (#1). At the start of unfolding, these attachment points are manually or electrically disengaged as the Touchboard (#1.9.1) is moved outwards from the Back side of the parent device.

Comment to FIGS. 23(a) and 23(b): When the Touchpad Keyboard unit (#1.9) is in the Folded position (suitable for the Handheld/pocket/cradle-mount State of the parent device), each Connection band (##1.9.4.1-3) is in completely folded position shown on FIG. 23(b). In this position, the two Sections of each Connection band are placed in the same plane side by side as FIG. 23(b) demonstrates—to minimize overall thickness. The main part of the Touchpad Keyboard unit (#1.9) called Touchboard (#1.9.1) is lying flat next to the folded Connection bands (it's not completely shown on the picture or otherwise it would have to be be put in front of the Connection band and would block it from view).

FIG. 23(a) shows one of the Connection bands in a completely unfolded state to demonstrate its design, but such position is not used, as a rule, when the parent device (the Communication device) is being operated or stored.

On both pictures, the Connection band is used attached to one of the Backplates (#1.2.1.4) via its Attachment mechanism (#1.2.1.4.1, also shown on FIG. 6) which couples with the Hinge Alpha (#1.9.4.1.1) of the Connection band. This reversible type attachment is either temporary or semi-permanent. It may be designed to conduct electric power or electric digital signals because the Connection bands may serve not only as mechanical but electrical connectors also.

Comment to FIG. 25: In the second phase of the Touchpad keyboard unit (#1.9) unfolding, the Touchboard (#1.9.1) is overturned to come to the Front side of the Communication device as shown on the FIG. 25.

Comment to FIG. 26: When the Communication device is in its Desktop state, the Touchpad Keyboard unit takes a semi-folded position to support the body of the Communication device with the display in a position convenient for desktop operation shown on FIG. 26. No-slip patches on the bottom (desk-facing) side of the Connection bands prevent the device from slipping and laying flat. Both cameras (#1.3.1.7 and #1.7.1.4) can be used (main Camera #1.7.1.4 needs to be rotated to front-facing position). Removable earpiece (#1.8) can be detached to be used as wireless earpiece or wireless mouse and subsequently attached back.

Comment to FIG. 27: In the two “Croissant” Versions shown on FIG. 27, the Modules are placed at the Back side of the flexible Base (#1.1), and the Display assembly (#1.3.1) is attached to the flexible Base (#1.1), not to a Module housing as in “Sandwich” Version.

The two Versions B1 and B2 differ by the properties of the flexible Display assembly (#1.3.1) and the flexible Base (#1.1).

In Version B1, the Display assembly (#1.3.1) is movable and can be detached from the flexible Base (#1.1) at the Top side to take the Raised position (similar to the one shown on FIG. 3 for the “Sandwich” Version of the Communication device). To achieve this, the two sets of Attachment points (#1.1.9 and #1.1.9) mounted on the Front side of the flexible Base work together with the set of Attachment points (#1.3.1.5) mounted on the Back side of the flexible Display assembly (#1.3.1)—work in a similar manner as in the “Sandwich” Version (see FIG. 10). The attachment mechanism of each Module to the flexible Base (#1.1) is similar to that shown on FIG. 8 for the “Sandwich” Version, with Backplates (#1.2.1.4) hold in place by multiple Screws (#1.2.1.3) each.

In Version B2, the flexible Display assembly (#1.3.1) is made thin enough to be able to bend together with the flexible Base (#1.1) it's permanently integrated with. The attachment mechanism of each Module to the flexible Base (#1.1) may differ from that shown on FIG. 8 for the “Sandwich” Version. For example, the mechanism may use longer screws (not shown) running through the housing of each Module (instead of running through the flexible Base as in Version B1) and having their heads accessible via openings (not shown) on the Back side of each Module.

“Comment to FIG. 28: The Configuration Variant (c) or “Lean” may apply to both “Croissant” Versions B1 (shown on FIG. 28) and B2. With this Configuration Variant, the middle section of the Communication device does not contain any Module or a Touchpad Keyboard unit attached. Such additional components may be attached when a change to Configuration Variant (a) or (b) shown on FIG. 29 takes place. For conversion to the Configuration Variant (a), one or more additional Modules are attached via a plurality of Connector points (#1.1.1.1.4) located at the Back side of the flexible Base (#1.1) as shown on FIG. 28. For conversion to the Configuration Variant (b), a Touchpad Keyboard unit (which may differ in size, shape etc. from the one designed for the Version “Sandwich”—for example, have no Flap Keypads) is attached via a plurality of Fasteners (#1.1.8) located at the Back side of the flexible Base (#1.1) as shown also on FIG. 28.

The Communication device of a “Croissant” Version B1 or B2 may attach itself, while taking the Bent shape, to a Wearable Data Management device (not shown) via the set of Top Attachment Strips (#1.7.9.1), Bottom Attachment Strips (#1.3.10) and Top-side button-type fastener (#1.7.9.2). This set is located on the Back sides of two or more Modules (see FIG. 28), unlike the “Sandwich” Version where the similar set of attachment components is located on the Back side of the flexible Base (see FIG. 6). In addition, each device of a “Croissant” Version B1 or B2 may have two separate sets of components for attachment to the Top side of the Control Unit of the Wearable Data Management device (not shown), including Multifunction Connectors (#1.3.2, #1.7.10) and Restraining Protrusions/Depressions (#1.3.3, #1.7.11)—unlike the “Sandwich” Version which may have only single such set. These two separate sets are required to accommodate different relative positioning of the two devices being attached—depending on the actual Configuration Variant of the Communication device and the corresponding position of the Wearable Data Management device on a wrist (as shown on FIG. 29). One set (#1.3.2, #1.3.3) is located on the Bottom side of the Bottom Module (#1.3)—for Configuration Variant (c); and another set (#1.7.10, #1.7.11) on the Bottom side of the Top Module (#1.7)—for Configuration Variants (a) and (b).

Comment to FIGS. 29(a), 29(b) and 29(c): A single Version of Wearable Data Management device may host a Communication device of any of the three Versions (A “Sandwich” and B1,B2 “Croissant”) and, in the case of a “Croissant” Version B1 or B2, the latter device may have any of the three Configuration Variants (a), (b) and (c) shown on FIGS. 29 (a), (b) and (c) respectively. However, the position of the Wearable Data Management device for the Configuration Variants (a) or (b) may be different from the position for Configuration Variant (c). In particular, cases (a) and (b) require the Wearable Data Management device to take the “Bottom” position shown on FIG. 13 and also in cross section on FIGS. 29 (a) and (b); while for case (c) the Wearable Data Management device may take the “Top” position shown on FIG. 14 and also in cross section on FIG. 29 (c). Also, different attachment parts belonging to the both coupled devices are engaged for these two cases, as described below, and certain other parts may be left disengaged (unused).

In the Configuration Variant (a), one or more additional Modules are placed in the middle section of the Communication device and attached to the flexible Base (#1.1).

Attachment between the two devices may be performed in the following way:
the Bottom Multifunction Connector—female (#1.3.2) of the Communication device connects to the Multifunctional Connector—male (#2.2.1.1) of the Wearable Data Management device;
the Bottom Attachment Strips (#1.3.10) of the Communication device attach to the Middle Attachment

Strips (#2.1.1.5) of the Wearable Data Management device;
the Top Attachment Strips (#1.7.9.1) of the Communication device attach to the Upper Attachment Strips (#2.1.1.3) of the Wearable Data Management device;
the Top-side button-type fastener (#1.7.9.2) of the Communication device attaches to the Upper button-type fastener (#2.1.1.4) of the Wearable Data Management device.

In the Configuration Variant (b), a Touchpad Keyboard unit (#1.9), which may differ in size, shape etc. from the one designed for the Version “Sandwich”, is placed in the middle section of the Communication device and attached to the flexible Base (#1.1).

Attachment between the Communication device and the Wearable Data Management device may be performed in the same way as for Configuration Variant (a) above.

In the Configuration Variant (c) called “Lean”, nothing is attached at the middle section of the Communication device, and the Control Unit (#2.2) of the Wearable Data Management device uses this space instead, thus making more compact overall profile of the bundle of the two devices.

Attachment between the two devices may be performed in the following way:
the Top Multifunction Connector—female (#1.7.10) of the Communication device connects to the Multifunctional Connector—male (#2.2.1.1) of the Wearable Data Management device;
the Bottom Attachment Strips (#1.3.10) of the Communication device attach to the Lower Attachment Strips (#2.1.1.6) of the Wearable Data Management device;
the Top Attachment Strips (#1.7.9.1) of the Communication device attach to the Middle Attachment Strips (#2.1.1.5) of the Wearable Data Management device.

The three Configuration Variants shown on FIGS. 29(a)-(c) are applicable to both B1 and B2 “Croissant” Versions, but Version B2 would differ from Version B1 shown since it does not have some Components Version B1 does: Attachment points #1.3.1.5, #1.1.10, #1.7.8.

Comment to FIG. 30: The fold-out position of the Touchpad Keyboard unit (#1.9) shown on FIG. 30 is achieved via rotating its Touchboard (#1.9.1) component to approximately 180 degrees from the initial folded position shown on FIG. 19, while keeping the Connecting bands (#1.9.1.4, not shown on FIG. 30) folded as shown on FIG. 23(b). The Touchpad keyboard unit (#1.9) in this position provides convenient and reliale alternative to the touch-sensitive screen when the Communication device (#1) is worn on a wrist, especially when the flexible Display assemly (#1.3.1) is in the Raised position as shown on FIG. 30. It's difficult to type on a virtual keyboard or to control virtual buttons displayed on the touch-sensitive display unless both arms are stable which is not always possible while walking, cycling, surfing etc. With the Touchpad keyoard unit (#1.9), locating appropriate controls by one or more fingertips is assisted by a tactile feedback provided by the Relief points (#1.9.1.3) since the pattern of displayed keys of a virtual keyoard or of displayed virtual buttons shall match the fixed pattern of the Relief points (#1.9.1.3) on the Touchboard (#1.3.1). For example, if the latter (physical) pattern is a matrix 5×8, then each virtual button displayed on the screen shall be pinned to a node of a similar 5×8 matrix, although potentially having different size and/or proportions. It's also possible to control a cursor using the Touchpad keyboard unit (#1.9) in the shown fold-out position.

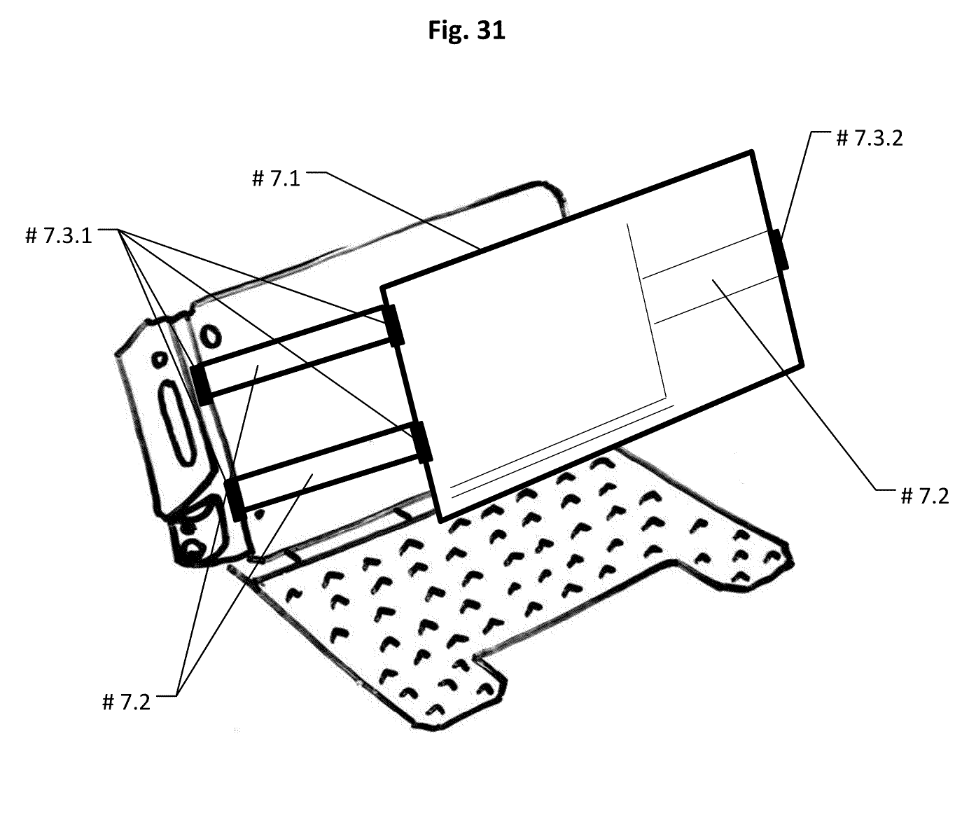

Comment to FIG. 31: The magnifying accessory may be attached to the Communication device while the latter is in its Hand-held or Desktop (shown) state, in order to enhance the visible image on the display and the amount of user-readable information. The main part of the accessory is the flat lens (#7.1), which in the working position shown is held parallel to the display surface, at a specific distance from the latter, by the plurality of connection bands (#7.2). The connection bands are attached to the flat lens (#7.1) and to the appropriate part(s) of the Communication device via the set of connection points (#7.3.1, #7.3.2) some of which may have a hinge-like construction and some may be de-coupled easily to detach the magnifying accessory from the host Communication device or to transform it into the non-working (folded) position.

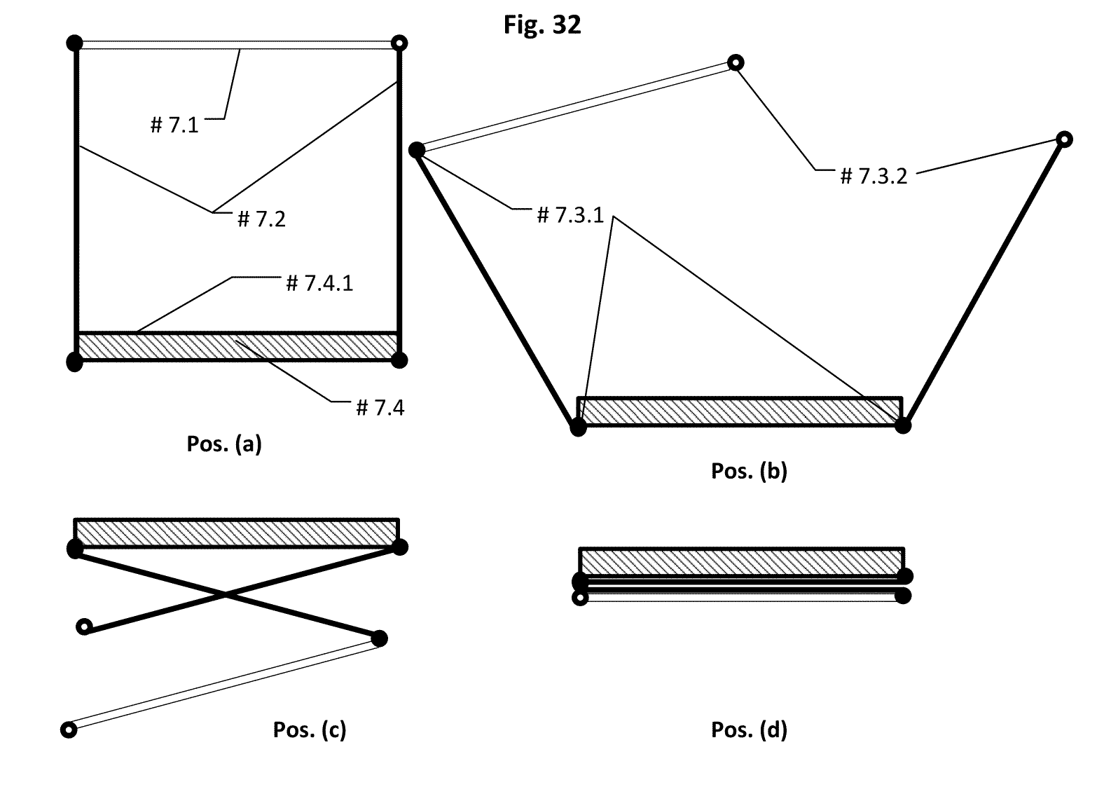

Comment to FIGS. 32(a)-32(d): The magnifying accessory may also be attached to an existing smartphone (#7.4) as shown on the Figures (providing four views from the same side). Four stages of accessory transformation are shown from the working position (a) into the non-working (folded) position (d) through the two intermediate positions (b), (c). In the first position (a), the flat lens (#7.1) is held parallel to the display surface (#7.4.1) of the host smartphone device (#7.4), at a specific distance from this surface, by the plurality of connection bands (#7.2). Two configurations are possible with the connection bands placed either at two opposite (left and right) sides of the flat lens (#7.1) or at the same (top) side. The first variant only is shown on the Figures. This variant allows, while the working position (a) is engaged, for the connection bands (#7.2) together with the attachment points (#7.3.1, #7.3.2), to apply force in two opposite outward directions (shown as arrows) to the edges of the flat lens (#7.1), in order to retain its flat shape and desired parallel-to-display surface position. Among the attachment points, some (#7.3.2) can be easily de-coupled by the user when the working position needs to be disengaged, as shown on FIG. 32(b). Other attachment points (#7.3.1) act as hinges when the connection bands (#7.2) and the flat lens (#7.1) are moved to the back side of the smartphone's body (#7.4), as shown on Figs. (b) and (c), until finally these components are aligned parallel to the back surface and pressed against it to be fixed in the non-working (folded) state, as shown on Fig. (d).

### 7. Detailed Technical Structure of the Example Embodiments

This Section is contained entirely in the separate document named Appendix to the Specification. It outlines the technical structure of example embodiments using a hierarchical representation and it references other documents using the same Drawing numbers (i.e. FIG. 1, FIG. 29(a), etc.) and the same component numbers (for example, #1.1.1 for the Main Layer component of the Flexible base assembly of the described embodiment of the Communication device).

8. Terminology Used in this Document and the Related Documents

Security Complex—the devices Key Data Storage unit, Lock Data Storage unit, Installed Lock device and Stationary Data Storage device are referred together as the Security Complex because their primary functions relate to online and offline security, personal identity verification, physical & logical (data) access authorization, data exchange session validation, data encryption/decryption, electronic and electromechanical locks operation etc.

Wearable Complex—the devices Communication device, Wearable Data Management device, Key Data Storage unit are referred together as the Wearable Complex as they are designed to be primarily owned/used by a person and worn on a wrist or carried in a pocket, bag etc. (although the Communication device has the Desktop State which allows it to be used as a desktop computer-communicator device also).

External device—a device not belonging to the set of eight devices: Communication device, Removable Earpiece unit, Touchpad Keyboard unit, Wearable Data Management device, Key Data Storage unit, Lock Data Storage unit, Stationary Data Storage device, Installed Lock device.

Host device—a device that provides mechanical enclosure and/or electrically powers and/or electronically controls another device. A Wearable Data Management device may host a Key Data Storage unit and/or a Communication device. An Installed Lock device may host a Lock Data Storage unit.

Component—any technically or logically distinguishable part or section of a device, which may exist as a separate part or assembly at some point in the process of manufacturing the device.

Parent device—a device the component belongs to (physically or logically).

Assembly—one of the higher-level components that the device can be disassembled into.

Sub-assembly—one of the mid-level components that an Assembly can be disassembled into.

Sub-sub-assembly—one of the low-level components that a Sub-Assembly can be disassembled into.

Part—a component of a device, belonging to a Sub-sub-assembly, Sub-assembly, Assembly or directly to the device itself, which cannot be decomposed (with the level of detail chosen in this Detailed Description section) into any components.

Group—a collection of similar or identical components that can be described together for convenience.

Version—some of the devices may be implemented in several Versions which will share the same primary functions but differ in the components included, physical layout/design etc. Typically a user purchases and/or operates a single Version of a device.

Configuration Variant—a user-selectable configuration of a device achieved by installing or removing components (possibly with the help of simple tools like a screwdriver) and/or changing the physical layout and/or electrical scheme of the device.

State—one of the user-selectable physical configurations of a device.

Usage Mode—a specific combination of one or more of the devices, with or without external device(s), plus method(s) of connection/interaction (wired, wireless, mechanical, etc.) between the participating devices and the related operational scenarios/methods/algorithms.

Usage Type—a specific set of ways the user uses, handles and operates a device.

Open-type operating system—a common operating system such as Android which allows software installation, configuration and/or modification performed at the user request or without it (automatically).

Closed-type operating system—a specialized operating system which does not allow any software installation, configuration or modification (with the exception of changes done via a procedure similar to firmware update requiring certain manipulations with the hardware).

Secure Terminal Mode—With this mode, the main processor (CPU) of the Communication device (which normally runs a common open-type operating system such as Android) is put into a suspended state and control over the Communication device's display, its Touchpad Keyboard unit (if available) and its other peripherals is passed to the processor of the Wearable Data Management device running a simplified, closed-type operating system (or other specialized program) whose instructions are stored in the Wearable Data Management device's ROM or RAM component(s) and are hardware-protected from modification by malware or any user-installed software. After that, the Wearable Data Management device processor interacts with the external PC in such a manner that no confidential data in unencrypted or decrypted form exists anywhere within the PC at any time, but only within the protected components controlled by the Wearable Data Management device processor: internal memory of the Wearable Data Management device, the Key Data Storage unit and the Communication device, the display of the Communication device and the Touchpad Keyboard unit. Alternatively, the Communication device's processor may be not put in a suspended state but start running a different operating system instead (preferably a closed-type one).

Attachment/Connection Type—determines how a component is connected to its Parent component (e.g. a Part to parent Sub-assembly, a Sub-assembly to a parent Assembly etc.) or how a device is attached to its Host device. See below for specific Types.

Permanent attachment—type of mechanical connection (with or without electrical connection) between two or more components of a single device which cannot be done or undone by a user, but only at authorized repair center for the device. This attachment is typically done or undone when a device is under repair.

Semi-permanent attachment—type of mechanical connection (with or without electrical connection) between two or more components of a single device which can be done or undone by a user, with possible use of common tools like a screwdriver. This attachment is typically done or undone when a device is being upgraded by a user or when a user replaces malfunctioning component(s).

Temporary attachment—type of reversible mechanical connection (with or without electrical connection) between two or more components of a single device which is routinely being undone and restored by the user during normal operation of the device.

Removable component—a component that is reversibly attached to its parent device via trmporary mechanical attachment (with or without electrical connection).

Removable Module—a Module of a Communication device whose reversible attachment mechanism is designed to allow quick, frequent and secure attachment and removal from the parent Communication device. The mechanism may require usage of intermediate connectors or sockets that will be attached to the Communication device's flexible Base in the same semi-permanent manner as the Modules described above.

Extension Module—a Module of a Communication device that is purchased separately and installed by the user to enhance functionality and/or performance of the device.

Look-at-the-display position—a user's posture with the arm positioned to comfortably look at the dial of a wrist-worn watch or at the display of a wrist-worn @Communication device.

Code Vector—a randomly or pseudo randomly generated binary word having a fixed length of few bytes that can be used as symmetric key for encryption, for authorization of one device by another etc.

Code Array—a collection of Code Vectors

Time-arranged Code Array—a Code Array where Code Vector is assigned to a specific real time (UTC) period called its Validity Time Frame. The code Vectors are thus arranged (sorted) by their subsequent (overlapping or not) Validity Time Frames. The resulting Validity Time Frame for the whole Code Array (Array Validity Time Frame), as a rule, spans over a period of few hours to few years.

Idle Period—a period when a Key Data Storage device is not connected to any host device or other external power source.

“Purge” Event—an event of emergency circumstances presenting a risk to security of confidential data that justifies and requires complete irreversible deletion of all the confidential data contained in the a storage of a Key Data Storage device, a Stationary Data Storage device or a Lock Data Storage device.

Contract—digital data communication relationships between two or more devices (Key Data Storage units, Lock Data Storage units, Stationary Data Storage devices), established for the purpose of secure data exchange, validation/authorization, etc., constituting the devices storing in their secure memory units either identical or mathematically related Code Arrays assigned to the Contract. Typically, two identical or mathematically related Code Vectors contained in the two Code Arrays written into memory units of a pair of the devices participating in the Contract will be used either to authorize, identify or validate a person, a device, an online session etc. or to perform symmetrical encryption/decryption (for secure data exchange between the two devices). The established data communication relationship between the devices participating in the Contract represents certain “trust” relationship between individuals (who own some of the participating devices) and/or organizations (that operate some of the participating devices) and/or physical objects (vehicles, door locks, PCs etc. that host some of the participating devices).

Contract generation—a procedure of generating random or pseudo random Code Vectors in a quantity sufficient to fill a Code Array with the desired Array Validity Time Frame called Contract Term and subsequent writing into secured memory units of two or more participating Slave devices. The process is controlled by a Master Device, which may or may not be a Party in the generated Contract (see below). Either identical copies of the original (randomly generated) Code Vectors are written or the results of a certain mathematical operation applied to the original Code Vectors. If more than two devices participate in the Contract, the Contract generation session may last few minutes (a time sufficient to connect all the Slave device(s) sequentially to the Master device). As a rule, the Contract will be of the Closed type meaning it will not allow to add new parties after the Generation has been completed (to avoid storing Code Arrays in a less secure memory storage that would allow reading Code Vectors assigned to future periods).

Contract Party—an individual, organization or object owning, operating or hosting Slave devices participating in generation of the Contract. This term can be also applied to each of these devices.

Contract Execution—a data exchange session, a financial transaction or other interaction between two or more devices—parties in the same Contract—involving retrieval of one or more Code Vector(s) from the Code Array assigned to the Contract, and subsequent unilateral, bilateral, tri-lateral etc. verification of other party's identity, credentials, access right etc.

Master device—a device whose processor (or other controlling chip) controls Code Array generation and writing into secure memory storage units comprised in the Master device itself and the participating Slave devices. Each Contract has one and only one Master device who's unique (within its device class) ID becomes a part of the Contract ID (see below).

Slave device—a non-Master device participating in a Contract Generation process to receive Code Array(s) generated by the Master device and being written into own secure memory storage of the Slave device.

Peer device—a device that interacts with other devices during a data exchange session without taking control of being controlled by other device.

Private Contract—a Contract involving one or more individuals (represented by their owned/operated Key Data Storage devices) and optionally one or more objects such as vehicles, door locks etc. (represented by their hosted Lock Data Storage devices), without any organization involved.

Public Contract—a Contract involving one or more organizations (government, public or private) represented by their owned/operated Stationary Data Storage devices. It may also involve one or more individuals (represented by their owned/operated Key Data Storage devices) and/or objects such as vehicles, door locks etc. (represented by their hosted Lock Data Storage devices).

Primary (Face-to-face) Contract—a Contract generated via physical connection of all the participating Slave devices to the Master device.

Secondary (Remote) Contract—a Contract generated with at least one Slave device not physically connected to the Master device and instead receiving the Code Array from the Master Device via some network or other distribution channel (secured or unsecured).

Manufacturer's Contract—a contract generated at the time a Slave device was manufactured, between a Master device owned/operated by the manufacturer and the Slave device. This Contract allows the manufacturer to validate remotely or face-to-face the authenticity of the Slave device, its genuine Device ID (serial number), etc. As a rule, the owner/user of the Slave device may have limited access or no access at all to the Code Array of this Contract.

Device ID: a unique (within its device class) ID or serial number assigned by manufacturer to devices of the Security Complex that can participate in the Contracts as either Master or Slave devices (i.e. Wearable Data Management devices, Key Data Storage units, Lock Data Storage units, Stationary Data Storage devices).

Contract ID: an alphanumeric string uniquely identifying a Contract. It may contain a Master device ID to avoid duplicate IDs for Contracts generated at the same time by different and non-connected/non-communicating Master devices.

May also contain a UTC-based timestamp to avoid duplicate IDs for Contracts generated by the same Master device.

Possible Contract ID segmentation: <Manufacturer ID>-<Master device ID>-<UTC Date YYMMDD>-<UTC Time HHMMSS>
Contract ID example: ACME-V12345-130505-052304

Trust Center (Validation Center, Authorization Hub)—A government, public or private organization owning and/or hosting one or more Stationary Data Storage device(s) and providing remote identity verification/validation/authorization services for individuals and organizations engaged in security- and trust-related relationships.

1. A flexible modular communication device comprising:
a flexible base comprising a plurality of embedded wires and a plurality of mechanical connector points arranged along the length of the base;
a plurality of removable modules, each module comprising a housing with electrical and mechanical connectors connected to the base at one of the connector points so that electrical communication between the plurality of removable modules occurs through the embedded wires, the plurality of removable modules cumulatively comprising control circuitry, visual display circuitry, and radio communication circuitry;
the connector points arranged to allow removal or attachment of at least one removable module without mechanical or electrical disruption of the other removable modules; and
a flexible display assembly in electrical communication with at least one of the plurality of removable modules.

2. The flexible modular communication device of claim 1, wherein the plurality of removable modules further comprises power supply circuitry, data processing circuitry, and audio input and output circuitry.

3. The flexible modular communication device of claim 1, wherein the flexible base comprises a flattening mechanism comprising a plurality of spring-action bands made of steel or a mechanically similar material, having a curved (arched) cross section similar to that of a steel measuring tape, and positioned parallel to each other in such a way that each band is stretched from the top (closest to the user's small finger when the device is worn on the wrist) side to the bottom (closest to the user's thumb when the device is worn on the wrist) side of the flexible base, the plurality of bands containing at least one band positioned with its concave side facing the front surface of the flexible base and at least one band positioned with its concave side facing the opposite (back) surface of the flexible base.

4. The flexible modular communication device of claim 1, wherein the flexible base comprises a water impermeable layer.

5. The flexible modular communication device of claim 4, wherein the connection of each removable module to the base is equipped with a gasket.

6. The flexible modular communication device of claim 5, wherein a gasket is mounted to an exterior surface of the housing for each removable module, the gasket encompassing the electrical connectors.

7. The flexible modular communication device of claim 5, wherein a gasket is formed by a protrusion of each removable module's housing, the gasket encompassing the electrical connectors.

8. The flexible modular communication device of claim 1, wherein the device can function in a bent state and a flat state.

9. The flexible modular communication device of claim 8, wherein one end of the flexible display assembly can be reversibly attached to a first attachment point when the device is in the bent state and reversibly attached to a second attachment point when the device is in a flat state.

10. The flexible modular communication device of claim 9, wherein at least one of the first and the second attachment points is located on a module housing on a side opposing the area of the connection to the flexible base.

11. The flexible modular communication device of claim 9, wherein the first and the second attachment points are located on a side of the flexible base opposite to the side connected to the removable modules.

12. The flexible modular communication device of claim 9, wherein the flexible display assembly comprises a detachable end that can be detached and raised when the device is in the bent state.

13. The flexible modular communication device of claim 12, wherein an end opposing the detachable end of the flexible display assembly is attached to the housing of one of the removable modules at the portion of the housing which is closer to the palm and detached at the remaining portion of the housing which is farther from the palm.

14. The flexible modular communication device of claim 13, wherein the detached section of the opposite end of the flexible display assembly can be reversibly attached to the removable module via a magnetic fastener (comprised partially in the flexible display assembly and partially in the removable module).

15. The flexible modular communication device of claim 1, wherein the device comprises attachment points for connecting the device to a wearable arm bracelet.

16. The flexible modular communication device of claim 15, wherein the attachment points comprise one or more of the following: a multi-functional electric connector (female), restraining protrusions, restraining depressions, magnetic fasteners, velcro-type fasteners, snap button-type fastener.

17. The flexible modular communication device of claim 15, wherein the bracelet is wearable on a wrist.

18. The flexible modular communication device of claim 17, wherein the device comprises one or more sensors for detecting whether the device is attached to the wearable bracelet.

19. The flexible modular communication device of claim 18, wherein the device comprises one or more gyro sensors, accelerometers and/or other sensors for detecting a specific arm and wrist position appearing when the user looks at the visual display of the device being worn.

20. The flexible modular communication device of claim 19, wherein the device comprises one or more accelerometers and/or other sensors for detecting specific linear or rotating motions of the wrist while the arm is in the specific look-at-the-display position—the detecting being used for controlling applications running on the device processor.

21. The flexible modular communication device of claim 18, wherein the device comprises one or more palm proximity and/or palm motion sensors for detecting specific palm motions while the arm is in the specific look-at-the-display position—such detecting being used for controlling applications running on the device processor.

22. The flexible modular communication device of claim 17, wherein the device comprises one or more accelerometers and/or gyro sensors and/or other sensors for detecting a specific arm movement appearing when the user moves the device worn on the wrist to come to close proximity of the ear—such detecting being used for placing or answering a call or performing other commands or functions.

23. The flexible modular communication device of claim 17, wherein the housing for each removable module has a prismatic shape with trapezoid cross-section.

24. The flexible modular communication device of claim 23, wherein the interior angle between the facet of the housing closest to the wrist and the facet of the housing closest to the rear side of the palm is greater than 90 degrees.

25. The flexible modular communication device of claim 1, wherein the device comprises at least one earpiece and at least one microphone.

26. The flexible modular communication device of claim 25, wherein the earpiece is reversibly attached to one of the removable modules.

27. The flexible modular communication device of claim 26, wherein the earpiece comprises a wireless connectivity circuit, a microphone and a battery unit.

28. The flexible modular communication device of claim 27, wherein the earpiece comprises an optical mouse.

29. The flexible modular communication device of claim 1, further comprising a touchpad keyboard.

30. The flexible modular communication device of claim 29, further comprising instructions stored in a memory for presenting on the visual display finger touches on the touchpad keyboard superimposed over an image of a keyboard.

31. The flexible modular communication device of claim 29, wherein the touchpad keyboard comprises a plurality of relief points extending from the touch-sensitive surface and yielding to finger pressure.

32. A wearable data management device comprising:
a band comprising an exterior surface and an interior surface;
a housing coupled with the band and defining an internal cavity;
an access window formed on the interior surface of the band in communication with the housing cavity;
a data storage unit located in the housing cavity and comprising an internal clock circuitry, an internal source of electric power; and
one or more sensors detecting changes in physical status of the device and physical breach attempts.

33. The wearable data management device of claim 32, wherein the band is a bracelet.

34. The wearable data management device of claim 33, wherein the band comprises an adjustable mount mechanism for reversible attachment of some existing watch models, thus allowing the band to replace a watch bracelet.

35. The wearable data management device of claim 32, wherein the band comprises one or more buttons for PIN entry using a sequential method with digits from 0 through 9 being entered via appropriate numbers of sequential presses of an appropriate button or buttons.

36. The wearable data management device of claim 35, wherein the sequential PIN entry method is supported by vibrations signalling recognition of each entered digit and/or other conditions.

37. The wearable data management device of claim 32, wherein the data storage unit comprises a breach-sensitive shell encasing all other electronic components of the unit, a plurality of sensors measuring mechanical, electrical or other physical parameters of the sections or areas of the shell, input/output circuits, and a processor with pre-loaded instructions for deletion of stored confidential data if the sensors detect a breach of the shell, a drop in energy level stored in the internal power source or other specific condition.

38. The wearable data management device of claim 37, wherein the memory chip of the data storage unit stores an array of reference ranges of mechanical, electrical or other physical parameters for the plurality of sections or areas of the breach-sensitive shell, the parameter values measured during tests conducted under multiple combinations of marginal values of environmental physical parameters such as temperature, pressure, and recorded into the memory chip.

39. The wearable data management device of claim 38, wherein the array of reference ranges is used to compare the reference parameter ranges with the parameter values actually measured by the plurality of sensors, in order to detect mechanical, electrical or other physical breach of the shell.

40. The wearable data management device of claim 32, further comprising a control unit comprising a battery, and a processor, the control unit in electrical communication with the data storage unit.

41. The wearable data management device of claim 40, wherein the control unit performs data decryption and encryption operations.

42. The wearable data management device of claim 41, wherein the control unit decrypts an encrypted code array (or other encrypted data set) received from an external device or via a network, using the decryption key either stored in the hosted data storage unit or received separately from an external device or network.

43. The wearable data management device of claim 41, wherein the processor within the control unit can take on control of a display, keyboard and/or other components of a hosted flexible modular communication device or of other connected device in order to allow secure input and output of confidential information in unencrypted or decrypted form, providing a decrease in a risk of such information being compromised via malware or other security flaw related to an open-type operating system the host device or the connected device normally runs.

44. The wearable data management device of claim 40, wherein the control unit can add or delete a code array to/from the data storage unit.

45. The wearable data management device of claim 40, wherein the control unit or the band further comprises one or more bio sensors for user's health related and/or user's identity related data collecting.

46. The wearable data management device of claim 45, wherein the bio sensor is implemented performing infrared, ultrasound or similar type scan of user's wrist tissues to capture images that can be used to identify the person wearing the device.

47. A touchpad keyboard device comprising:
a touch sensitive surface;
a plurality of relief points extending from the touch-sensitive surface and yielding to finger pressure;
the plurality of relief points spaced apart in proportion to spacing of keys on a keyboard;
instructions stored in a memory for presenting on a visual display finger touches on the touchpad keyboard, images of the touches superimposed over an image of the keyboard.

48. The touchpad keyboard device of claim 47, wherein the touch sensitive surface is capable of detecting position of touching single finger, in real time.

49. The touchpad keyboard device of claim 47, wherein the touch sensitive surface is capable of detecting positions of touching multiple fingers, in real time.

50. The touchpad keyboard device of claim 47, wherein the relief points are covered by the touch sensitive surface.

51. The touchpad keyboard device of claim 47, wherein the relief points protrude through openings defined in a layer comprising the touch-sensitive surface.

52. The touchpad keyboard device of claim 47, wherein the relief points are capable of sending electric signals if pressed by a finger.

53. The touchpad keyboard device of claim 47, wherein the instructions stored in memory comprise instructions to change a visual appearance of any key image belonging to the image of the keyboard if at least one of the fingers touching the touch sensitive surface approaches a relief point corresponing to the key image closer than a set threshold.

54. The touchpad keyboard device of claim 47, wherein the instructions stored in memory comprise instructions to logically map a plurality of selectable elements currently present on the display of the host/connected smartphone or other host/connected device, elements such as virtual buttons, virtual controls, text fields, menu items, images, icons, widgets, display areas etc., onto the plurality (matrix) of relief points, so that a selectable element is visually highlighted on the display whenever at least one user's finger touches the touch-sensitive surface at a point closer than a set threshold to the appropriate (i.e. logically mapped to this particular selectable element) relief point, and the highlighted selectable element is selected (engaged, activated, etc.) whenever user's finger presses the relief point.

55. A complex of universal devices capable of performing authorization, validation and access control tasks via mutual data exchange comprising:
at least one portable data management device that has wireless data communication capabilities and comprises a key data storage unit;
one or more devices wherein each device is either a stationary data storage device operated by an organization or a lock data storage unit installed in a vehicle, in a door lock or in another object.

56. The complex of universal devices of claim 55, wherein the portable data management device and the stationary data storage device can act as master devices performing generation of an original Code Array filled with random or pseudo random Code Vector data and passing either the original Code Array or a Code Array resulting from performing certain mathematical operation upon the original Code Array to each connected slave device.

57. The complex of universal devices of claim 55, wherein the portable data management device can encrypt and decrypt data using as keys Code Vectors from the Code Arrays stored by the comprised key data storage device.

58. The complex of universal devices of claim 57, wherein the device can connect to a network, then receive an encrypted Code Array and separately an encrypted Code Vector from external devices, then retrieve a Code Vector stored in the comprised key data storage device, then decrypt the received Code Vector using the retrieved Code Vector as the key, then decrypt the received Code Array using the decrypted Code Vector as the key, then write the decrypted Code Array into the memory storage of the comprised key data storage device.

59. The complex of universal devices of claim 57, wherein the device can connect to external devices to take on control of their components related to data input from and output to the user, can then support user input of unencrypted information via the external components with subsequent encryption and passing to a connected device or network, and also support decryption of encrypted information received from a connected device or network with subsequent output to the user via the external components.

60. A display image magnification accessory comprising:
a flat lens;
a plurality of connection bands; and
a plurality of attachment points for mechanical attachment of the connection bands to the flat lens and either to the flexible base or the modules of the flexible modular communication device, or to a body of an existing smartphone device, or to a body of another host mobile device having a display.

61. The magnification accessory of claim 60, wherein the connection bands are made of steel or a mechanically similar material, and have a curved (arched) cross section similar to that of a steel measuring tape.

62. The magnification accessory of claim 61, wherein the connection bands, while in a working position, are placed perpendicular to the display surface, with the concave side of each band facing outward.

63. The magnification accessory of claim 60, wherein some of the attachment points can act as hinges.

64. The magnification accessory of claim 60, wherein in the working position the flat lens is placed parallel to the host device's display surface at a distance roughly equal to the length of each connection band, while the connection bands are placed perpendicular to this surface.

65. The magnification accessory of claim 60, wherein in the non-working (folded) position the flat lens and the connection bands are placed as close as possible to the back surface of the host device's body, parallel to this surface.

66. The magnification accessory of claim 65, wherein the flat lens at one side is attached to one or many connection bands via attachment point(s) acting as hinge(s), and at the opposite side is attached to one or many connection bands via attachment point(s) that can be reversibly coupled (in the working position) and de-coupled (in the non-working position).

67. The magnification accessory of claim 65, wherein in the working position the attachment points in combination with the connection bands are arranged so as to apply outward-directed forces (tension) to the opposite sides of the flat lens preventing it from changing its flat shape and/or from losing its position parallel to the host device's display surface.
